(19) United States
(12) Patent Application Publication
(10) Pub. No.: US 2023/0139538 A1
(43) Pub. Date: May 4, 2023

(54) METHOD AND DEVICE FOR TREATING VARIOUS TYPES OF FLUIDS

(71) Applicant: Moon Bong LEE, Seoul (KR)

(72) Inventors: Moon Bong LEE, Seoul (KR); Young Mee JEON, Seoul (KR); Seung Hyun LEE, Seoul (KR); Whee LEE, Seoul (KR)

(73) Assignee: Moon Bong LEE, Seoul (KR)

(21) Appl. No.: 17/912,033

(22) PCT Filed: Mar. 15, 2021
(86) PCT No.: PCT/KR2021/003193

§ 371 Date: Sep. 15, 2022

Related U.S. Application Data
(60) Provisional application No. 62/989,744, filed on Mar. 15, 2020.

(51) Int. Cl. B01D 29/27; B01D 46/10; B01D 46/44

(52) U.S. Cl. CPC B01D 29/27; B01D 46/10; B01D 46/44

(57) ABSTRACT

One or more embodiments provide method and device for treating various type of fluids.

This application claims the benefit of priority of U.S. Provisional Application No. 62/989,744, entitled “Treating Fluid and etc.” filed on 15 Mar. 2020 and modifications. The benefit under 35 USC § 119 (e) of the United States provisional application is hereby claimed, and the aforementioned application is hereby incorporated herein by reference.

### TECHNICAL FIELD

This disclosure was not developed with any type of government support. Any government has no rights in applicants' disclosure.

This disclosure pertains to the field of methods, procedures and devices for treating various type of fluids, and improving some others more, with high efficiency but with low cost.

### BACKGROUND ART

This disclosure is for better life of human being and world by improving methods, procedures and devices for treating various type of fluids, etc. We live with lots of fluids, etc. For many reasons or purposes, they needs to be treated and improved from one state to one more other states, but efficiently and economically.

### DISCLOSURE OF INVENTION

### Solution to Problem

One or more embodiments provide method and device for treating various type of fluids. Further, one or more embodiments provide a computer-readable recording medium in which a program for executing the method on a computer is recorded. The technical problems to be solved by the present embodiments are not limited to the technical problems described above, and other technical problems may be derived from the following embodiments.

### BRIEF DESCRIPTION OF DRAWINGS

FIGS. 1A and 1B are concerning the basic of the concept.

FIG. 2 is concerning summarized Terms and Symbols in the figures.

FIGS. 3A and 3B are concerning a kind of application of fluid ‘air’ in the container ‘room.’

FIGS. 4A and 4B are concerning a kind of application of fluid ‘water’ in the container ‘pool.’

FIG. 5 is concerning a kind of complicated space.

FIG. 6 is concerning a kind of tap water production by ‘Nested-sacks’ or ‘sack(s)-in-sack.’

FIG. 7 is concerning a kind of sewage treatment (if a big width sack is not available).

FIG. 8 is concerning a kind of septic tank (simplified, but with flexible compartments).

FIG. 9 is concerning a kind of removing green algae, red tide, jellyfish, etc. in touristic beach, etc.

FIG. 10 is concerning a kind of making (alcoholic) beverages, etc.

FIG. 11 is concerning a kind of blending like making solution or dough

FIG. 12 is concerning a kind of treating disinfection, seed-coating, etc. of grains, etc.

FIGS. 13A and 13B are examples of installing a (very) long sack.

FIG. 14 is an example of making endless nested sack including hose(s)

FIG. 15 is an example of solid fluid treatment.

FIG. 16 is concerning a kind of treatment of contaminated sand or soil.

FIG. 17 is an example of sack(s)-in-sack method.

FIG. 18 is an example of a conversion to active form.

FIG. 19 is an example of ventilation.

FIG. 20 is an example of variation of sacks.

FIG. 21 is an example of easily detaching seals of the sack.

FIG. 22 is an example of supplementing the reduction in filtering.

FIG. 23 is an example of mask opening and closing methods.

FIG. 24 is an example of a bottle with removable inner sacks.

FIGS. 25A and 25B are examples of usage a bottle with a removable sack.

FIG. 26 is an example of remote initiation shown in diagram.

FIGS. 27A to 27D are examples of treating aerosol.

FIG. 28 is an example how to produce thin but flat insulator.

FIG. 29A to 29C are examples of treating with perforated sacks and making such.

FIGS. 30A and 30B are examples of how to treat a fluid to increase temperature.

FIG. 31 is an example of combining various treatings in case of big pool.

FIG. 32 is an example of no axis motor (fan).

FIG. 33 is an example of valve application (for combination)

FIG. 34 is an example of Multiple Valves I—complex (of linear and rotary) type.

FIG. 35 is an example of Multiple Valves II—complex (of linear and rotary) type.

FIG. 36 is an example of Multiple Valves III—Double Rotary type.

FIGS. 37A to 37E are examples of 360 degree energy transfer in 3D view.

FIG. 38 is an example of Method and apparatus for gathering investors.

FIGS. 39A to 39D are examples of how to produce better property sacks.

### MODE FOR THE INVENTION

As used herein and in incorporated documents:

The present disclosure may include various embodiments and modifications, and embodiments thereof will be illustrated in the drawings and will be described herein in detail. The effects and features of the present disclosure and the accompanying methods thereof will become apparent from the following description of the embodiments, taken in conjunction with the accompanying drawings. However, the present disclosure is not limited to the embodiments described below, and may be embodied in various modes. In this regard, the present embodiments may have different forms and should not be construed as being limited to the descriptions set forth herein.

Reference will now be made in detail to embodiments, examples of which are illustrated in the accompanying drawings. In the drawings, the same elements are denoted by the same reference numerals, and a repeated explanation thereof may be omitted. These elements are only used to distinguish one element from another.

The singular forms with ‘a’, ‘an’ and ‘the’, or without them and similar referents in the context of describing the present disclosure (especially in the context of the following claims) may include the plural forms as well, unless the context clearly indicates otherwise.

The term ‘and/or’ includes any and all combinations of one or more of the associated listed items.

Expressions such as ‘at least one of,’ when preceding a list of elements, modify the entire list of elements and do not modify the individual elements of the list.

Terms used in the present embodiments have been selected as currently widely used general terms as possible while considering functions in the embodiments, but the terms may vary according to intention or precedent of a technician working in the art, emergence of new technologies, and so on.

In addition, there is a case in which terms are randomly selected, and in this case, meaning thereof will be described in detail in description of the corresponding embodiment.

The use of any and all examples, or exemplary language (e.g., ‘such as’, ‘like’, colon ‘:’, semicolon ‘;’, etc.) provided herein, is intended merely to better illuminate the present disclosure and does not pose a limitation on the scope of the present disclosure unless otherwise claimed.

It will be further understood that the terms ‘comprises’ and/or ‘comprising’ used herein specify the presence of stated features or components, but do not preclude the presence or addition of one or more other features or components. In addition, unless explicitly described to the contrary, the word ‘comprise’ and variations such as ‘comprises’ or ‘comprising’ will be understood to imply the inclusion of stated elements but not the exclusion of any other elements. In addition, when a certain portion includes a certain component, this means that other components may be further included therein rather than excluding other components unless specifically stated to the contrary.

In the text and in the figure, three dots ‘ . . . ’ means multiple or repeat, nth (Nth) means serially or just multiple or repeat, T±n means sequentially multiple or repeat something, in this case ‘Treat. The lowercase roman numerals like i), ii), iii), . . . in the text and/or in the figure means selecting one of them, not excluding combination. One or pair of curly bracket’{′ and/or ‘}’ also means selecting one of them inside of it in the text and/or in the figure, if it is not a math equation.

Terms ‘configured’ or ‘includes’ used in the present disclosure should not be interpreted as necessarily including all of the various components or various steps described in the specification, and it should be construed that some of the components or steps may not be included or may further include additional components or steps.

In addition, the terms ‘-er’, ‘-or’, ‘unit’, ‘module’ and ‘system’ described in the specification mean units for processing at least one function and operation and can be implemented by hardware components or software components and combinations thereof.

It will be understood that although the terms ‘first’, ‘second’, etc. may be used herein to describe various elements, these elements should not be limited by these terms.

Furthermore, recitation of ranges of values herein are merely intended to serve as a shorthand method of referring individually to each separate value falling within the range, unless otherwise indicated herein, and each separate value is incorporated into the specification as if it were individually recited herein.

When a certain embodiment may be implemented differently, a specific process order may be performed differently from the described order. In addition, the steps of all methods described herein can be performed in any suitable order unless otherwise indicated herein or otherwise clearly contradicted by context. The present disclosure is not limited to the described order of the steps. For example, two consecutively described processes may be performed substantially at the same time or performed in an order opposite to the described order.

Sizes of elements in the drawings may be exaggerated or mitigated for convenience of explanation. In other words, since sizes and thicknesses of components in the drawings are arbitrarily illustrated for convenience of explanation, the following embodiments are not limited thereto.

In the following examples, the x-axis, the y-axis or the z-axis are not limited to three axes of the rectangular coordinate system, and may be interpreted in a broader sense. For example, the x-axis, the y-axis, or the z-axis may be perpendicular to one another, or may represent different directions that are not perpendicular to one another.

This is to treat matters basically “a container itself”.

According to this concept, no other extra container (which may be very big) is necessary, accordingly no other extra space for the extra container(s) is necessary, and treating matters became much more efficient. It needs much less time (i.e. less energy-, time-, space-consuming) by this concept named “Treat Method or Non-Dilution Method”.

It is to be understood that the embodiments of the concept herein described are merely illustrative of the application of the principles of the concept. Reference herein to details of the illustrated embodiments is not intended to limit the scope of the claims, which themselves recite those features regarded as essential to the concept.

The used terms in this concept, not confined to the listed, are following;

“FLUID (S)” means

: not only ‘Gases’ such as air, etc.,

: ‘Liquids’ such as water, milk, various kind of oil (like lubricant, crude oil, olive oil, etc.), collide, suspension, mucus, etc., and

: ‘Aerosols’ such as smoke (incl. from chimney, smoke bomb, cigarette, etc.), steam, vapor (incl. From (electronic) aerosol generator like nebulizer, etc.), bio-aerosol (biological aerosol like fungus, bacteria, virus, pollen), smog, fog, mist, fume, haze, etc.),

: but also (flowing) ‘Solids’ such as normally small things like (fine) dust (generally in the gas or liquid), beads, soil, sand, pebbles, stones, mineral, flour, powder, flake, granules, grains, (coffee) beans, fruits (including crushed), (whole) grain for soup, drinks, juices, (alcoholic) beverages, etc., and ‘additives’ themselves like ingredients, catalysts, reagents, chemicals, (fining, dying, etc.) agents, disinfectants, antiseptics, preservatives, resists, etc., including things such as stick, sheets, (roll of, stack of, sheets of, group of, crumpled, wrinkled, etc.) papers, clothes, sponge, plastic, vinyl, (chewing) gum, (ply)wood, glass, steel, which may be formed to have a space inside where may be filled with other matters, etc.,

“TREATING” ‘fluids’ or ‘additives’ means various a kind of classifying, selecting, separating (like filtering, cleaning, purifying, clarifying, squeezing, racking (lees in winemaking), (re-)fining, centrifuging, evaporating, distilling, sediment, etc.), decreasing or increasing (representative ex. ‘filling up’ the same or similar wine to barrel to remove air which causes acidification) the quantity of the fluids, adding, removing (ex. stones from rice), extracting, discharging, washing, dividing, cutting, grinding, blending, mixing, stirring, homogenizing, painting, (ex. seed) coating, spraying (agents), blowing (to dry, cool, separate, etc.), drying, moisturizing, heating, cooling, chilling, (ultra-violate rays, infrared [untarred] rays, x-rays, gamma rays, etc.) radiating (to kill living organisms like decay-causing bacteria from many foods, to prevent sprouting of fruit and vegetables to maintain freshness and flavor, and to do etc.), and also including delaying, staying, keeping, storing, putting aside, buffering, or storing at silo for a while, and also including measuring to control the treating, etc. Also it includes neglecting (similar to ‘putting aside’ above) which means do nothing artificially for a while, expecting some natural reactions like sedimentation, harmonization, fermentation, etc.

One types of treating can be done with one or more another treating methods to same or different fluids sequentially or concurrently (not necessary to be exactly concurrent).

“CONTAINER” means, including personal, private, social, public, industrial, etc. use, various:

ROOM (normally contain gas like air and all (usually 6—left, right, front, back, bottom and top) sides are closed, like living room, (school, kindergarten, etc.) class room, (station, etc.) waiting room, (semiconductor production, etc.) clean room, (hospital, etc.) operating room, etc., the inside of Building like theater, museum, (large) church, oratorium, (main) auditorium, etc.,

INSIDE of Transportation like car, bus, subway, train, airplane, submarine and space vehicle, etc.,

TANK (normally contain liquid like water or oil, and usually 5—left, right, front, back and bottom sides are closed, in other words top opened or re-capable, like swimming pool, (public-) bath, aquarium, water source, dam, oil-tanker or reservoir (including 6 sides closed), oil-fry (cooking) tank, cooking oil tank, tank (or silo, trailer container) for powder, flour, grains, kernels, beans, granules, soil, sand, etc. (including 6 sides closed), etc.,

(Body) ORGANs like heart, womb, kidney, etc., Tubes like a blood vessel, a vascular tract or a vein, etc., ETC (like earth for the fluid air, or fluid water of well, pond, lake, river and ocean, or a huge tank, which are difficult to make such a big sack (to be explained next) to cover at once.) In a sense, a container is a kind of sack (inner-container) below, which will be explained.

“INNER-CONTAINER (S) (herein after may be called just ‘sack(s)’ or ‘Sack(s)’)” is kind of sack(s) in the above container, like endothelia, (inner-)liners or (inner-)sacks inside of the above container which locates between the fluids and the above container.

It can shrink to the degree that nothing is inside and inflate to fulfill the inside of the original container.

It may be one or more sacks: in a manner of side-by-side including top-and-bottom, and in a manner of nested i.e. sack(s)-in-sack, etc. or in combination of them.

It can be made easily by cutting liner stuffs (like various kinds of vinyl, plastic, paper, clothes, net, web, etc., but graphene which is very thin, elastic, strong, and inert will be the best, not available in the near future though) and pasting (gluing, adhering, stitching, sowing, stapling, etc. and in combination of those methods) them to make an inner-shape of the container.

In case of one big inner-container, the whole for the container can be divided into several sub-sacks connected by “ ” which allows fluid passing through to the other sub-sacks. In case of complicated container, same sub-sack method is applicable. In case of ‘very’ complicated container (for example, the shape of container itself is complicate, or something complicated is in middle or everywhere), ‘Improved Molding Method’ is better to make just-fit inner-liner sacks or sub-sacks. The applicants call it “Molding” ‘in-molding’ or just ‘molding’), which may be new molding technology. It is like spray-up molding or spay-mold making, but gets shape of the inside of the object (=the outside of the space). This concept will make ‘thin mold’ which will be used as a sacks or sub-sacks to be fit into the space exactly (not to leave untreated space or matter) and hold the matters or the fluid inside.

The sack may be very thin, but durable and somewhat elastic for easy handling. Even though it is very thin, there is no problem to hold the fluid like water that may be heavy unlikely air, because the thin but just-fit sack will be sustained by the walls and bottom of the container like room or pool. So thin but just-fit sack in this concept is a kind of separator, diaphragm, etc. between (large amount of) fluid and vessel (wall or bottom of the room).

Also, it includes bottom-less (like hat), top-less (like bowl) or both-less (like cylinder) in other words wall-only sacks.

And also, it includes not-fit, not-fully-fit, partially-fit sacks. Unlikely sub-sacks which will fulfill the containers eventually; these are used just partially for the above huge containers.

In a sense, a sack is a kind of container if the sacks are nested, which will be explained.

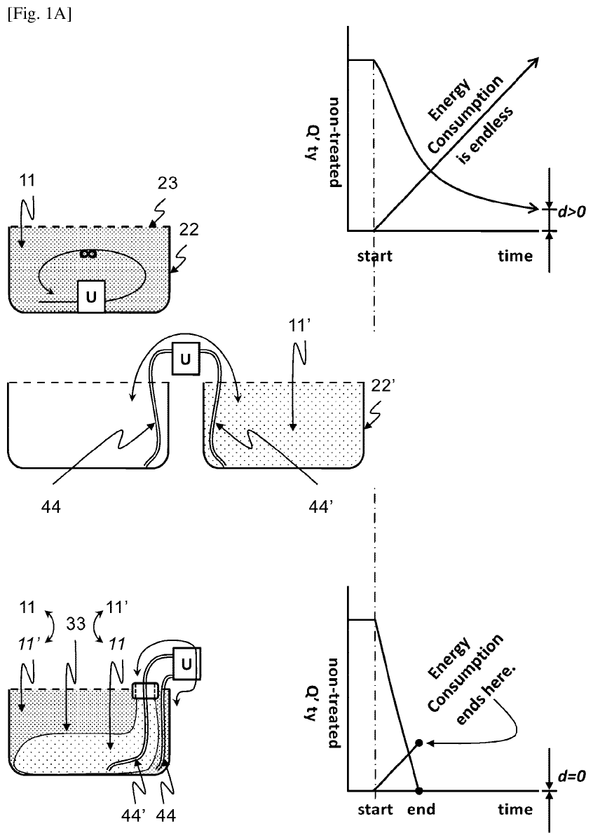

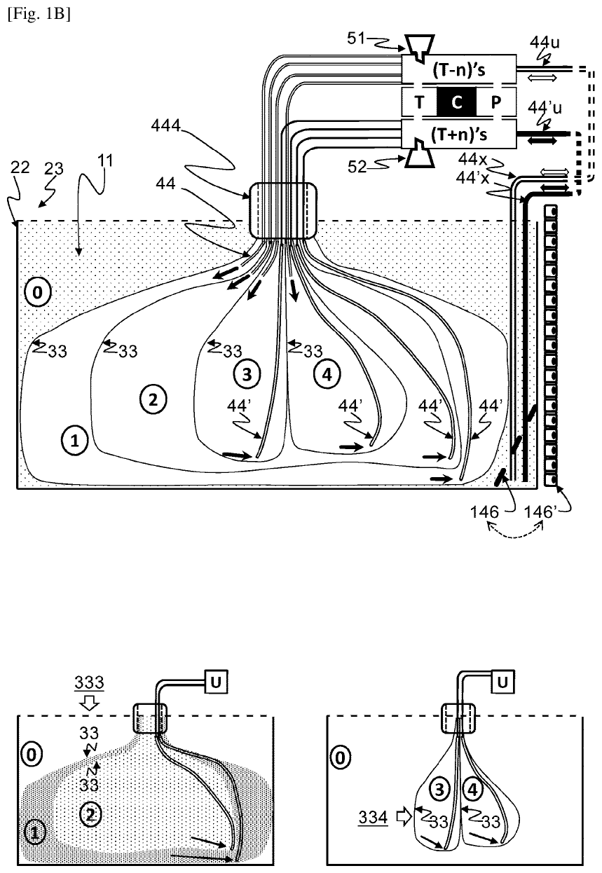

FIG. 1 is concerning the basic of the concept.

As shown in FIG. 1, the basic concept is ‘treated fluid’ replaces ‘original fluid’ by means of inner container(s) or sack(s).

Accordingly, it is to be understood that the embodiments of the concept herein described are merely illustrative of the application of the concept of the concept. Reference herein to details of the illustrated embodiments is not intended to limit the scope of the claims, which themselves recite those features regarded as essential to the concept.

As shown in FIG. 1A, a typical conventional fluid treating method is such as cleaning air or pool water, but not restricted to it. A fluid (10) is in a container (22) which may have a lid (23) or not, so it is drawn as dotted line.

Let us think a box marked with a letter ‘U’ (Unit) as air cleaner in the room, or pool cleaner in the pool. The cleaner filters the room air or pool water while circulating them, continuously until contamination is lowered to a certain desired level. However, the filtered air or water i.e. fluid is mixed to the dirty fluid again. As shown in the graph, non-treated i.e. non-filtered quantity of the fluid (y-axis) is reduced but never reaches to zero (d>0) theoretically, even though the circulation repeats infinitely (marked as ∞ in the Fig.). In other words, the conventional method just dilutes dirty fluid with filtered fluid with infinite time and energy. Therefore, we would like to call this conventional method as “Method.” which is not economical.)

As shown in FIG. 1A, in order to avoid this never-ending dilution, another container (22′) with a suction hose (44) and a release hose (44′) are necessary. Because it needs another space for the container, it may be big problem if the container is huge.

However, as shown in FIG. 1A, we can solve all the above problems with just a sack (33). Its inflated volume is not smaller than the inside of container (22), which is not essential because even smaller sack (33) may be used to treat ‘some part’ of fluid ‘thoroughly.’ The sack (33) is totally or partly flexible, inflatable, foldable, etc. or may be wrinkled, twisted, shrunken, etc.

The original fluid (10) is suctioned through suction hose (44) and treated by the box marked or symbolled as a letter ‘U’ (Unit: will be explained later), and then treated fluid (10′) is released though release hose (44′) to inside of the sack (33). The sack (33) is a kind of separator between original fluid (10) and treated fluid (10′). Even though the volume of the treated fluid (10′) increases, there will be no overflow, because as much volume of the original fluid (10) will decrease.

As shown in the graph of FIG. 1A, therefore, the non-treated quantity decreases linearly down to zero without any non-treated quantity (d=0). This results fixed time period and fixed energy consumption, without same volume extra container (22′) and space for it. Therefore, we would like to call this new method as “on-Dilution Method.” (One important thing here is time, energy and space consumption is fixed, and all the quantity is treated thoroughly and furthermore ‘evenly,’ which is much more economical than the conventional Dilution Method.)

More important thing is that through they can treat fluid thoroughly and evenly as many times as they want easily by just reversing the actuator like fan, motor, etc. (If the treating is such as filtering, the filter may be changed with new one or reversed the used filter not to remix to re-treated fluid again. If the treating is such as adding some or another ingredients one by one, just reversing the direction of the actuator is enough though.)

As shown in FIG. 1B, the sacks (33) are numbered in circle like \textcircled{1}\textcircled{2}\textcircled{3}\textcircled{4} in the figure, sack-1, sack-2, sack-3, sack-4 in text. As shown in this figure, sack-3 in sack-2 in sack-1 in sack-0. Sack-0 is container (22) itself. In other words, a container (22) such as river, lake, ocean, etc. is not only a kind of container (22) but also a kind of sack (33). This view is scalable, which will be presented.

Each sack (33) has inlet hose (44) and outlet hose (44′) respectively. The inlet hose (44) is depicted as thick black line long enough to reach to the bottom of the sack (33). The outlet hose (44′) depicted as double line white in the middle short enough for just pour or release from top. But in order to repeat treating back and forth, outlet hose (44) also may be long enough to reach to the bottom of the sack (33). To make sure the end of the hoses (44) is touching the bottom tools like weight with opening may be introduced.

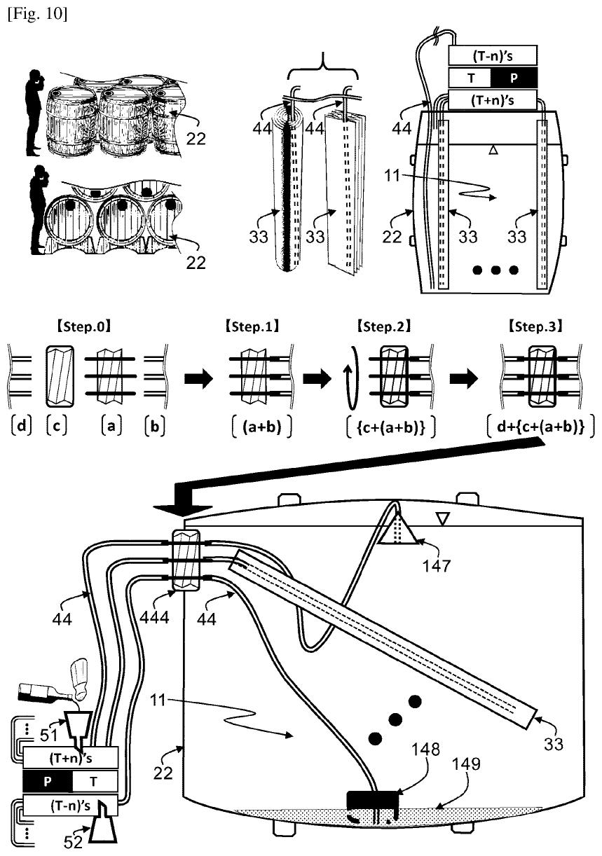

A lot of hoses (44, 44′) and top of the sacks (33) are organized by a organizer (444; details are in FIG. 10). It may have buoyancy and be big enough to hold many people.

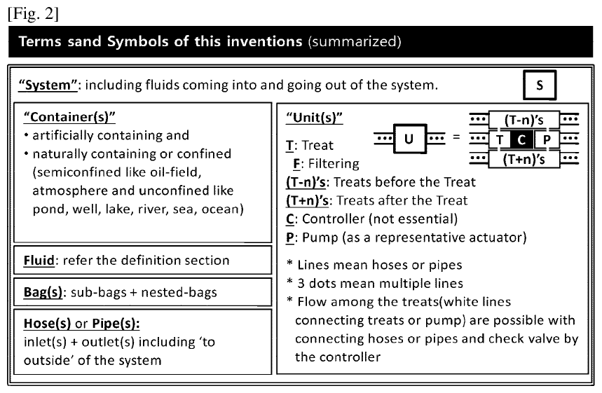

Special type of hoses (44, 44′) may be introduced. Unit-hoses (44u, 44′u) receive or send fluid (10) from or to outside of unit[U; explained in FIG. 2]. System-hose (44s, 44′x) receive or send fluid (10) from or to outside of system[S; explained in FIG. 2]. As depicted as dotted lines unit-hoses (44u, 44′u) and system-hose (44s, 44′x) may connect each other. Controller[C; explained in FIG. 2] may adjust the flow between the sacks by a flow adjust tools.

It may have a kind of screen (146) drawn as dotted line for such as to avoid the case that the sack (33) prevents suctioning of hoses (44, 44′). The screen (146) may be replaced (depicted as dotted double arrow) perforated pipe or hose type screen (146′). In order not to be stuck by the thin layer of the sack (33) according to the pressure of fluid (11) on it, it is better that the holes on the side of the pipe face the wall of the container than facing the sack (33). Just facing wall of the container (22) is enough because it is round, which is difficult to be stuck however thin the layer of the sack (33) is.

One or more of the sacks (33) like sack-4 of the figure may use for another purpose such as for ‘storing’ materials, etc.

Actually it is meaningless to distinguish inlet and outlet.

First reason is that they changes their rolls by repeating treats back and force. For the second reason, we would like to show two examples.

First example is FIG. 1B, let us assume that sack-1 and sack-2 with just one long hose (44) respectively without inlet hose are in sack-0 actually a container (22). Suction from sack-1 then (treat by unit[U]) release to sack-2. After completion, when treat once more, suction from sack-2 then (treat by unit[U]) release to sack-1, repeatedly vice versa. The hoses (44) change their rolls alternatively.

Second example FIG. 1B is obvious with the above just changing sack numbers.

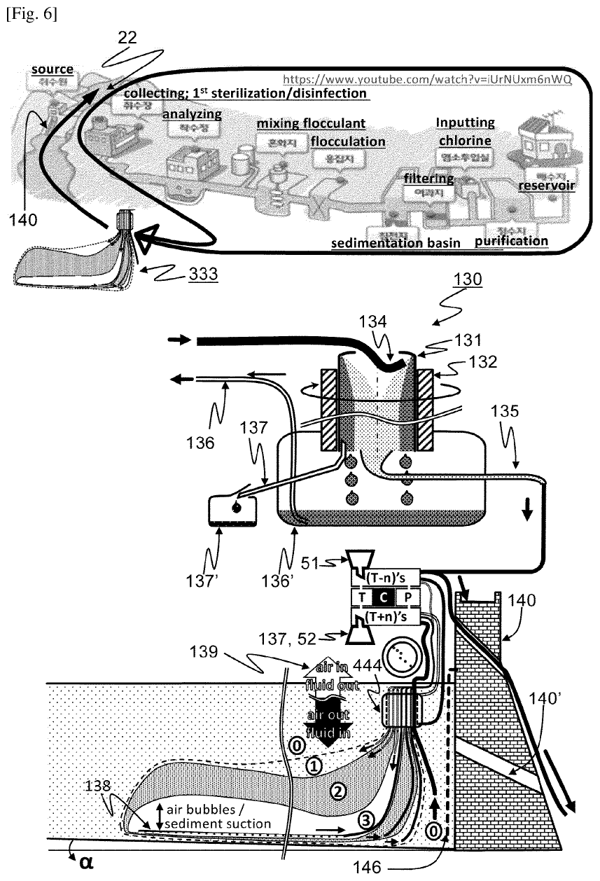

This concept may include adder (51) to input something like additives, agents, etc., and discharger (52) to remove something like precipitate, sedimentation, results of treats, etc. An example of adder (51) and discharger (52) is in explanation of FIG. 6.

FIG. 1B is a example of combination comprising FIG. 1B (nested-sacks) and FIG. 1B (side-by-side including top-and-bottom sacks). According to the necessity, they can be combined in various ways including multiple of them.

Nested-sacks (333) means sack (33) in sack (33) . . . in sack (33); each sack (33) may contain step by step treated results separately from the other step result. Side-by-side including top-and-bottom sacks (334) means sack (33) by sack (33) . . . ults separately from the other step result. There may be series of a sack (33) which may contain one more nested-sacks (333) and/or one more side-by-side including top-and-bottom sacks (334) in combinational way.

Even though the sacks (33) are numbered sequentially, actual treating doesn't have to follow the sequence. The sequence depends on situations; leakage danger to inner sack (33), short time reaction to small sack (33), etc.

Treating is more efficient, if all the sacks (33) have full inflating ability to the container (22) by wrinkle, elasticity, etc.

The unit[U] normally locates on the ground or on top of (floating) organizer (444), but may go into the one of the sacks (33).

FIG. 2 is concerning summarized Terms and Symbols in the figures.

Because the original fluid (10) is changed to treated fluid (10′) by treating once, as explained just before, and then treated fluid (10′) may become original fluid (10) by reversing the actuator to treat more times repeatedly, they will be symbolized as fluid (10) collectively, unless specifically required. It is more concise with less confusing.

With the same reason, because the suction hose (44) and the release hose (44′) may exchange their role by changing actuator direction for one or more treating, they will be symbolized as hose (44) collectively, unless specifically required.

Concerning the arrows in the figures, stealth arrows are to emphasize directions, whereas equilateral triangle arrows are for pointing parts and general directions.

“System” comprises Container(s), Fluid, Sack(s), Hose(s) or Pipe(s), Unit(s), etc., including fluids coming into and going out of the system. Symbolized as a letter ‘S’ in box in figures and [S] in text.

Concerning “ ” details are in definition section. Symbolized as a number ‘10’.

“Container(s)” comprises artificially containing and naturally containing or confined (semiconfined like oil field, atmosphere and unconfined like pond, well, lake, river, sea, ocean). Symbolized as a number ‘22’.

Sack(s) comprises sub-sacks (sacks-in-sack), nested-sacks (side-by-side including top-and-bottom vertically and horizontally) and in combination of them. Symbolized as a number ‘33’.

Hose(s) or Pipe(s) comprises inlet(s) and outlet(s) including ‘to outside’ of the system. Symbolized as a number ‘44’.

“Unit(s)” comprises various Treats, Controllers (not essential), Actuators like Pump, etc. Symbolized as a letter ‘U’ in box in figures and [U] in text.

“Treat” comprises (T-n)'s: Treats before the Treat, (T+n)'s: Treats after the Treat. Symbolized as a letter ‘T’ in box in figures and [T−n], [T], [T+n] in text. Even though they look like adjacent, one or more of them may be apart from the unit being connected by the pipe of hose (44). Some of treats may have delay, being neglected, buffering, etc. at different pace of fluid (10) flow, for such as sedimentation, harmonization, heating, chilling, freezing, etc.

“Filtering” as one of the representative treat, filters fluid. Symbolized as a letter ‘F’ in box in figures and [F] in text.

“Controller” which is not essential, controls the whole system. Symbolized as a letter ‘C’ in black box in figures and [C] in text.

It may have communication means wired and/or wireless, etc., to give and take signals internally including in circuits and externally. It may include notification means generating light, sound, smell, cold and/or hot temperature, vibration, etc., to give a kind of warning signal externally.

It may have means, processes, and/or procedures for sensing internal and/or external conditions, comparing with a set value or with input value.

With the data, the values and the signals including manual operating signals, it may compute, predict or estimate new data or value using programs like artificial intelligence.

Based on these, it may drive, control and/or adjust the actuators, electronically and/or mechanically.

“ ” moves fluid of the System. Symbolized as a letter ‘P’ in box in figures and [P] in text. P stands for Pump as a representative actuator to show intuitively. It may not be essential; some of the actuating may be done naturally. The notification means of the ‘control’ above may be classified as one of the actuators generating light, sound, smell, cold and/or hot temperature, vibration, etc., to give a kind of warning signal externally.

Some of the components listed fully above are not essential, because there are cases it works without some of them.

And lines mean hoses or pipes, 3 dots mean multiple lines, and flow among the treats (white lines connecting treats or pump) are possible with connecting hoses or pipes and check valve by the controller

Those parts above are not essential but may be used selectively.

For representative example, if the fluid (10) in the container (22) with lid (23) is volatile enough to make vapor pressure just by sun light, etc., the suction hose (44) and pump[P] may not be necessary. It is because the vapor with pressure will go into unit[U] with treat[T, in this case chilling, to make vapor to liquid] without suction hose (44) and pump[P].

If the fluid (10) is muddy water in the pond (as a container (22)) of water shortage area, the system[S] just comprising sack (33), release hose (44′) and lid (23) with confined area beneath like underwater air pocket, can make distilled water just with sun light or just with outside temperature.

For another representative example, if the fluid (10) is crude oil in the oil field, with the above presentation, refiners can make primarily refined oil just with sun light.

In the process of explaining the concept, simple applications was first explained though, those skilled in the art who understand this concept to be presented can make above systems.

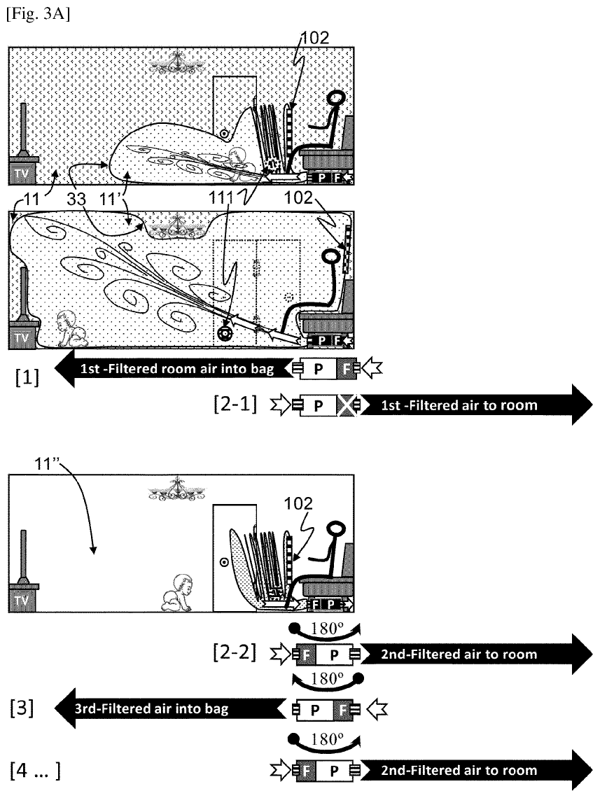

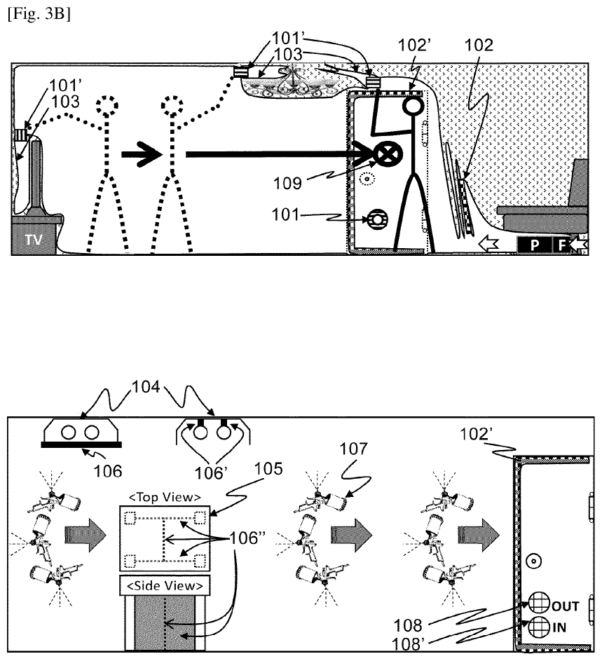

FIG. 3A is concerning a kind of application of fluid ‘air’ in the container ‘room.’

In this case, the unit[U] comprises pump[P] as an actuator and filter[F] which are located under a sofa. (Symbolizing or numbering of explicitly known matters or parts such as sofa, person, baby, TV, lightening, door, etc. are omitted through this presentation.)

Instead of extra pump[P] and filter[F], any kinds of existing ((household) vacuum-, water-, air-, etc.) cleaners use ‘motor (fan or pump) and filter.’ If they are outside of the room or house, they may connect them to a sack (33) with hoses (44).

As shown in FIG. 3A, the sack (33) in the container[C] room is inflated by treated (filtered) fluid (10′) air through the filter[F] and pump[P] cleaning the original fluid (10) air in this case dirty or contaminated air. The sack (33, packed in a box in order not to be dusted, and packing/shrinking can be done automatically by pump's vacuuming) or whole unit[U] can be stored under the sofa, etc. neatly. The baby may enter into the sack (33) through air tight zipper (102) first to breath filtered fluid (10) air as quick as possible.

As shown in FIG. 3A, the sack (33) is fully inflated with once treated fluid (10′) air. A connector (101) may be included some position on the sack (33) to connect another sacks (33) for next door containers[C] rooms consecutively, continually, and/or vertically to the upstairs or downstairs. With this, just one unit[U] cleaner may cover all the container[C] rooms in the houses or buildings (including adjacent).

As described bottom of the FIG. 3A, the first session is pumping original fluid (10) room air into sack (33) through filter[F] and pump[P], after fully inflated, then the second session is exhaling for pumping filter[F] treated fluid (10) clean air to container[C] room. Exhaling may be done just by hand pulling the sack (33) from inside, get out of the sack (33) then hand pressing the sack (33) from the outside. This exhaling may not need filter (marked as [X] at the original filter[F] position), no more filtering though.

As shown in FIG. 3A bottom, however, if they turn the unit[U] household cleaner to make it oppositely connected, not only exhaling is easy by pump[P] but also filtering once more is possible resulting twice-filtered fluid (10″) air.

There may be some ways to filter once more and more after first filtering is finished. For example;

(1) In case that the motor of the unit[U] is reversible, just switching to the reversible mode. The filter[F] may be rotated horizontally 180° to prevent the captured dust on one side of the filter[F] from mixing the filtered fluid (10) air again. Because filtered fluid (10) may contaminate pump[P] less, changing filter[F] position (before or after pump[P]) as well as turning filter[F] face may be considered.

(2) In case that the motor of the unit[U] is not reversible, just rotated the whole unit[U] horizontally 180° (leaving the filter[F] as it is), changing the connecting point between the sack (10) and the unit[U], leaving the sack (10) as it is in the room. [n] of FIG. 3 means nth cleaning order. Connecting point of unit[U] to sack (33) is: in [1] and [2-1] at pump[P] side, in [2-2], at filter[F] side, in [3] at pump[P] side, in [4] at filter[F] side, and so forth as shown in FIG. 3A.

Additional treating as many times as they want is easy just by turning the unit[U] or switching the direction of reversible pump[P], leaving the sack (10) as it is in the container (22) room, etc.

As shown in FIG. 3B, to reduce un-treated space or fluid (10), connecting small sub-sacks (103) is useful, like connecting rooms above, using smaller connectors (101′). A person may start from far inside to door. After finishing, gets out (109) to next door through air tight zipper-door (102′).

Treating may be done room by room respectively, moving the whole unit. Nevertheless, connecting sacks for each rooms by connectors is more convenient, because there is no needs to move units.

Not to leave any un-treated space (for just-fit), as shown in FIG. 3B, for the places like a semiconductor production clean room, “Method” is better than connecting the small sacks (103) of FIG. 3B.

There may be various situations though. As an example, in case of fluorescent lamp (104), applying separator (106′) leave less untreated space than separator (106′) As another example, in case of 4 leg table (105) applying 3 separators (106″) as shown in Top View is enough.

After applying separators (106, 106′), spray stripper first with sprayer (107), then the solution (like ‘Sprayable Urethane Rubber or Plastic’), if necessary apply masking tape earlier.

Put ventilation pipes (108).

Solution of stripper (to detach easily) may be applied first.

Spray the solution or melting plastic (vinyl etc.) with sprayer (107, if necessary, use sprayer equipped with heater to melt)

from the exit-door first to have time to be hardened then ceiling,

then wall and at last floor, without disconnection.

After the door side is hardened, cut and detach the mold of door (top, bottom, handle side) then attach air tight zipper-door (102′), just taping may be enough though.

Get out through the zipper door and original door.

Ventilate the inside of mold through the ventilation pipe out (108) and in (108′), which may be used as inlet and outlet of the pump[P] and filter[F] afterwards.

After full hardening, detach the mold from ceiling, wall and floor.

The detached mold will be used for non-diluting air cleaning, which will result perfect (no space un-treated) cleaning the fluid air with prompt and great efficiency.

Once the sack(s) are made, it (they) can be used repeatedly. And they can make some more extra molds before removing the masking tape, etc., which take some time and effort to set again.

Same as the living room of FIG. 3B, the production room may be connected by the connecting method, which can treat with 1 unit[U] without moving it, and sub-sacks method also applied explained if the line is very complicated.

This molding method may be also used for not only living room, kindergarten class room, semiconductor production etc., but also liquid containers like swimming pool or etc. In case of no ceiling structure like swimming pool, (after dry and water out) additional separators (106) expanded plates may be introduced to the extent that the mold of the additional part may cover (and fold-glue) the surface of the top side.

This can be converted or applied to other type containers[C] such as ROOM, INSIDE of Transportation, TANK, etc. of the definition section.

The space of the separator (106) removed will be filled by the thin membrane with elasticity formed by sprayed ‘Urethane Rubber or Plastic,’ etc.

Concerning the pumping and filtering system, ‘Economic Mono system’ (1 pump and 1 filter) is possible by turning Inlet-side and Outlet-side of the pump, ‘Dual system’ is convenient (inhale pump & filter+exhale pump & filter) though. Over 2 inhale and less than that exhale system is feasible, because inhale needs more time to filtering but exhale itself may not need filtering. 1 general household vacuum cleaner may be used as Mono system (over 2 as Dual system).

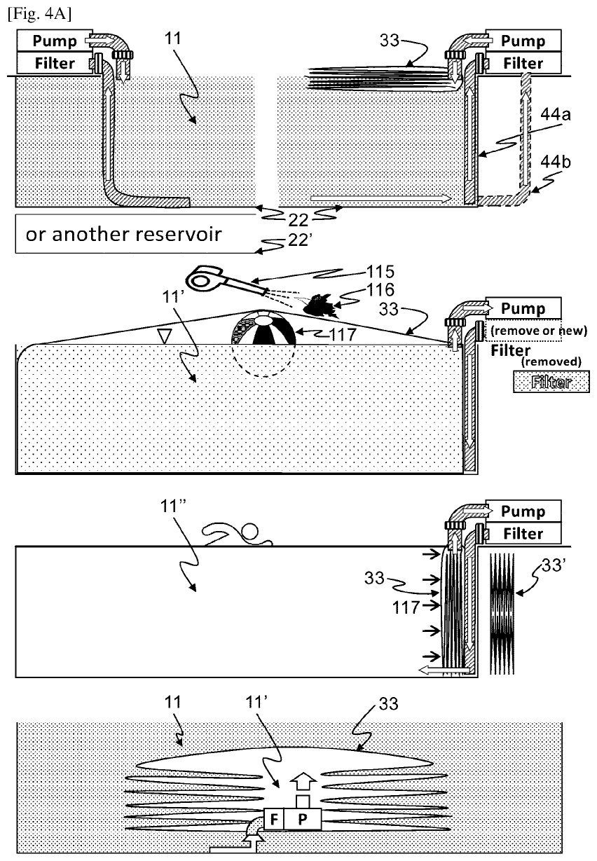

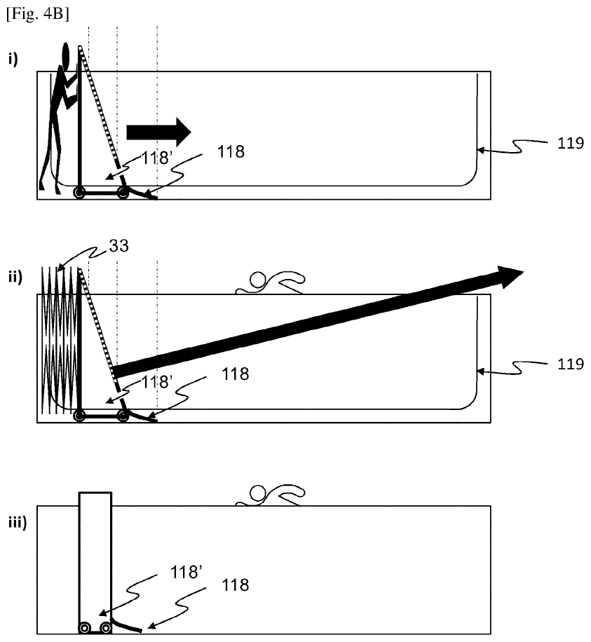

FIG. 4A is concerning a kind of application of fluid ‘water’ in the container ‘pool.’

FIG. 4A is the case of without lid (23) as explained in FIG. 1A. The present fluid (10) pool water in the container (22) pool cleaning uses Diluting Method (mixing cleaned water to dirty water of the pool again continuously), which takes long time, therefore, is inefficiency. Or it needs another container (22′) reservoir which requires another space for it.

FIG. 4A shows just introducing sack (33) folded to the conventional filtering for efficient Non-Dilution method. The hose (44) or pipe may be portable (44a) with solid line or fixed (44b) with dotted line. Even fixed, it may be installed detachably with bolts and nuts (omitted). White arrows show flow direction of the fluid (10).

FIG. 4A shows the sack (33) is fully inflated with once filtering treated fluid (10′). The fluid (10′) once filtered may be filtered again as many times they want as explained above. The filter[F] may be removed, changed with new one, or turned as explained before. The container (22) pool may locate out door, where fallen leaves, dust, etc. are headache because they will be rotten and contaminated. Therefore if the pool is not in use for a while, the fluid (10) pool water may be kept in the sack (33).

And also the sack (33) may act as a cover the of fluid (10) pool water, every odd times (1st, 3rd, 5th, . . . filtering which become the fluid (10) is in the sack (33). To prevent germ, bacteria, algae, etc. from growing, let the sack (33) have the ability such as to block the light (with black color), to pass ultra violet rays, etc. selectively and filtering (as one of treat defined before) those before flourishing, and adding (as one of treat defined before) some ingredients like precipitants, removing agents, disinfectants.

With a leaf blower or water jet (115), fallen leaves (116) on the sack (33) are easily blown out, unlikely soaked or submerged on the bottom. A kind of floater (117) may be introduced to make a slope on top of the sack (33) to remove rain, (soaked) fallen leaves, etc. with the leaf blower or water jet (115). The air inlet (omitted) of floater (117) may extend to outside (long enough to reach up to the ground) through the sack (33) in order to inflate or deflate the floater (117) form the outside of sack (33). The floater (117) may be attached to inside of sack (33) and may have various shapes like cone, etc.

FIG. 4A shows every even times (2nd, 4th, 6th, . . . results. Filtering treated fluid (10″) pool water is returned to the container (22) pool from inside the sack (33), which is ready for use i.e. swimming. When swimming, return it to the container (22) pool from the sack (33), after swimming, they may wrap it with the sack (33) again.

The sack (33) is shrunk by outside water pressure (117) and inside negative suction pressure. To shrink neatly, a kind of guiding material (omitted) such as plates, wire, etc. may be attached to the sack (33). Another type of sack (33′) is drawn and a lot of variations are possible.

FIG. 4A shows one example of the implementation. The system[S] is independent from the container (22). The unit[U] may need wireless controller and power source inside or wire to power source (omitted). The merit of this type is it can be kept under the pool water with some lightening inside and logo, etc. on the top of the sack (33) which may be seen from the outside through filtered water.

Additionally, it is space saving though, when they would like to empty to clean the side and bottom of the pool without pouring down the water to save it, the shrunk sack (33) may be moved on to the ground between as many polls as they can support the sack (33) to be filled with water. If there is a wall, it can be used instead of many polls. The thinner the sack (33), the more the polls. Then pump all the water of the pool out into the shrunk sack (33). The figure of this is omitted.

FIG. 4B shows Pool Skimmer & Clarifier

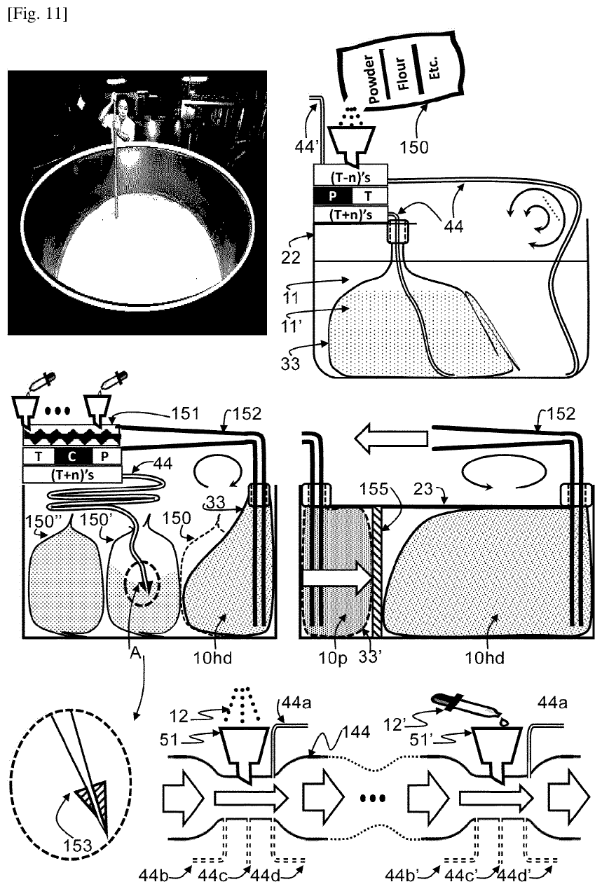

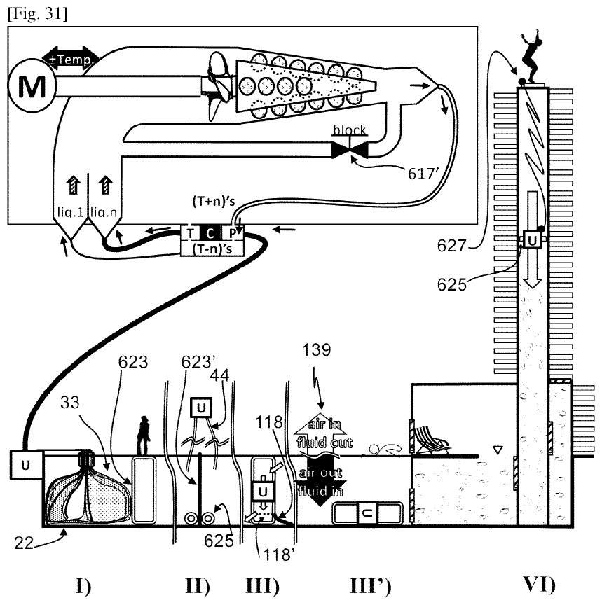

Skimmer (118) and skimmer bin (118′) may be introduced to already fallen leaves which will gathered in skimmer box (110′). A rail (119) may introduced to move directly in the track. These may be operated manually like option i) or automatically like option ii) or iii). Option iii) will be explained in FIG. 31 after septum (155) in FIG. 11 latter.

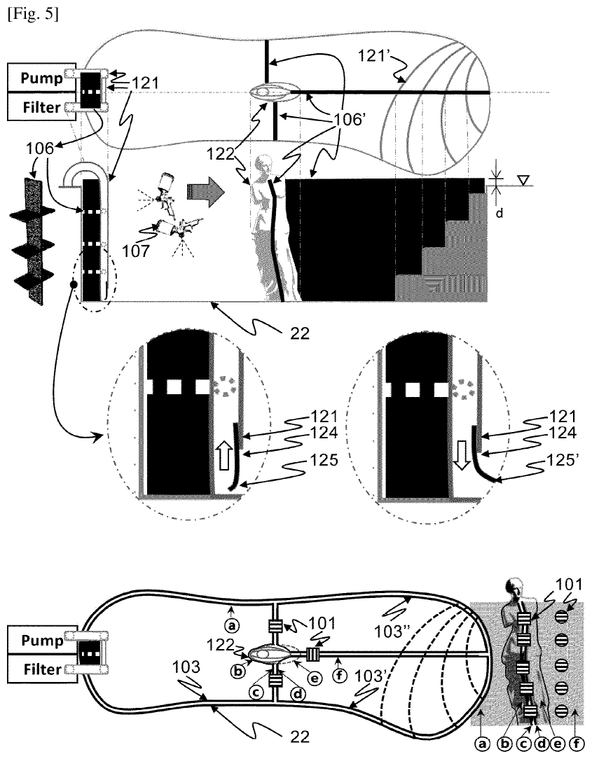

FIG. 5 is concerning a kind of complicated space.

It is similar to FIG. 3B except that sub sacks (103) are used. In FIG. 3B also, it is natural that to use sub-sacks (103) if the space is complicated or too big.

It shows that it is possible to make just-fit sack (33) even though the shape is very complicated, by comparting the space with separators.

As shown in FIG. 5, let us assume that atypical container (22) pool with pool handle stairs (121), general stairs (121′) at the side and a statue (122) in the middle.

Pump[P] and filter[F] may use general hose (44), but in this case use the left and right pipes of pool handle stairs (121) to be connected to pump[P] and filter[F] (may be installed underground for tidiness). Bottom end of longitudinal pipes of pool handle stairs (121) has openings (124) and a kind of rubber valve (125), as shown in the enlargement, to suction the bottom water well. It needs to be bent easily like rubber valve (125′) showing release, but in case of suction, if it bends up to more than half of inner diameter, the suction quantity will be rather decreased. Therefore, it is better the rubber valves (125, 125′) have core inside like metal strap of watch. It is useful when the unit[U] has a kind of buffer, because normally suction quantity is equal to release quantity. It is applied the pipe or hose (44) of the other cases also.

It is better waterspout (omitted) of the pool is beneath the rubber valve (125).

As shown in FIG. 5, the procedures to make just fit sack (33) is flowing;

Empty the container (22) pool.

Put the separators (106, 106′; Black area and white-dotted lines are separators).

Spray the solution bottom, sides and separators (106,106′) whose height is higher than the water level (depicted as ‘d’) not to wet by the water of step 6 for better combining between side spray and top spray of step 6.

After hardened, remove the separators (106,106′) leaving sub-sacks (103, 103′, 103″, . . . .

Connect the compartments i.e. sub-sacks (103, 103′, 103″, . . . by connectors (101).

To make cover (top) which may be water-tight,

i) attach other cover-material to the sides by stitching, (instant)gluing, taping, stapling, clipping and/or etc., or

ii) fill the water up to ground level (marked as ∇ in right side of FIG. 5), then spray the solution on top of the water from the edge of each compartment i.e. sub-sacks (103, 103′, 103″, . . . which will form the top cover after hardening the solution and be combined (including chemically) with sides.

Right side of the figure shows vertical arrangement of connectors (101). Actually ‘bottom’ one connector is enough, because the water will fill each sub-sacks (103, 103′, 103″, . . . from the bottom slowly, if there is no rapid supplying or withdrawing excessive amount of water. \textcircled{a}˜\textcircled{f} are pointing each position respectively.

The above embodiments were treating with one sack (33) or sub-sacks (103) side-by-side including top-and-bottom, but not restricted to it even though they were concerning, as examples, room air or pool water cleaning. From now, with proper examples, we are going to disclose “Nested-Sacks” or “Sack(s)-in-sack” which we would like to call.

FIG. 6 is concerning a kind of tap water production by ‘Nested-sacks’ or ‘Sack(s)-in-sack.’

FIG. 6 shows tap water production procedure: from source, collecting for first sterilization or disinfection, analyzing, mixing flocculants, flocculation at the sedimentation basin, filtering, inputting chlorine, purification, and reservoir. The present system needs not only many steps but also a lot of spaces or area.

As shown in this figure, all the above steps and spaces may go into the system[S] with a nested-sacks (333) and the nested-sacks (333) is laid down under the river.

One important thig is a liver (lake, ocean, etc.) itself is the container[C].

A dam (140) is not essential, because the sack (33) or nested-sacks (333) may be laid under the no dam river and be tied to the ground

FIG. 6 shows details of FIG. 6. A centrifuge (130) may have a top edge covered centrifugal-cylinder (131) which may have (iodine) magnet (132) to attract matters attracted by magnets. It is supplied with fluid (11) to be treated through upward-hose (134). The fluid (11) will form a several layers. They can take, for example, three part; center layer with less matters, middle layer, outer layer with more matters. The figure shows three examples of taking out, not restricted to them (may be used in combination).

Type-1 pipe (135) from center layer may go directly to out of unit[U] like another sack (33) for another treating, out of the system[S] for final use like tap water, etc.

Type-2 pipe (136) from middle layer is gathered in a bowl (136′) of the unit[U] for retreating in the unit[U], etc.

Type-3 pipe (137) from outer layer gather in another bowl (137′) outside of the unit[U] for another treat out of system[S] like waste reprocessing. Type-3 pipe (137) for outer matters may have, at the end, blade to scrape out matters gathered inside surface of the centrifugal-cylinder (131). This scrapping out helps maintaining magnetism of magnet (132) by shortening the distance to the matters. Type-3 pipe (137) acts like discharger (52) explained in FIG. 1B. As an example of the adder (51) of FIG. 1B, in this tap water case, additives out of the system[S] like chlorine, flocculants, other coagulants, etc. may go into it.

The centrifugal cylinder (131) may set horizontally, or at any angle also.

Mixing flocculants, chlorine, etc. (if sack-3 is determined) needs stirring. It can be done by moving things like fluid (11) water proof (robot) fish, shaker, etc., or making air bubble through perforated bubble-hose (138, depicted as withe dotted line at the bottom side) which can be used to suction sediments also, as shown in sack-3. Conversion to other treats is easy too.

Up and down arrow (139) symbolizes the organizer (444) with empty inside may float up by air-in or fluid-out (in order to do maintenance, repair, etc.) and submerge down by air-out or fluid-in (in order not to be seen from outside).

Symbol ‘a’ at the bottom means, because it's upstream of a river, this slope (a) may be used in gathering sediments by gravity with gentle bubbling.

If volume of the sacks (33) are same, the longer one is better than wider, for aquatic animals' safety and easy production of sacks (33).

It may have screen (146) for such as to avoid the case of sack (33) to prevent releasing dam (140) water through dam-hole (140′). As explained in FIG. 1B, the screen (146) may be replaced simple perforated pipe or hose type screen (146′).

This embodiment may be applied to treating fluids (11) like living sewage, septic water, radioactive water, etc., also.

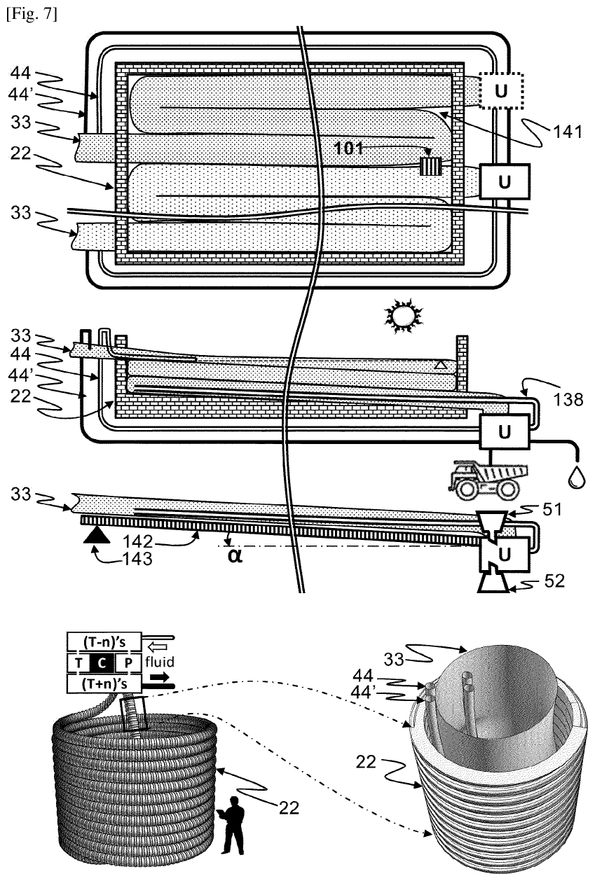

FIG. 7 is concerning a kind of sewage treatment (if a big width sack is not available).

Because a long plastic sack is easier to make, long plastic sack case is presented (for factory yard, etc.). They may install one long sack bent or connect short ones by the connectors (101; connecting side by side or between end and beginning), according to the sewage situation and quantity.

Shown as in FIG. 7 top view, in the container (22) two sacks (33) are side-by-side including top-and-bottom. They may be connected by the connector (101) if necessary. Each of them is bent like ‘S’ shape (not restricted to this shape), and three layer stacked as shown in FIG. 7 side view. The figure means filling long thin tube into a box, not depicted accurately though because it is for intuitive understanding. The sacks (33) are differently dotted just for distinguishing purpose. They are connected to the unit[U]s respectively, directly or by hose (44, 44′).

In this case, fluid (11) is not in the container (22) directly, but in the sack (33) and hose (44, 44′), because sewage may be smelly. Cleanly treated fluid (11), however, may be there for space saving.

Actually a kind of vacancy like a space (141) is not left if the (plastic) sack (33) is thin enough. It is not a problem however thin the sack is, and however many (high) the stack is, because the pressure between inside and outside of the sack (33) or between inside of the sack (33) and wall of the container (22) is ‘offset or canceled each other.’ (The detail explanation is in “related industries”

Because the sack (33) is very thin, if they really worried that it will burst, which will never happen though, put some water in the container (22), whose (water) level is going up while the sack (33) is filled up. The space (141) will be filled from the bottom at the same level with the fluid (11) waste water filled. Most of the added water to the vacancy space (141) will spill over when the hose (44) is fully filled up.

Shown as in FIG. 7 side view, three layers stacked on the slope. To use solar energy properly, (alternatively) transparent, tinted, or colored plastic sack (33) or cover (omitted) may be used. Perforated bubble-hose (138, similar to 138 of FIG. 6) may be included. It is to have penetrated the sack (33), but there is no need to do so. It can be put in like any other hoses (44), but it can have a perforation (omitted) that needs to be fixed facing down, and it is a case where a certain amount of strength is required like a steel pipe.

The perforations (omitted) of the pipe or hose (138) may supply air, O2, N2, etc., which may be returned from the top end. Sludge etc. will be sedimented slowly and coming down along the (spiral) slope to the bottom by the bubble from the perforations of the bubble-hose (138).

If the hoses (44, 44′) pierce from the bottom, needed when necessary, leakage problem may happen.

Shown as in FIG. 7 side view, it is one layer on the slope. If the yard is broad enough, container (22) or stacking is unnecessary. (‘Thick’ sack) one layer is enough. Simple plate board (142) and pedestal (143) make slope (α) for various treat instead of brick structure of FIG. 7. Unit[U] may be included for sedimentation, filtering, centrifugal separation, bio-reacting, etc

The adder (51) for the above agents and/or the discharger (52) to get rid of a certain matters explained in FIG. 6 may be introduced.

The above is an side-be-side example, however sack(s)-in-sack or nested-sacks (333) and/or in combination with side-by-side including top-and-bottom are possible too as explained before.

Shown as in FIG. 7 and FIG. 7 magnified some part of the former in 3D-view, the container (22) may be formed in the form of spiral, which is for narrow and/or temporary site, etc. A number of sacks (33) and hoses (44, 44′) are inside of it, the Nth sack (meaning one of many sacks) and N-lth and Nth hoses are drawn and the others are omitted though.

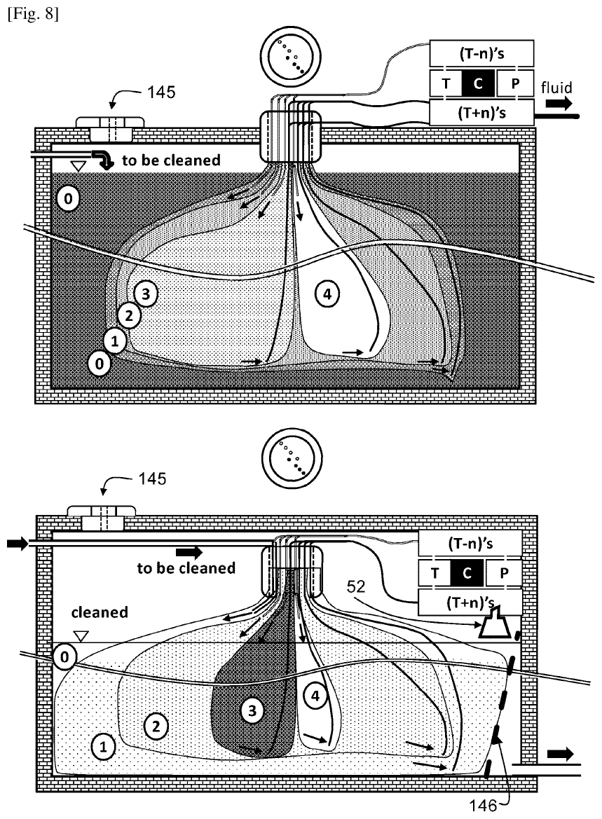

FIG. 8 is concerning a kind of septic tank (simplified, but with flexible compartments).

The basic concept is similar, as explained many times before (repeating symbols and numberings may be omitted). The variations, however, are diverse. One of them is application for a kind of septic tank. On top of the tank is manhole (145).

Shown as in FIG. 8, in this case, the fluid (11) to be treated, i.e. dirty, flows into the container (22) septic tank first.

Shown as in FIG. 8, contrarily, the fluid (11) to be treated, i.e. dirty, flows into the sacks (33) first. In this system finally treated fluid may get out immediately through discharger (52).

In case of coming fluid (11) is for example toxin, sending it to inner most sack (33) not to spill out.

As explained before, both figures are dotted as dirtiness decreases, the sequence does not matter. and the Nth treated fluid (11) may go into any other sack (33) for next treating repeatedly.

One or more of the sacks (33) like sack-4 of the figure may use for another purpose such as for ‘storing’ materials, etc.

It may have screen (146) for such as to avoid the case of sack (33) to prevent suctioning of hoses (44, 44′).

Because the compartments are not fixed, in other words ‘flexile,’ the volume of each compartment can be changed ‘automatically’ according to the situation.

Even though a kind of general plastic sack (33) is enough for general fluid (11) such as water, for the fluid (33) containing reactive matters such as ammonia coming into septic tank, the graphene, which is thinnest and strongest as far, is the best to make sacks (33). Mass production method of the graphene is required.

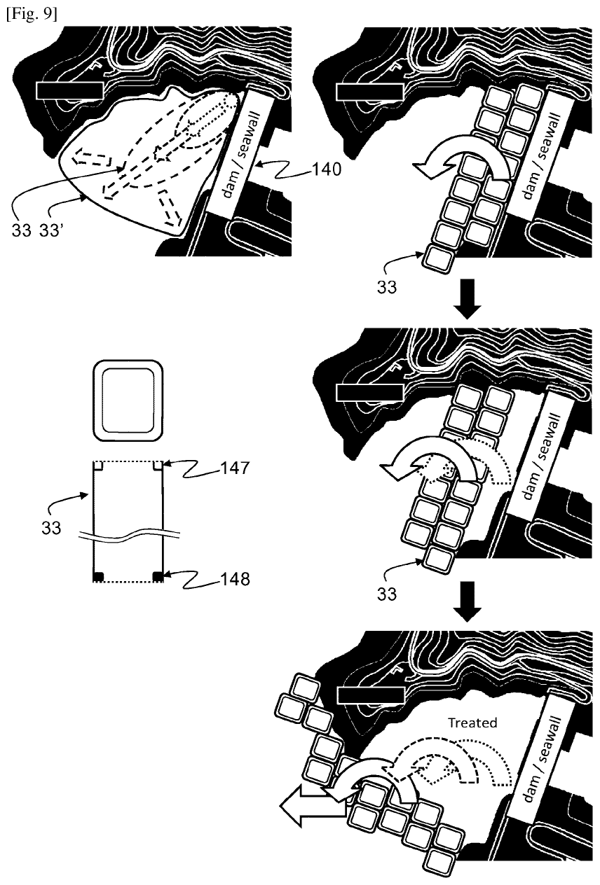

FIG. 9 is concerning a kind of removing green algae, red tide, jellyfish, etc. in touristic beach, etc.

It is a contour map near downstream of the river and the sea with lots of green algae, red tide, jellyfish, etc. to be removed.

Dam (140) or seawall is not essential, to show this concept is applicable to a kind of open container (22) like sea, etc.

The unit[U] may be on the vessel or on dam (140), etc. connected to the sack (33) through long hoses (44). Some of them are not drawn for simplicity.

As shown in FIG. 9, wrinkled or shrunk one big sack (33) or more than one small sacks (33) connected by the connectors (101) inflate by the treated (green algae, red tide, jellyfish, etc. are filtered by the unit[U]) fluid coming into. And similar procedure explained above.

As shown in FIG. 9, two series of small but y-axis long sacks (33) as in FIG. 9 makes barrier. The sacks (33) may not be connected and moving forward in the figure, leaving treated water behind.

In those case, the big sack (33) or connected small sacks (33) may not have top side and/or bottom side i.e. cylinder type sack which is cheap and easy to handle (depicted as dotted line FIG. 9).

The length of the sacks (33) may be long enough (about 1.3˜1.5 times of sea level considering the wave height) to reach to the bottom of the sea. Topless sack (33) may have buoy (147; somewhat different from floater (117)) at the top and/or with weight (148, poise) at the bottom. Even without top of the sack (33), if the buoy (147) is high enough for the wave not to over, and the length of the sack (33) is longer than wave height plus sea level, confining sea water is possible. Sack(s)-in-sack is possible too.

The weight (148) is not indispensable, because the fluid (treated) to be filled itself will do that role. Nevertheless, it can be an anchor.

FIG. 10 is concerning a kind of making (alcoholic) beverages, etc.

A beverage industry, for example, making wine needs various kinds of treats not just filtering but also repeating in and out of the barrel, inputting some agents from time to time.

Shown as FIG. 10, container (22) barrels are stacked vertically and/or horizontally.

Shown as FIG. 10, in order to input the flat and wide sack (33) in to small hole of container (22) barrel, it may be rolled or folded, including crumpled, etc. It may be inserted into the hole of container (22) barrel horizontally stacked directly as shown in FIG. 3-A.

Shown as FIG. 10, however, vertically stacked barrel like in FIG. 3-B may have a hole under the liquid level (depicted as tringle) another type of organizer (444) may be introduced. The organizer (444) may be prefabricated as shown in FIG. 10: linker (a) with bolt has short pipes inside which links hose container side (b) and hose unit side (d) by screw tightening nut (c), according to the steps depicted in the figure as an example. The organizer (444) may have variations such as different number of short pipes, etc. to connect more sacks (33), or endoscope with light (omitted), etc. Three dots in the figure means many more sacks (33), hoses (44), sack(s)-in-sack, etc. are possible.

The hose (44) connected to buoy (147) may release a kind of agents form the top, or suction top layer fluid (11). The hose (44) connected to weight (148, poise) may suction lees (149, dregs), etc. It may have screen to pass the fluid (11) while suctioning. The buoy (147) may adjust buoyancy by air in and out through another hose (44, not drawn), therefore this function may combined with weight (148, poise) into one. Floating level may be controlled remotely, with endoscope. This may be applied to the other embodiments also.

FIG. 11 is concerning a kind of blending like making solution or dough

This is one of the embodiments adding something to fluid (11), whereas the other ones were mainly extracting something from fluid (11) like filtering, etc.

As shown in FIG. 11, it is hard work to blend powder like flour evenly with the fluids (44) like water to make such as solution of low-density, dough of high-density, etc. The reason is flour does not dissolve because of insoluble starch granules, proteins and lipids, but they absorb water.

As shown in FIG. 11, however, repeatedly (depicted as round double arrows and dots) mixing very small amount of flour to water will make evenly diluted solution easily in one container (22) with a sack (33), two hoses (44) and unit[U]. At the beginning, the fluid (11) water not only may be in in the container (22) but also may come into the system[S] form the outside through hose (44′). The hose (44′) may be used as release hose (44) sending finished fluid (11′) to outside also. A folded part at the right side of the sack (33) means it may expand more enough to fill the container (22), omitted in the other figures though.

As shown in FIG. 11, the feature of high-density solution like dough is ‘less solvent’ like water, ‘almost same with original volume’. It may need something like kneading, which may be done by number of screw feeder pusher (151), and Bernoulli tube (144) explained in FIG. 11 in combination, with less water supply (depicted as pipette). Hose (44) may be transformed to tapered pipe (152) to increase pressure while passing through for water to penetrate and for time delay.

Because, in the case, the volume is similar to original and high density makes repeating treat difficult (but not impossible, depicted as clockwise single arrow), the space can be used as keeping pack (150; used, 150′; to be used). As the volume of the sack (33) increases, the volume of the flour decrease. Spear pipe (153) connected to hose (44) may be introduced. Part A in the figure is magnified to FIG. 11′. Tapered shape helps not being stuck inside, because of less density than entrance. It pierces into the top of the pack (150′), suctions flour (omitted), and automatically goes down by quite heavy self-load as the flour decreases, until it reaches the bottom of the pack (150′) and all the flour is suctioned. Then pierce the spear pipe (153) on the top of next pack (150″) and so on. It is easy to take out the empty packs. In the sack (33) high density fluid (10hd) is.

As shown in FIG. 11, high density fluid (10hd) was increased. Let us assume that the container (22) has a septum (155) inside which acts like piston. In the empty left side of the septum (155) where flour packs (150, 150′, 105″, . . . were, another sack (33′) is installed. Filling it with higher density fluid (10p) may press the septum (155) to push fluid (10hd) back out (difficult but not impossible, depicted as counter clockwise single arrow) to tapered pipe (152). A lid (23) and suctioning from the tapered pipe (152) may help. Instead of higher density fluid (10p), high-pressure air or water may be applied. If there is no leakage or punctuation inside, no or thin sack (33) may be acceptable.

As shown in FIG. 11, to get small amount of flour (and small amount of water also), just air blown or Bernoulli Theorem may be introduced, which is one of the treats and part of unit[U]. The additive (12) flour is suctioned into Bernoulli tube (144) as a form of severely dispersed. Another additives (12′) like water again, air, steam, or other agents, etc. may go into the Bernoulli tube (144) through: hose (44a)—from the top and after adder (51); hose (44b)—from the bottom and before adder (51); hose (44c)—from the bottom and at the same time of adder (51); hose (44d)—from the bottom and after adder (51). Next Bernoulli tube (144) may have same or another additives (12′) through hose (44a′), hose (44b′), hose (44c′), hose (44d′). All those may be used in combinational.

This concept may have many variations, besides flour for bakery, etc., such as cement for ready-mixed concrete, etc. of construction industry, powder based medicine of pharmaceutical industry, etc.

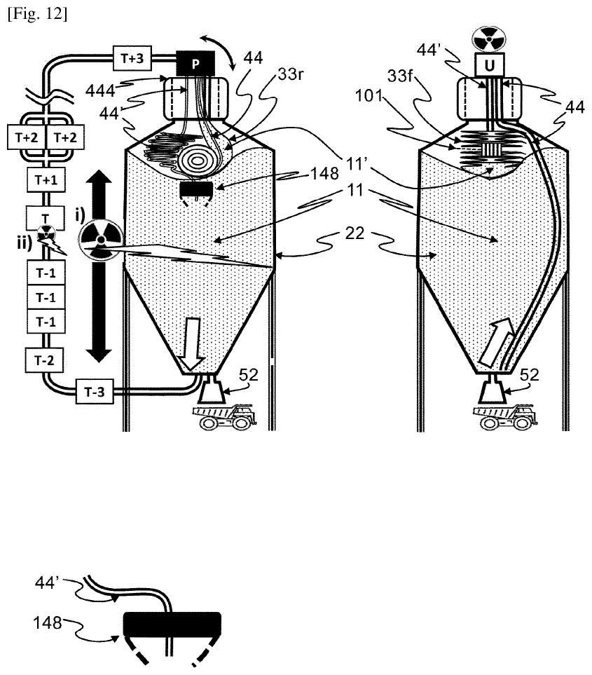

FIG. 12 is concerning a kind of treating disinfection, seed-coating, etc. of grains, etc.

As shown in FIG. 12, fluid (11) grain is in the container (22) silo. Radiation is one method of treats. Radiation disinfection from the outside of the silo (marked as ‘i)’) is not uniform because of depth (depicted as length of thunder marks) from the origin of the source. Even though the radiation source moves inside, the problem before still remains. In case of chemical disinfection to inside, using liquid type is almost impossible and using gas type like fumigant is feasible but not uniform with the same reason before.

According the concept, therefore, after suctioning through hose (44) and pumping to make it pass through the radioactive or chemical applying area (marked as ‘ii)’) in a row will result very uniform treating, less radiation quantity (depicted as smaller radiation mark), and short radiation range (depicted as shorter thunder marks), moreover without any extra space as explained before.

As an example that there may be various kinds of treats, before and after of main treat [T] radiation, there are before treats [T−n]'s and after treats [T+n]'s. Two [T+2]'s show an example of parallel treat to process more quantity to increase treat capacity. Other three [T−1]'s show an example of serial treat to process once more to increase treat precision. Also it shows an example of just treats[T] and an actuator pump[P] i.e. there may not be a controller[C], introducing controller[C] is convenient though. It is similar to other embodiments also.

Following procedure is for already filled container (22), which is difficult to install suction hose (44) into middle of the grain.

With starting pumping of the unit[S], the fluid (11) grain flows down to the hose (44), it passes the treat area marked as ‘ii)’, then goes into rolled sack (33r) in the container (22) silo. The sack (33r) start to be filled with the incoming treated fluid (11′) grain, as much as the volume of the original fluid (10) decreases, maintaining the same volume of the original container (22) silo.

At same time, the roll of the sack (33r) is unwound continuously by the pressure of the incoming treated fluid (11′) grain. Under the roll of the sack (33), there is weight (148, poise) of which enlargement is FIG. 12′, and explained in FIG. 10, connected to the hose (44′). The weight (148) will go down automatically and naturally by the down pressure of the roll of the sack (33r) and the weight of the treated grain coming into it and as the grain that supported the floor decreases. This hose (44′) is unwound or unfolded to the bottom of the silo. It is now release hose (44′), but will become a suction hose (44) for next treat vice versa.

The suction hose (44) may be built-in inside of the roll of the sack (33r). For next treat the hose (44) outside of the silo is unnecessary but it can be used for multi sack treat.

As shown FIG. 12, the suction hose (44) is already installed. This case is similar with the above. This shows folded sack (33f) and connectors (101) may be used. And this case also may need the new hose (44) inside the folded sack (33f), if it is not just one time treat.

Another example is a kind of seed coating, it also can be done easily with the concept without extra space or container (22). The farmer does not need to pack the coated seeds into small or various sizes before order from the consumers, because coated seeds will replace its own space (volume) in the container (22) silo. According to the order quantity, they may pore down them from container (22) silo directly onto truck instead of upload each packs.

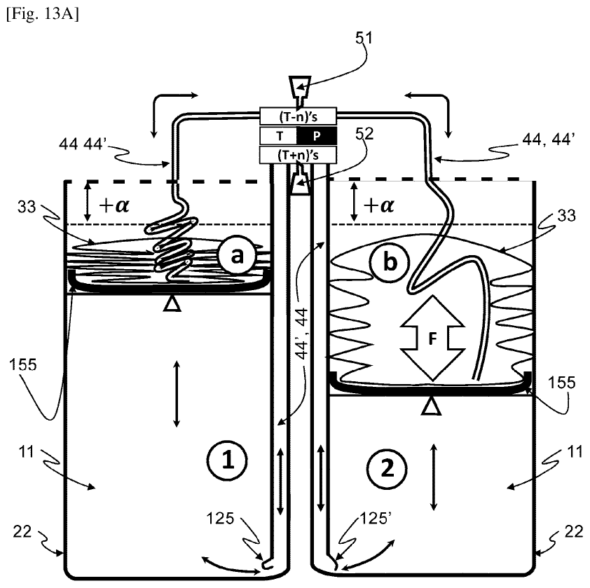

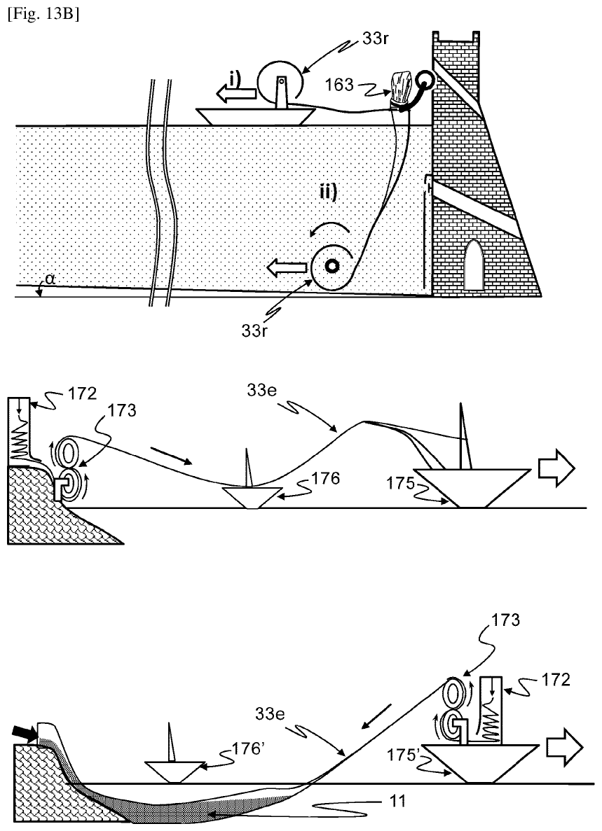

FIG. 13A is concerning use of more than one container for more flexibility

This is improved version of container (22) with lid (23) and septum (155) explained in FIG. 11 which was horizontal. Numbers and symbols are similar, except that: ‘+’ means some more space than the original fluid (11) volume, and symbols ‘\textcircled{a}’, ‘\textcircled{b}’ as sack (33) and ‘\textcircled{1}’, ‘\textcircled{2}’ as container (22) acting as sacks (33) also owing to the pipe or hose (44′, 44) inside the container (22), and rubber valve (125, 125′) introduced as similar reasons as explained in FIG. 5.

From the basic method \textcircled{a}↔\textcircled{b} and \textcircled{1}↔\textcircled{2} connecting containers (22) through the unit[U] makes more flexibility such as: treating \textcircled{a}+treating \textcircled{b}+treating \textcircled{1} to \textcircled{2}, while sending the mixture to one or more of \textcircled{a}, \textcircled{b}, \textcircled{1}, \textcircled{2}, adder (51) and discharger (52), etc.

‘+a’ may be used as buffer for some excessive quantity while gathering. This allow easy control even though the controller[C] manage to adjust within the total volume not changed.

In addition, more combinations with sack(s)-in-sack, side-by-side including top-and-bottom sacks can achieve more delicate treats, like more chemically stable reaction. Without septum (155), just with sack(s)-in-sack, side-by-side including top-and-bottom sacks variations like above is possible, such a problem as chemical safety may occur.

Both adder (51) and discharger (52) may be used as exit of excessive volume, for example, like gas generated by chemical reaction, etc.

The concepts of the above embodiments examples, not restricted to those, may be applied to the other areas, for example, using containers (22) like tank such as fuel industry, etc. which has tankers with a container (22) tank just for storage.

With the concept, however, the tanks related is not just storage, but it may be changed to processing units of a factory like refinery, even during the long time of transportation not only by vessel, etc. but also while moving through the oil pipe line.

In addition, with this concept, extra space like ballast tank of ships for balancing by filling the empty may be utilized like tank above.

In addition, with this concept, unexpected space like cave, abandoned mine, waste oil filed, etc. also may be utilized not only storage but also part of treat i.e. processing of a various kinds of industry.

In addition, with this concept, pond, lake, river, sea, etc. may be changed to not only pure water storage, crude oil storage, etc., but also factory of pure water, refinery, etc.

FIG. 13A is concerning a kind of installing a (very) long sack.

This is the example case installing a (very) long sack (33) in the container (22) lake, river, sea, ocean, etc. and the fluid (11) water. It is similar to FIG. 6 concerning example of tap water, therefore, detailed explanations and numbering parts are omitted. Producing a long plastic sack is easier and more economic than a wide one with same volume.

The (very) long sack (33) was presented to contain big amount of fluid (11) to be stored and treated. The long sack is useful to store tap water etc. for big population.

As shown in FIG. 13B, a long sack is prepared in the rolled state (not excluding folded, crumped, etc.). Case i) is on the vessel dragging the rolled sack (33r; see FIG. 12), as unrolling or unwinding on the surface of the water. Case ii) is just put the rolled sack (33) directly on the water surface or to the bottom of the river. In both cases, the rolled sack (33r) will be inflated and unrolled automatically by fluid (11) coming in.

Starting from the upstream of the river is feasible too, with anchoring the beginning of rolled sack (33r) at the riverside somewhere at the upstream, and with sealing the end of the unrolled (i.e. unwound) sack (33r) at the dam (14) or somewhere at the downstream. It is easier to unroll by the flowing down stream. The unit[U] may be installed at the beginning, end and/or somewhere between them. Instead of organizer (444), the opening of the sack (33) may be tied simply like a tied-end (163), where number of hoses (40, 40′) may be inserted to connect to the unit[U]. The tied-end (163) shows a simple method of sealing, not a recommendation. The same throughout the specification.

The release hose (44) and/or suction hose (44′) may be installed as long as the full length of the rolled sack (33r) while manufacturing the rolled sack (33r), which is unnecessary if there is no need to suction and/or release the fluid (11) form the opposite end of the unit[U]. Just longer than the water level is enough. It is because however long the unrolled sack (33) is, during the suction period, all the fluid (11) finally flows and gathers down to the hose (44) located at the downstream, by the gravity and the water pressure of outside of the sack (33), contrary to the above self-unrolling.

As shown in FIG. 13B, an almost endless long plastic sack (33) may be produced, compared to the above ong but limited length roll sack.

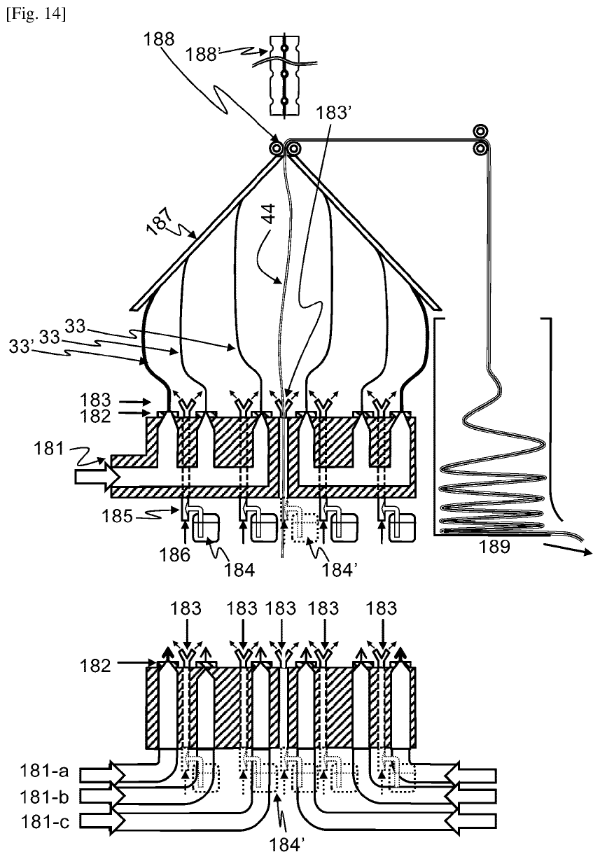

As shown in FIG. 13B, the sack factory (172; details to be followed in FIG. 14) is at the riverside or seashore, or on a dam.

As it produces endless sack (33e), a ship (175; not restricted to ship, but any type of vehicles) drags the sack (33e). There may be tensioner (173) and/or support ship(s) (176), etc.

As shown in FIG. 13B, the sack factory (172) is in a ship (175′). A shuttle (176′) supplies raw materials, etc. to the ship (175′) for endless production. The produced start-end is fixed, and the fluid (11) to be stored and/or treated is poured into the sack (33e) produced just before. The ship (175′) goes forward while producing the sack (33e).

Here, the lake, river, ocean, etc. is a kind of a container (22). In addition, the water itself of the lake, river, ocean, etc. is a kind of a container (22), too.

The hose (44) is not drawn, however, it may be included while producing, or longer than just water level length is enough, as explained in explanation of FIG. 13B.

Multiple hose (44), nested sacks or sack(s)-in-sack, side-by-side or top-and-bottom, multiple sacks and/or connectors (101) may be applied here also.

When circulating the liquid inside of the sacks to inspect or treat, using Siphon Principle saves energy. In other words, in-to and out-of the sack of the liquid can be balanced by sealing the system (similar to elevator weight balancing).

A kind of repellents, sound wave, etc. may be applied to prevent aqueous creature from attacking the sack (33).

FIG. 14 is concerning a kind of making endless nested plastic tube sack including hose(s)

As shown in FIG. 14, making nested-sack or sack(s)-in-sack (33) of ‘same’ material uses one of circular type extruder (181) which pushes melt material into (last) heaters (182). Air-supplier (186) pushes air through Y shaped air ducts (183) to make a kind of bubble sacks (33); in this case 3 bubble sacks (33). These sacks (33) pass collapsing frame (187) to make bubble sacks (33) flat. Stripper of the stripper-supplier (184, dotted line 184′ means just air stripper) to detach each sack (33) easily, may be sprayed into the pushed air by the Venturi tube (185). For stripper, just air, water, steam, powder, volatiles (like gasoline), oil, lubricant, etc. may be used. The hose (44) may be inserted through the (Y shaped) air ducts (183). It is drawn in the middle air ducts (183), and it is applicable to the other air ducts (183) also. Or another separate hole (not drawn) may be introduced. The hoses (44) and collapsed bubble sack (33) pass nip rolls (188; top view 188′) grooved to accept the hoses (44), then go to stacker (189) instead of wind-up machine.

Through the bottom of the stacker (189, depicted as 172 in FIG. 13B) the flatted three (in this case) sacks-in-sack are dragged by the drag ship (175) outside endlessly.

Because it is an example, some of components like hose (44) or number of the sacks (33) are omitted or increased. Or it may have variations such as thicker outmost sack (33′) for extra strength by wider extruder (181) hole.

As shown in FIG. 14, making nested-sack or sack(s)-in-sack (33) of ‘different’ material uses different circular type extruder (181) respectively. The others are similar with the above. Even though the extruders (181) are different, if same material is used, same material sack (33) will come out.

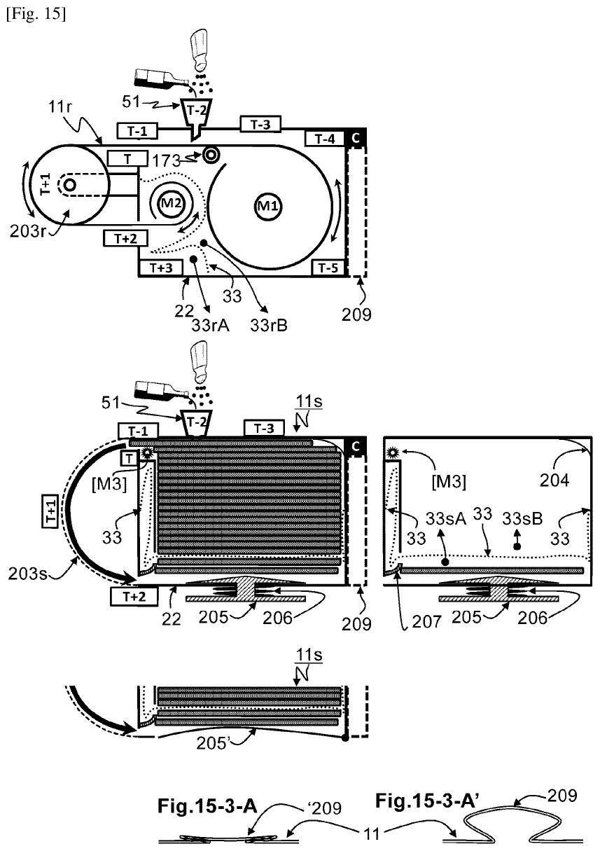

FIG. 15 is concerning a kind of solid type such as sheet, stick, etc.

At this point, we would like to remind those skilled in the art that the pressure is NOT a problem.

The first reason is that, for example, LNG is stored at about minus 130˜minus 160° C., because it will stay in a liquid state “at atmospheric pressure” when only the temperature of the liquid is at or below that temperature. Materials that cannot sustain atmospheric pressure are rare on the earth.

The second reason, more importantly, however high the pressure is or however thin the inner-liner is, the basic concept is feasible. Because it is located between the high pressure and the same high pressure (i.e. the high pressure of one side is cancelled by the same high pressure of the other side), even though it is very thin it can sustain any high pressure (besides inside of the LNG tank is at atmospheric pressure).

From now on, the concept concerning fuel industry is disclosed.

Another representative examples are tanks as a container (22) for fuel related industries such as crude oil or liquefied gases as fluid (11). This concept may be applied to tanks for Liquefied Gases like LPG (liquefied petroleum gas), LNG (liquefied natural gas), etc. Extremely low temperature of the fluid (for example, LPG is mainly propane (C3H8) of liquefaction point minus 42.1° C. and butane (C4H10) minus 0.5° C., and LNG is mainly methane (CH4) of liquefaction point minus 162.0° C. should be considered.

Even though the materials of the inner sack (33) should endure and also maintain flexibility at such low temperature, those skilled in the art can easily find that kind of materials like in the ‘space suit’. The space suit endures and maintains flexibility for astronaut to move and work at the space whose average temperature is minus 270° C. much lower than the above. Compared to the space suit, the inner sack (33) for liquefied gas is very easy and simple, because unlikely space suit there is no issue of bullet-proof (to protect astronauts from quickly moving materials in the space) or insulation. (‘space-blanket’ is similar too.)

To explain simply, plastic sacks were found at the Challenger Deep of the Mariana Trench world's deepest 10,927 meters which is much more deeper than 40˜50 meters high LNG tankers.

In case of membrane type tanks, Sliding Method also can be applied with proper cold-resistant sealing like silicon, lubricant, etc.

Concerning the pressure, therefore, putting (empty and shrunk) inner sack (33) into the fluid vertically as well as on to the fluid horizontally, etc., in other words, pumping outside fluid into vertically put inner sack (33) or horizontally laid inner sack (33) can not be a problem. However, ‘horizontally on to the top of the fluid’ method can use its self-weight to press-down the bottom fluid to produce upward pressure through the tube.

In case of spherical-type tanks, they normally have one ‘central-column’ (up to 40˜50 meters high pipe-tower comprised filling and discharging pipes, measuring lines, access ladder, cargo pump at the bottom, etc.), half-sack is useful. It will cover the inside of the tank fully, without any space left except very little space at the angular spot (the thinner inner sack skin, the less space left). If not any space left is allowed, the ‘new molding method’ mentioned before can be applied)

FIG. 15 is an example of solid fluid treatment.

The solid type fluid 11 includes a sheet or a stick having a moving characteristic similar to that of the fluid 11, together with powder or granule, etc. as in definition section. The sheet or the stick may be collectively referred to as the fluid (11) depending on the situation.

The solid type fluid 11 is easy to come out of the container 22. The inside of the container 22 may be partitioned by a sack 33, which acts like a flexible septum 155 and may constitute a sack 33 together with a part of the container 22. Of course, the sack 33 can be configured in a typical “ ” shape, but it may be concisely made by utilizing a part of the container 22.

Such a solid type fluid 11 may be seaweed, meat, etc., which can be formed in the sheet or stick form. Food and beverages such as alkaloids such as caffeine, and appetite suppressants, vitamin, etc. may be added to substrate of sheet or stick form and used. The appetite suppressant component may be glucomannan, Gymnema sylvestre, Griffonia simplicifolia, Caralluma fimbriata, green tea extract, conjugated linoleic acid, Garcinia cambogia, etc.

The sheet or stick can have a certain thickness. It may be in the form of a single sheet or stick, and may consist of two or more layers. It may be formed to have a space therein, and may have a different materials therein.

The solid fluid 11 sheet or stick may be provided, for example, in a roll form (11r; in the figure in FIG. 15), a stacked form, etc. (11s; in FIG. 15). In the drawing, the sack 33 is indicated by a dotted line so that it can be seen more clearly between several lines. Most of them are similar except for the shape, so the differences will be mainly explained.

Here, the sack 33 is a kind of flexible septum 155, that is, a new container formed in the container 22 with a part of the container-A or sack-A (33rA, 33sA) and a new container formed in the container 22-B or sack-B (33rB, 33sB) is formed, and the two spaces are completely separated by the sack 33 so that they do not affect each other.

As shown in FIG. 15, in the case of a roll type fluid (11r), it can have a sending roll and a receiving roll relatively. There may be cases where the treat is processed only once. But as the treat is repeated, the sending side may become the receiving side, and the receiving side may be the sending side. In this iterative process, according to the present concept, the sack 33 does not change the total volume of the fluid 11 in response to each volume change and the separation state is well maintained.

‘M’ in the figure represents a motor as a representative actuator instead of pump[P] as the previous representative actuator. When [M2] is driven counterclockwise, for example, it pulls the fluid (11r) of [M1]. The fluid (11r), for example, through (internal) treatment such as dehumidification [T−5], flavoring [T−4], etc., and preheating [T−3] to support the tensioner 173, which is a kind of tension holding means. Additives are added through the adder 51. After heating top and bottom (may include the sides) [T−1], [T], the fluid 11 is supported from the inside, for example, it passes through the inner guide (203r), which performs chilling [T+1] treatment, and changes the direction. It is wound in [M2] after drying [T+2], [T+3] for long-term storage. In this state, the radius of [M1] decreases and [M2] increases. In this state, if you rotate [M1] clockwise, the process reverses to the above, and this can be repeated.

As shown in FIG. 15, the stack type is similar to the roll case, so a common explanation will be omitted. FIG. 15 was drawn separately so that the sack (33) can be clearly seen.

In this embodiment, unlike [M1] and [M2] of the above example, a transfer motor [M3] that only transferring without a winding function is introduced. When [M3] is driven counterclockwise, for example, the fluid 11s sandwiched between [M3] and the container 22 is pushed out. Without an actuator such as [M3], it is also possible to make an opening (not drawn) in the upper surface of the container 22 and push it out, for example, with a thumb and/or electromechanically. The fluid 11r passes the outer guide 203s in the direction of the inner arrow and changes direction. If the transfer of the second stick proceeds as above immediately after the transfer of the first stick, the first stick is pushed by the second stick and is transferred to the front of the pusher 205 along the inclined surface of the pusher 205. As shown in the current drawing, the spring 206 is pushed back and pushes the front fluids 11 forward. By this force, the front fluids 11 are sequentially pushed, and by the slide guide 204 moves to the left side where the [M3] is. It becomes a kind of mounting state, and the subsequent process can be repeated. The treats and so on are similar to the example above. The stopper 207 slides the fluid 11 along a curved surface to pass, and stops the fluid 11 once passed so that it does not go back. Currently, only one stopper 207 is drawn on the left, but it may be installed additionally on the right, front, and rear. The pusher 205 can also be activated manually, i.e. by pressing with a thumb.

In FIG. 15, a pusher 205′ with built-in elasticity is a modified pusher 205 above, so that there is no need for a separate spring, and it can be operated manually, for example, by pressing it with a thumb and/or electromechanically.

Unlike FIG. 15, which is a truncated fluid (11), it is possible to stack consecutive long sheets or sticks vertically, horizontally or inclinedly in zig-zag wise, and it is possible to repeat treating fluid (11) forward and backward.

Treat [T] includes various treats in the definition section, such as heat treatment including cooling or heating, or drying or humidification. If [T] in the drawing is referred to as heating, the heating plate may be a roller or a caterpillar track, and may receive heat from another heating element, or itself may be a heating element. All or part of a roller or a caterpillar may be mesh.

[T−1] may be heated in the same manner as [T], or treatment such as heating or disinfection may be performed by light such as far-infrared rays or ultraviolet rays. These may be configured by combining them top and bottom as drawn in the figure, in singular or plural. In order to prevent the generated heat from escaping to the outside, it can be shielded with insulation materials such as vacuum tubes and airogels, etc. If it is for hand held, the thinner but flat insulator is better. It may be made by introducing convexed walls and/or separation inside the vacuum chamber.

Thermoelectric elements, electric resistive heating elements, high-frequency heating such as induction heating and dielectric heating, ultrasonic heating, as well as chemical exothermic reactions including body temperature can be used. It is not limited to this and may be used in combination.

For induction heating, the fluid 11 may have a susceptor. The susceptor may be an edible metal gold, silver, or the like.

In [T±n], n indicates that it can be of a different kind rather than an order. Some treats can be introduced inside the container (22), such as [T+3], [T−4], and [T−5]. One of the treats could be cutting.

Here, the stick or the sheet may be folded to have the sides and the top or bottom, or the side walls and the top and bottom are fused, bonded, or sewn to form an inner space. This can be put in, or another kind of fluid (11) can be put in the sack (33). Another fluid 11 can be placed on or buried in the substrate itself in the form of a stick or sheet, (chemically) bonded, adhered, etc., and can also enter the above inner space.

The stick or the sheet may be partially and/or entirely meshed or perforated. Different matters can enter the space formed by two or more layers and side walls.

One or more sheets or sticks can be folded or pasted to create a sheet or stick with an inner space. The upper and lower surfaces of this sheet or stick can be bonded with dots, lines, or faces by sewing, heat fusion, ultrasonic fusion, or using an adhesive, in order to reduce the height of the inner space or make it stronger. It is similar to how to make a quilt.

The sheet or stick may be two or more laminates, and one of them may be a release paper. One or more of the laminates may be induction heating receptors such as foil, etc., which can be used as susceptor during induction heating, and can conduct heat at the same time.

Although the sheet can be treated in advance, various additives can be added depending on the situation at the time of use or the needs of the user. For example, additives for adder (51) include solid such as powders like salt, sugar, etc., adhesives such as wood paste, and cream, etc., solutions such as liquids, suspensions, colloids, etc., gas such as spraying solutions, etc., and aroma substances such as gas type, liquid type, solid type, or solid with sublimation properties.

Alternatively, for example, a solution may be sprayed first and then powder may be applied or added in combination.

Control[C] has various modes. It can be done by the timer, or by sensing the heating degree or the state of the solid fluid 11. As a sensor of the above state, an optical sensor that detects the change in color due to heating may be used. The temperature can be sensed by measuring the electrical resistance of the heating element, and a probe capable of measuring the internal temperature can be applied by utilizing properties such as changes in electrical resistance when moisture in the fluid 11 changes.

Control[C] of heating temperature and actuator [M; Motor, it was P; Pump in other embodiments] can be operated to adjust the progress speed of fluid 11, to return fluid 11 back, and/or treating such as cutting to separate the solid fluid 11 to an appropriate length or volume.

The operation of the Controller[C] is operated not only manually, but also fully automatically comparing with pre-input values, semi-automatically operated by the user, or by using artificial intelligence operation such as reflecting the user's operation value.

As shown in FIG. 15, the sheet or stick, collectively called as fluid (11), may contain one or more parts that can protrude from the plane i.e. flattened protrusion (′209). This protrusion (209) may have other shapes, including a circular shape, and the outermost perimeter of protrusion (209) may be around 25 mm. The outermost perimeter of protrusion (209) may be greater than 25 mm and less than 120 mm. The outermost perimeter of protrusion (209) may be less than 25 mm.

The protrusion (209) may be molded with vinyl, silicone, etc., and it is stored after pressing it into a flat surface (FIG. 15). It may protrude when used (FIG. 15)

The sheets or the sticks may have one or more perforations (not drawn). In the case of silicone, the perforations may be shrunk up to diameter zero due to its elasticity, but when the protrusion (209) is sucked and the air inflows through the perforation by minus pressure, the diameter of the perforation may be enlarged from zero up to 5 mm.

The material of the sheet or the stick may be water-soluble. The material of the sheet or the stick may be water-insoluble. The material of the sheet or the stick may be breathable. The sheet or the stick can itself be edible.

Finished or used sheets, especially sticks, can be put back into sack-A (33sA).

The amount added in advance to the sheet can be provided in units that are intuitive to the user such as natural number, half (½, 0.5). ⅓ (0.33), quarter (0.25), etc. It may be provided in a unit length according to the user's preference or the user's motion.

For example, if the producer makes the quantity of the ingredients in the sheet or in the stick be familiar numbers; natural number, ½ (0.5), ⅓ (0.33), ¼ (0.25), etc. per unit length like 1 inch, 1 cm, etc., consumers can make it easier to calculate intuitively. However, it does not exclude those calculated electrically or electronically.

Not only sheets or sticks, but also additives may be provided in certain units as described above. In addition, it may be provided in the form of a cartridge for easy replacement of sheets, sticks or additives. The cartridge physically and/or electronically has, for example, an identifier with another brand, and the controller [C] can control with the information received from the cartridge such as components and quantities per unit length, etc.

The cartridge can be ruptured to open automatically upon insertion, or can be rotated after insertion to create an outlet. The remaining amount of the cartridge or the amount transferred from the cartridge can be estimated or measured by sensing the change in capacitance.

The amount of ingredients to be used can be controlled by the length, etc. of the sheet or stick.

The unit length, etc. can be marked on a sheet or stick. When the sheet or the sheet is drawn or transferred from the container (22) for use, a click is generated for each unit movement distance, or the controller [C] calculates it and notifies the user with, for example, sound, light, vibration, etc.

It can have a function of recording the amount of fluid 11 that exited out from the container (22), the amount of fluid 11 that re-entered to the container (22), and the time interval between exiting and re-entry by physical methods such as electricity, electronics, etc. and analyzing the time intervals in a specific period such as day, month, year, etc. It may include data input from the outside. The amount used or absorbed by the user can be estimated by time intervals, etc.

By a known method, self-certification, and/or adult certification according to the ingredients can be made. A long-distance wireless communication function can be built into the controller[C] itself. Only short-distance communication such as Bluetooth by the controller[C] is possible though, if accompanied by external device such as a smart phone with long-distance communication ability.

Such data or analysis results can be displayed through a self-display, or additional analysis, processing, and display can be performed by performing wired or wireless communication with external devices such as smart phones. In addition, data can be transmitted from external devices through wired or wireless communication.

Although the power (208) is omitted in other drawings, the present embodiment is indicated by a dotted line in consideration of a situation that can be used as a portable device. This does not mean that other embodiments cannot be portable.

At the outside of the System[S], the entire fluid (11) may be exhausted. Just some of the fluid (11) may be exhausted at the outside and the rest, for example, only the stripper, etc. may be returned.

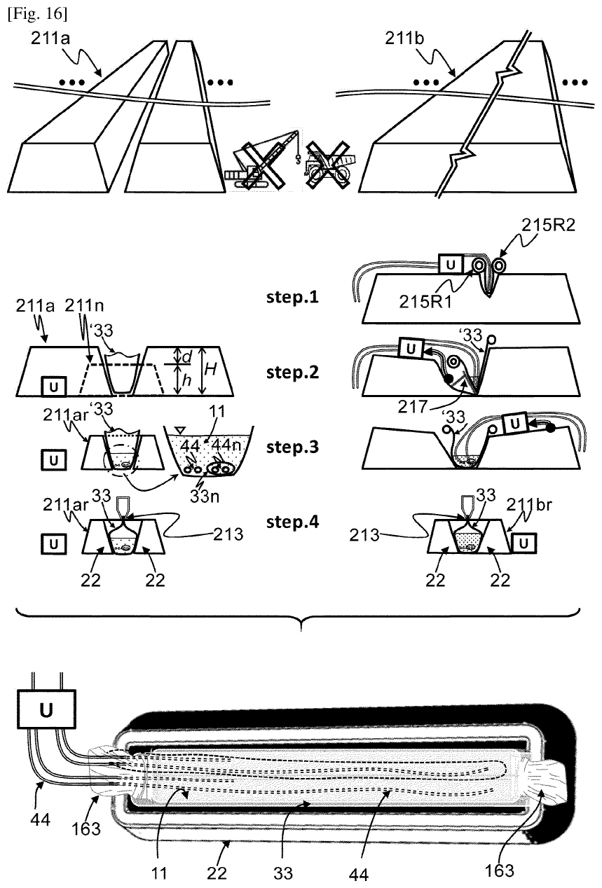

FIG. 16 is concerning a kind of treatment of contaminated sand or soil.

There is a case in which the fluid 11 that needs to be washed off due to radioactive fallout contamination, for example, contaminated soil or sand, as it is or by putting it in a hemp sack or the like (in a large amount) and stacking it as a stack 211.

FIG. 16 is a case of stack 211a with a passageway in the middle to allow the vehicle to pass. FIG. 16 shows a case in which the stack 211b is made continuously without passageway. Because of its fairly large width, it was marked as a long break line.

The three dots indicate a plurality. The symbol of heavy equipments is for comparing the size of the stacks (211a, 211b), and the ‘X’ mark on the symbol means that heavy equipment is not required to handle the stacks (211a, 211b) by this concept.

FIG. 16 is a processing by utilizing the passageway between the stacks 211a.

We use the existing passage, so we start at step 2. Two new stacks (211n; new) may be stacked at both ends of the passage to form a container 22 together with a part of the existing stack 211a. The height may be lower by ‘d’ than the original stack 211a height ‘H’. The new stack 211n can be made by moving a part from the top of the existing stack 211a. This is the first reason ‘H’ is lowered.

In the made container 22, a flexible plate such as vinyl is put in a ‘U’ shape from the front, back, left and right. It is a sack (′33) that has not yet been completed. The upper curve of the sack (′33) is the rear part of the container (22) among vinyl put in ‘U’ shape. So, in this drawing, which is a cross-sectional view in the center of the left and right, the rear stack 211n is drawn with a dotted line. The height of the sack (′33) is higher than ‘h’, so it is better to have a width enough to allow the ends of the ‘U’ to overlap later. It is good to have room to tie or seal the shear and the end in the longitudinal direction as well. FIG. 16 163 (tied-end) is related.

In step.3, as in the enlarged view of the right unfinished sack (′33), the hose (44) inside the sack (′33) is connected to the unit[U] in advance to start processing. The same is true for the additional sacks (33n; nth), including the additional hoses (44n; nth). As described above, there are various methods of adding a sack for complex processing, such as side-by-side, sack(s)-in-sack, multiple, and so on.

Sand, soil, etc. of the existing stack 211a is washed with external water, and the clean sand is immediately sprayed on the ground or transported. Washing water may be radioactive contaminated water. After repeated washing, it can be rinsed last with uncontaminated (sea) water. Sand and soil, which are most of the stack 211a, are removed to reduce the total volume, and only used water including radioactive fallout is put into the unfinished sack (′33). This is the second reason ‘H’ is lowered.

In the existing stack 211a, the remaining stack 211ar (remain) supporting the sack (′33; including 33 after completion) can be processed by the above method after step. 4 is completed.

What is important here is that solid components such as sand, which occupy most, are removed, so the volume is greatly reduced, and the amount of rinsing water is added to the radioactive contaminated water that has not been treated before, but it is a fluid (11) that is relatively easy to treat. This fluid (11) is also handled in step 4.

In step 4, the top surface of the unfinished sack (′33) is joined by ultrasonic welding or the like. The hose 44 and the additional sack 33n and the hose 44n put in advance are pulled out through the front end or end of the unfinished sack ′33, and sealed with a simple knot tied-end (163) to complete the sack 33.

The flow of fluid 11 through hose 44 is described in detail in FIG. 16.

FIG. 16 is a processing the stack 211b without free space such as a passageway.

Step.1 Two (vinyl, etc.) rolls connected prepared. Half of a large roll is wound halfway around the other roll, or the ends of the two rolls are connected by fusion bonding or the like. Two new stacks (211n; new) as shown in FIG. 16 are not required, and the container 22 can be made by leaving both sides, front and rear parts of the existing stack 211a.

Since there is no free space, making a container is started right away, while digging down from the top and putting vinyl in the form of ‘U’ in the front, rear, left and right. The volume is reduced by processing the dug out sand directly with the unit [U]. Vinyl or the like is supplied while properly unwinding the left and right rolls 215R1 and 215R2.

Step 2. Excluding the leftover part (211br) from the existing stack, digging to the ground is first. Like the three-line thick arrow, the unit [U] treats sand, etc. from the lower part of the unfinished sack (′33) first. A support plate 217 with attachments may be installed to support the unfinished sack ′33 containing the fluid 11.

In step 3, the sand, etc., in the area other than the part to be left (211br), As marked by the thick arrow of the three lines, is treated first. Repeat steps. 2 and 3.

Step.4 is similar to FIG. 16. After that, the water collected through the hose 44 connected to the unit [U] is treated.

FIG. 16 is a view from above in 3D top view, which is the final result, excluding sand or soil that has been cleaned and returned to nature. The results of FIG. 16 with passage and FIG. 16 without even passage are shown in FIG. 16.

If the sand or soil is hardened, it is quite bulky and can be crushed more finely with a small explosive and/or later with a hammer drill for excavation.

The whole process can be handled by the controller[C] of the unit[U], and the unit[U] is drawn on the ground, but it is possible to increase the pumping efficiency by installing it on the existing stack 211a and descending while processing it.

Even if it is not the above method, this concept can be applied in various ways, such as moving a part to another place and then creating a container. Concentrated contaminated water may be treated as described in FIG. 6.

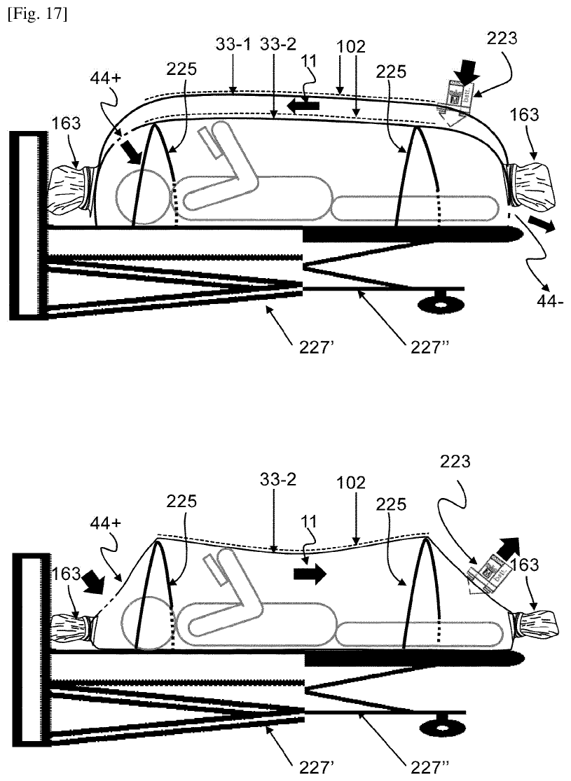

FIG. 17 is an example of sack(s)-in-sack method.

FIG. 17 is a two-layer positive pressure chamber. The negative pressure chamber keeps the patient's germs out. The positive pressure chamber prevents external germs from reaching the patient. Due to the high cost and time required to install, there were many patients, such as the COVID-19 outbreak, and there was a shortage of negative pressure chambers in countries around the world. So, it is necessary to manufacture it simply and inexpensively.

Although it may be possible with a single layer of sack, it can better protect the patient. etc., such as warmth, in field situations.

A second sack 33-2 is contained in the first sack 33-1, and both ends may be sealed with a knot 163 or the like. The ventilator 223 blows air, which is the fluid 11, and passes between the first sack 33-1 and the second sack 33-2. Here, the ventilator 223 has a concept similar to that of the unit [U], in which the actuator is a motor and drives a fan to move the fluid 11, air, and may include a controller [C].

Inlet filter (F+; indicated by dotted line in the figure) filters (again) and supplied to the patient's head in the second sack (33-2). The air in the second sack (33-2) is discharged through the outlet filter (F−; indicated by the dotted line in the figure) on the patient's foot side while exerting positive pressure inside the patient. An amount of air less than the amount of air sent from the ventilator 223 or the amount of air entering through the inlet filter F+ is exhausted. Therefore, positive pressure is applied, and air from which pathogens of the patient have been removed is discharged through the outlet filter F−.

The controller[C] inside the ventilator receives internal environmental data, patient status data, and patient operation data via wired or wireless input, and controls air volume, temperature control, and emergency signal generation, etc.

The inlet filter F+ and the outlet filter F− may or may not be used either, and both.

Therefore, positive pressure is applied to the patient, but pathogens do not escape to the outside.

The negative pressure chamber has the effect. It is said that there is an effect such as improving the performance of athletes training in the air dome. For patients, the positive pressure environment as above rather than the negative pressure chamber is helpful.

It can also be used by athletes or the general public, not patients.

This case is sack(s)-in-sack though, the side-by-side or a combination of them are also possible, so that various functions can be performed.

Each sack may have a respective airtight zipper 102 that can be accessed by a patient or the like.

The ventilator 223 supplies air to apply positive pressure. If the fan 223 has a reversible function, it can also be used as a negative pressure chamber or others.

FIG. 17 shows simple personal negative pressure chamber. Mostly similar to FIG. 17

It is possible to put the spacer 225. The spacer 225 is unnecessary in a positive pressure situation, but can relieve the patient's discomfort when in use.

To open the airtight zippers (102), it can have the function of turning the reversibly so that contaminated air does not go out.

The ventilator 223 may have a filtering function. The ventilator 223 may have a reverse operation function of inverting the ventilation.

The bed 227 means that it can be used for a hospital room including a home bedroom (227′) and an ambulance (227′). It can be applied not only to private beds for field use, but also to hospital rooms and personal protective equipment.

FIG. 18 is an example of a conversion to active form.

It is a kind of conversion of FIG. 17 for bed into an active form, and the basic concepts of FIG. 17 can be utilized. For convenience of drawing, it is shown based on FIG. 17, but the features of FIG. 17 can also be applied.

The tied-end 163 may be difficult to maintain air tight, but has an advantage that can be simply applied in a field situation, and it is also to show that the basic purpose can be achieved even if the air tight is not perfect.

The number of seals or tie-end 163 of the envelope 33 is two if it is a tube-type material, and one if it is an envelope-type material.

Positive pressure prevents bacteria from entering the outside air for patient protection. Even if the air around the patient is not filtered and leaks through the gap of the tied-end (163) by positive pressure, it does not matter. This is because filtering only the incoming air is enough.

The negative pressure is to block or filter out the air from the patient's respiratory system to protect the people around the patient. It is not a problem because it is a structure that filters when external air enters by negative pressure through the gap of the tied-end 163.

In order to increase the airtightness of the tied-end 163, after making the tied-end 163, the gap may be sealed by applying an adhesive or simply taping. It, therefore, is not to exclude various fusion methods, etc. in manufacturing.

The spacer 225 may be unnecessary when positive pressure is applied, but when negative pressure is applied, it may be useful to relieve the user's stuffiness.

An inlet filter F+ may be installed on a part of the envelope 33, and when positive pressure is applied, it may be converted into an outlet filter F−.

FIG. 18 is applied to the upper body. Although it is shown that the ventilator 223 is held in the hand, it can also be applied to the waist as shown in FIG. 18.

FIG. 18 is applied to the head. This is the active as it is limited to the minimum area that needs protection. The ventilator 223 may have a hose 44. Since it is difficult to directly apply the ventilator 223 to the sack 33 limited to the head, the hose 44 from the waist or hand may be introduced. Of course, it does not exclude that it can be applied by miniaturization.

FIG. 17 can be used for beds also.

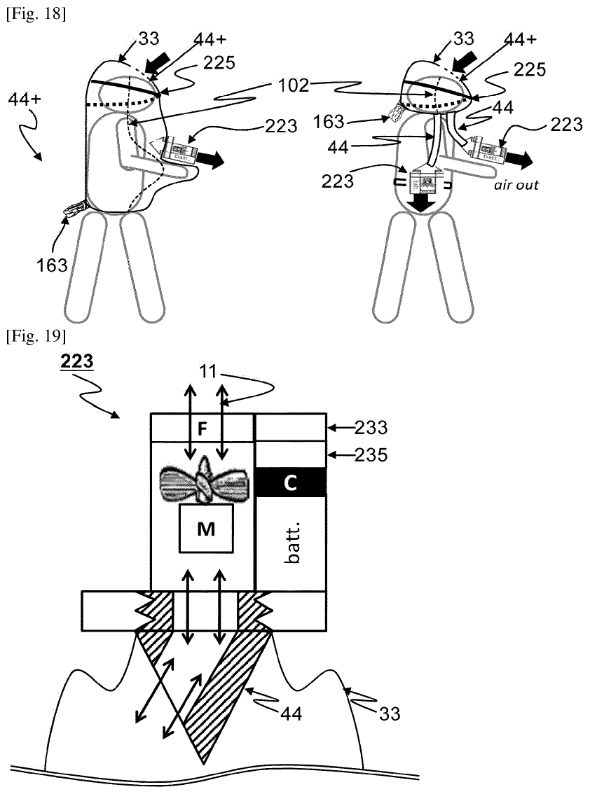

FIG. 19 is an example of ventilation.

It relates to a detailed description of the ventilator 223 mentioned above.

The basic concept is to simply install the sack 33 while maintaining airtightness.

The ventilator 223 may be able to rotate in reverse. However, it is explained in detail in FIGS. 4A and 4B that the filter side may be changed when switching the rotation direction.

The power source can be battery or wall power and can be converted by an adapter.

It is not excluded that air is supplied through the hose 44 using an external ventilation facility.

The hose 44 can be connected to another hose 44.

Methods of combining the ventilator 223 with the envelope 33 include i) an adhesive method, ii) a forced fitting method, iii) a screw connection method, and the like. An existing opening of the sack 33 may be used, or a new one may be made.

The hose 44 may have a pointed portion. A new pipeline, as an example, can be made by piercing the sack (33) with it.

As is mentioned, It may have a means for sensing internal and external conditions such as air temperature, patient's body temperature, drug residual quantity, battery residual quantity, driving status of a fan, etc., and comparing with a set value and monitoring.

Based on this, it can be adjusted by the controller [C] using the predicted value, the estimated value, or the deviation from the reference value, and transmitted to the outside through the notification means 233 and the communication means 235.

Examples of the notification means 233 are light, sound, vibration, and the like, and examples of the communication means 235 are wired, wireless, and the like.

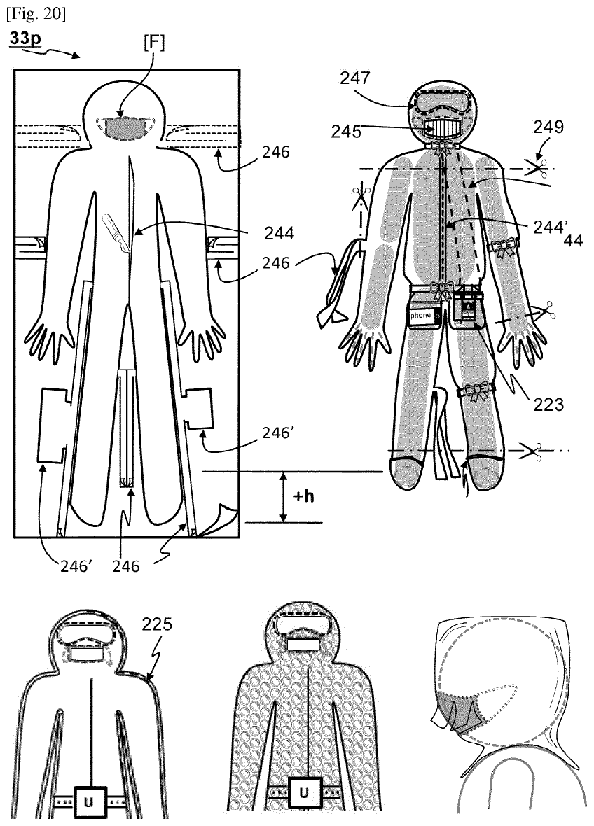

FIG. 20 is an example of variation of sacks.

It relates to making and using the sack of a different shape than the conventional one.

An elongated bag is common, but it is necessary to economically manufacture an appropriate shape because it may be very strange when applied to a person as shown in FIGS. 18-1 and 18-2.

An example is making a personal full body protective suit. By cutting by cutter (249) or being omitted at the time of production from the beginning a part of the full-body protective suit, a specific area, for example, the head protective equipment as shown in FIG. 18 may be made. This protective suit can economically include a variety of accessories.

FIG. 20 is a form for making a protective suit.

FIG. 20 is a form to be worn.

The material may be inexpensive and easily heat-sealed transparent vinyl, etc. or a durable material such as a silicone sheet, latex, etc. may be used.

Two sheets of vinyl (243) are stacked, fused and cut as shown in the drawing. It is also possible to do both fusion cutting at the same time. It does not rule out molding into a desired shape or cutting and pasting the three-dimensional into small planes.

It is possible to put an incision 224 that the user can enter. Do only the top one of the two sheets. This incision may have sealing 244′ on it after the user enters. An airtight zipper, taping, adhesion or the like may be applied to the sealing 244′. Release paper can be applied to the taping. They can make a strap (246) that can be tied by using the margin to be discarded. The neck strap 246 can be omitted in the full body protective suit so is shown in dotted lines, but can be used to neatly tie the neck portion.

Among the parts showing the strap 246, the softly folded shape means that it is not fused and can be divided into two sheets. Among the parts shown in the vinyl 243, the softly folded shape may not be fused, but it means that the two sheets are overlapped.

The strap 246 with the pocket (246′) can be used as a pocket as shown in FIG. 20 by fusion bonding and then incision (244) only one side of the sealed inner space. The ventilator 223 described in FIG. 19 can be put in the pocket 246′ thus made, and the hose 44 may be connected to blow air toward the respirator of the user.

The opening may not be completely cut and may not cut the top like a “ ” i.e. leaving the top side uncut. This remaining part may be cut in a vertical direction like a shred 245 while the upper part is left uncut, thereby generating static electricity with the mask surface, thereby improving the filtering capability of the filter.

A mask can be added as a filter[F].

The mouth and nose part of the protective suit (33p) are incised as shown in the figure. Onto the ‘inside’ of the incision of the protective suit (33p), attach only the edge of the mask. They may hing a the mask straps on the ears, at the ‘inside’ of the protective suit (33p), just like wearing a normal mask.

In general, there is a leakage through which air flows in or out of the gap between the mask and the face, so there is a mask leak rate standard.

However, this protective suit (33p) does not have any problem even if there is such a gap. This is because the whole body is surrounded by vinyl, except for the mask filtering part. So, when they breathe in, the air that flows into the gap is the air inside of the protective suit, so outside air cannot flow in.

Even if it leaks through the gap when exhaling, it is inside the protective suit (33p) and does not leak outside.

Air, which may contain viruses, is treated by the mask and enters the protective suit (33p). Filtered air comes IN to the protective suit (33p). Therefore, this protective suit (33p) becomes a kind of positive pressure chamber because it does not infect people Inside.

Air, which may contain virus after entering and exiting the human lung, is treated by the mask and goes out of the protective suit (33p). Filtered air goes OUT from the protective suit (33p). Therefore this protective suit (33p) is a kind of negative pressure chamber because it does not infect people Outside.

Therefore, this embodiment is a positive pressure chamber and also a negative pressure chamber, that can be worn.

There is no fear of being infected, and no fear of infecting another person.

This breathing process can be repeated as in many previous embodiments.

If a transparent material is used for the protective suit 33p, goggles may not be required. However, if the transparency of the suit material i.e. vinyl, etc. is low or the material is colored, the eye part of the protective suit 33p is cut and the edge part of the goggles is adhered as same way with the mask.

In addition, inexpensive, but highly transparent plastic 247 (instead of expensive goggles) may be attached as shown in FIG. 20 according to the size. Earpiece or temples are not drawn because the thin and transparent plastic, which is likely to be applied, is not heavy and may not require earrings. Here, ‘transparent’ includes containing colors like sunglasses, and tinted glass.

They can place the mask under the armpit side so that it doesn't cover your face. It will not get wet even when it rains, and the filtering ability of the mask can be increased by the electro static generated by movement of the arm.

Fan [P; a kind of pump] can send air around the mouth and nose through the hose (44).

In order to ventilate without a power source, for example, an ambu bag, hemobac, self filling ventilation bag, a bellows type device, etc. may be used. If they sit on it or walk under the sole of the feet, it can blow air by being pressurized by the body weight and suction air again due to elasticity.

A two-way valve may be introduced for continuous airflow.

One of the concepts is that even flat suit becomes three-dimensional. Although not drawn, the width of the elbow, hip, and knee joints may be increased by about 1.3 to 2 times the circumference of the corresponding body part so as not to interfere with bending. They may also add wrinkles.

There may be an addition (+h) for the foot to the actual length of the leg. Although it is a flat tailoring, it is intended to protect foot which is vertical. They can be crumpled into the shoes, or they can be made to protect the shoe from outside.

One-time use of protective clothing is basic, but may be reusable, if it is not in a hospital-like environment; clothings like diet sportswear, sauna suits, raincoats, simple diving suit, winter clothes, underwear, conserving bath water, etc.

In addition, it can be used for water conservation. For example, when bathing in a public bath or with a large family, if they wear this protective clothing and enter a water-filled bath and fill ‘into’ the protective clothing with water, they will not be harmed by others, nor will they be harmed. There may not be mask.

It has been described based on overlapping one layers, but as described in FIG. 14, one layer may have more than two layers.

FIG. 20 illustrates the concept of two or more layers of protective suit. However, according to the fusion bonding and cutting method described in FIG. 20, the double line of the drawing yarn is bonded and cut into a single line by fusion bonding, and parts other than the double line become double.

That is, the end or edge may be in the shape of a sack in the same sack. Unit[U] and hose 44 can be connected.

When air is passed through the space between the layers, in addition to the heat exchange effect, there is an effect of improving the filter performance by generating a electro static. A spacer 225 may be provided to maintain a gap between the two or more layers.

FIG. 20 shows that one layer of multi-layered air cap or air bubble wrap may be overlapped to make a protective suit. It is possible to increase the physical resistance or the effect of maintaining the temperature of the internal fluid 11 air.

Although the description was made on the premise that molding is performed, as shown in FIG. 20, a square plastic bag that can be easily obtained may be used.

A moisture remover (not drawn) inside may be introduced.

In order to manufacture a product having a shape such as a protective suit, for example, disposable gloves, etc., were previously used as ‘continual’ methods, but a ‘continuous’ method using circular mold may be introduced.

By the way, if they choose the taping method rather than the zipper method, they need to open sealing (244′) several times, it is difficult to peel off the beginning of the taping with vinyl, so they need a means to do it easily.

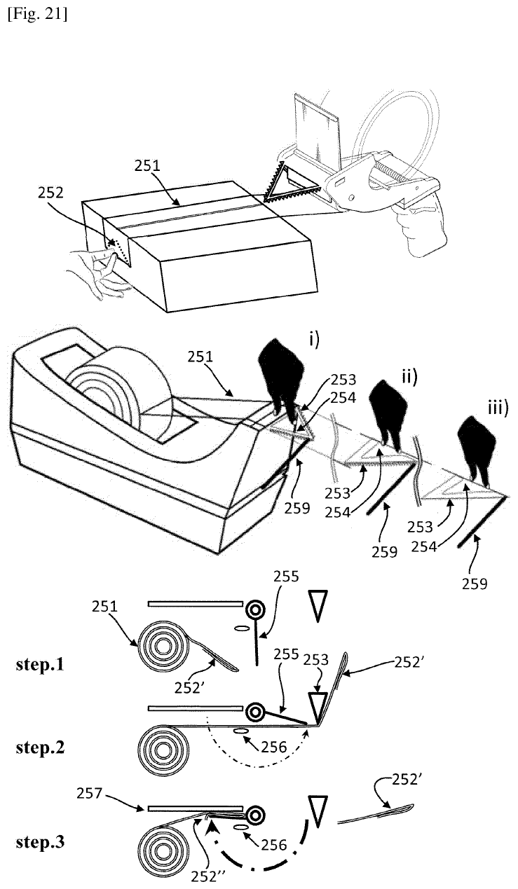

FIG. 21 is an example of a sealing or tapping that can be easily removed.

When the taping is to be removed as mentioned in the last part of the description of FIG. 20, as shown in FIG. 21, if only the start or end of the taping is removed, the remaining part can be easily removed by the tensile force in the longitudinal direction of the tape.

For easily detachable taping above, either of the two ends is folded inward. A covered surface 252 covering the adhesive surface is made. The covered surface 252 does not stick.

Means to facilitate this is introduced.

FIG. 21 is an example of easily detaching seals of the sack.

FIG. 21 shows that, for the purpose, the cutter 253 can be made inclined. A space 254 can be placed inside the inclined cutter. After being cut inside the space 254, the upper surface of the remaining tape is pressed down with the index finger. In the space 254, the covered surface 252 may be made by tapping the tape 253 together with the thumb.

The cutter 253 may be made of, for example, i) a triangular shape ii), iii) an angle symbol shape, and the like. The blade of the cutter 253 may be i), ii) serrated, iii) straight, or the like.

Since the blade of the cutter 253 protrudes, for example, a support rod 259 can be introduced to inforce the strength.

It can also be applied as shown on the right side of FIG. 21. FIG. 21 shows that the adhesive surface is below, that is, toward the cutter 253. In contrast, in FIG. 21, the adhesive surface is below. Therefore, the tape may not stick to the cutter after cutting. However, they can use the static electricity generated when the tape is pulled out for use. Plastic can be added to facilitate the generating static electricity.

FIG. 21 shows a case where the non-adhesive surface of the tape 251 is toward the blade 253. In step 1 is initial state. The covered area 252′ was made by in the previous step. In step 2, when the covered area 252′ is pulled toward the right angle of the cutter 253, the impact plate 255 rotates counterclockwise and accumulates elasticity in the elastic body (not drawn). When the tape 251 is cut off by the cutter 253, the impact plate 255 momentarily starts to rotate in the clockwise direction. It is also possible to selectively place some protrusions 256 on either side of the tape 251 to support folding. As the folded part touches the impact response plate (257), the bonded surfaces are joined together, resulting in a non-adhesive part on the part. The bold arrow means an instantaneous strong rotation.

By using the generated strong rotational force and the resulting impact force, it is possible to mark certain advertisements, patterns, etc. on the folded side. In addition to general stamping, elements such as microcapsules that change color by impact can be used.

If the protective suit (33p) is made of thin vinyl, it is good for activity, but it is easy to tear. In this case, it can be repaired by taping simply.

This method has the advantage that it is easy to find the beginning of the tape and does not stick to the hand when pulling. As well as protective clothing, it is easy to remove the tape from the delivery box, which helps protect the environment.

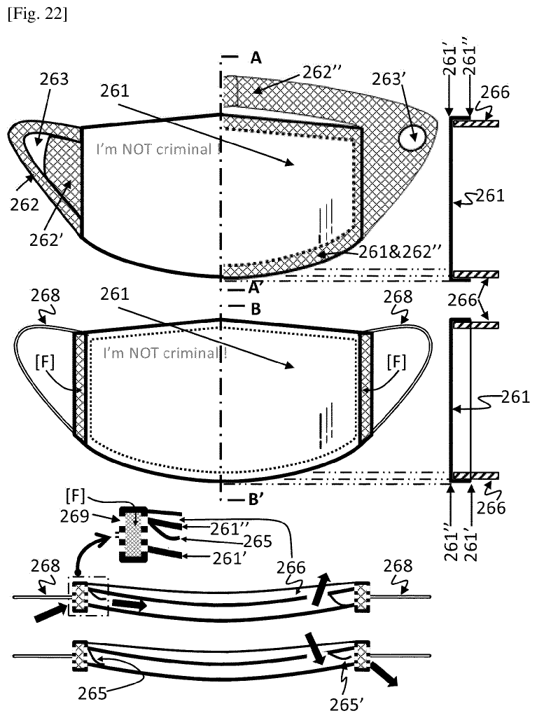

FIG. 22 is an example of supplementing the reduction in filtering.

It is a kind of supplementing the reduction in filtering ability due to transparency of a part of a mask.

The mask is a simple but representative method of treating fluid 11 air. This is because the mask serves as a filter [F] as one of the treat [T] and also serves as the container 22 at the same time. However, while the existing mask does not have the hose 44, various treatments are difficult, but the hose 44 can be applied to a transparent mask to be described later.

When a part of the filtering area of *?*the existing mask is converted to the transparent plate 261, the filtering area, that is, the filtering capability is reduced. In order to compensate for this, it is possible to allow air in and out of an existing earpiece, temples or a variant thereof, and a filtering capability can be reinforced there.

If the filtering of the existing mask is an area method, the string method is a line method. Therefore, as the distance from the transparent plate increases, the amount of air that can be sucked or discharged rapidly decreases. Therefore, if the string is of the same thickness and material of the same material, it is necessary to lower the porosity by properly sealing the front or less sealing the rear. Although the manufacturing cost is high, combinations of different thicknesses and materials are also possible.

The strap can be connected from the top/bottom of the mask to the bottom/top on the same side as it is now. The string may be connected from the top/bottom to the back of the head in the form of ‘=’ and connected to the top/bottom of the opposite side, or in the form of ‘X’ from the top/bottom to the back of the head and connected to the bottom/top of the opposite side.

In order to lengthen the filterable length, the ‘=’ type, or the ‘X’ type, is better than hanging on the ear. Alternatively, it is also possible to tie like a shoelace, for example.

It is good to manufacture a string with a constant porosity, so a kind of cover is used to control the porosity. The opening of the cover may be increased as it moves away from the transparent plate. By attaching this cover to the connector (not drawn), they can fix it after inserting the earpiece.

Earpiece can be made of non-woven fabric. Although the non-woven fabric lacks elasticity, an elastic body between the earpiece may be inserted in the middle, or the connector may have elasticity, and the length may be adjusted.

There are methods such as tying the string itself to adjust the length, or they can configure a connector so that the extra length of the string can be put inside the mask.

There is a connector that connects the transparent plate 261 and the string. This connector is on the side of the transparent plate, in order not to replace it. Only this string is replaced, and the front transparent plate 261 can be used continuously. There are multiple connectors, so you can choose the number of strings to connect. If you connect several, you can disperse the filtering ability, making it easier to breathe.

The configuration of the connector and the like may be bi-directional like a conventional mask, or may be one-way in which the suction and discharge filters are separated.

The production process of general masks is complicated, but since this method only needs to produce strings, there are many advantages in addition to the effect of a transparent plate mask.

FIG. 22 is an example in which a conventional simple earpiece serves as a hose 44 as well as a filtering role. It shows the filtering area, i.e., the ability to extend to the string 262, further to the inner region (262′) of the string 262, and the string to the band shape (262″). It is shown in combination. The ear-hanging area is the spaces 263 and 263′ shown in the drawing. The face fitting plate 266 is made of a material such as silicon, which is not shown, but is shown in detail in FIG. 22. An example was also shown that an overlapping portion (261&262″) can be introduced to increase bonding force with the transparent plate.

FIG. 22 shows a method in which filters [F] are introduced on both sides of the transparent plate. Fluid (11) air flows in and out through the filter [F] through the air passage 269. It can be designed in such a way that both inflow and outflow occur in one filter [F]. However, when air passes through the transparent plate on inhaling air, static electricity that helps filtering is generated. If the air containing a lot of moisture from the lungs passes in the reverse direction, the static electricity can disappear. Therefore, it is the inflow passage in FIG. 22 and the outlet passage in FIG. 22 that are classified. The description of the operation of the inlet valve 265 and the outlet valve 265′ will be omitted since the air flow entering through the ventilation hole 269 is clearly indicated by a bold arrow. Although it is supposed to apply a general earpiece 268, a method as shown in FIG. 22 may be added. The left and right sides of the face, for example, have a significant length from the nose, so you can put enough filters. You only need to replace this filter after use, and it is easy to manufacture because filter making is just cutting long rod.

As an auxiliary device for comfortable breathing, the above described ventilator 223 or the like may be applied to the mask. Depending on the direction of breathing, a physical or electrical switch can be introduced that enhances the airflow in that direction.

Masks can incorporate microphones and speakers that work both wired and or wirelessly. Since wearing a mask interferes with the transmission of sound, you can introduce a method of transmitting sound out of the mask. The internal microphone and the external speaker may be fastened by a physical method such as hooking, or by a magnet including an electromagnet. The speaker can be connected by wire or wirelessly without being fastened over the mask and placed away from the mask.

Both the general mask and the transparent plate mask can have openings that can be opened and closed. It is also possible to place an airtight zipper in the opening, a magnet above and below the opening and/or before and after the opening. It is also possible to introduce an elastic body to open and close again only when a force is applied, for example, when the chin is spread open or pulled by hand.

In the case of a transparent plate mask, it is not disposable like a conventional mask, so only the filter needs to be replaced by the above method, so it can be made to have various functions at a little more cost. However, it does not exclude those applied to general masks.

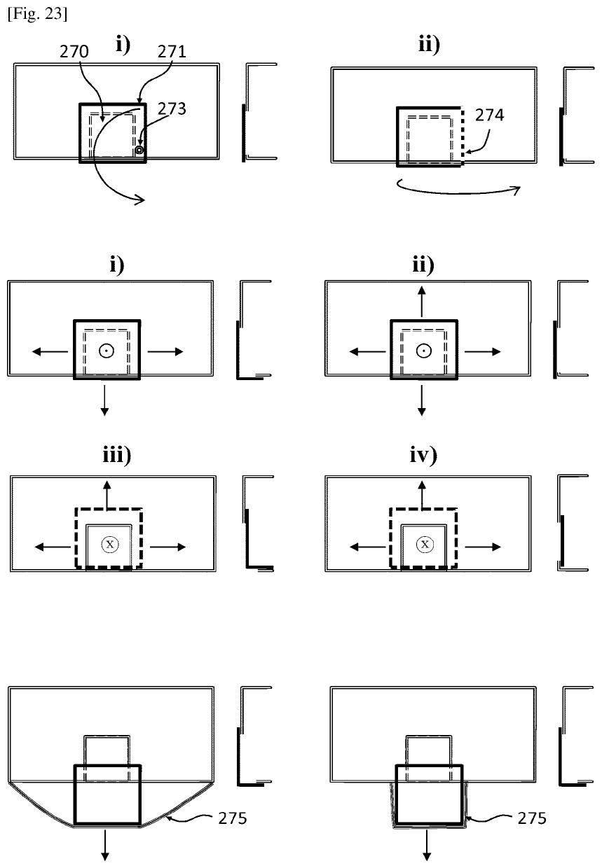

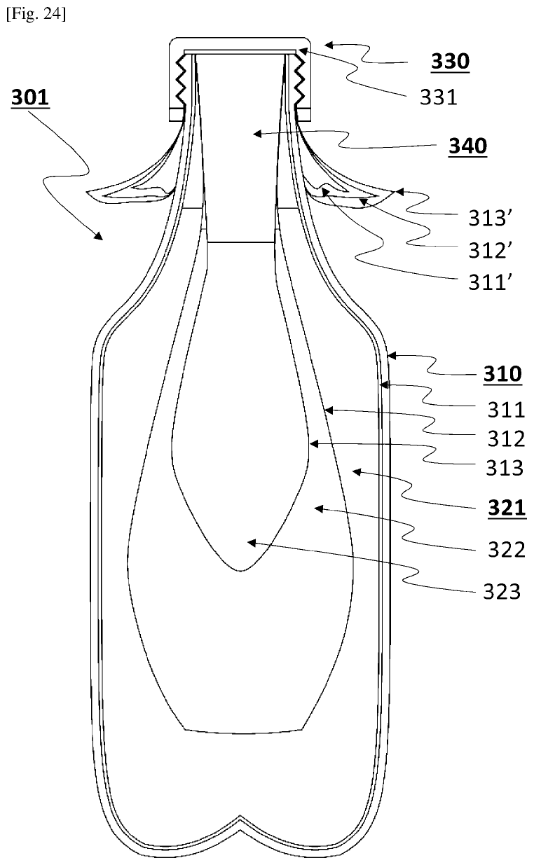

FIG. 23 is an example of mask opening and closing methods.

It is not limited to the mask. The opening/closing passage 270 is indicated by a single solid line or a dotted line of the screening plate 271 with two solid lines or dotted lines. The 60 degree arrow indicates the direction of opening and closing. A direction sign x in circle is ‘go into the paper’, dot in circle is ‘come out of the paper.’

In the hinge method, the same plane rotation method by the one-point shaft 273 (possible at different positions), the right angle plane by the one linear shaft 274 (possible to be installed up, down, left and right) can be applied.

In the slide method, a single door type moving up, down, left, right, front and back, and a double door type moving horizontally and vertically can be applied.

In other methods, bellows method, curtain method, blind method, etc. are adaptable.

As for the shape of the screening plate 271, a ‘I’-shape and an ‘L’-shape can be applied. The L-shape may transmit the movement of the jaw directly to the plate.

As the material of the screening plate 271, the same material as the transparent plate, and a non-woven fabric other than the transparent plate may be used. In the case of applying a non-woven fabric, etc., if it is thin, it can be made to have a thickness or strength sufficient to include or not use a support.

As a method of operating the cover plate 271, a jaw movement, a hand movement, an elastic force, an electromagnetic force, a separate actuator, and the like can be applied.

The location of the screening plate 271 may span inside, outside, in the middle, and both of the mask.

As for the actuator method, sensors such as sound, motion, proximity, and shape can be applied, and a controller [C] can be introduced.

The screening plate 271 may have a stator, rail and/or sealing home to limit a direction of motion.

The opening and closing of the mask may be applied in various ways depending on the situation by combining the above methods.

In the mask, the sliding method may have a simple structure and be more advantageous in maintaining airtightness. It does not exclude other methods, and it can be applied depending on the situation, so the description will focus on the sliding method.

The sliding direction can be either up, down, left, right, or front and rear, but it is described centering on a downward direction similar to lowering the chin when opening the mouth.

FIGS. 23 and B is a kind of options. The upward moving direction does not matter, and it can move downward like a chin, and the one that can transmit the movement of the chin is the i)-type, which is an ‘L’ shape on the outside.

FIG. 23 is an example of applying the elastic body 275 to the above i)-type. A rail (not shown) and/or a sealing member (not shown) to guide the vertical movement may be applied.

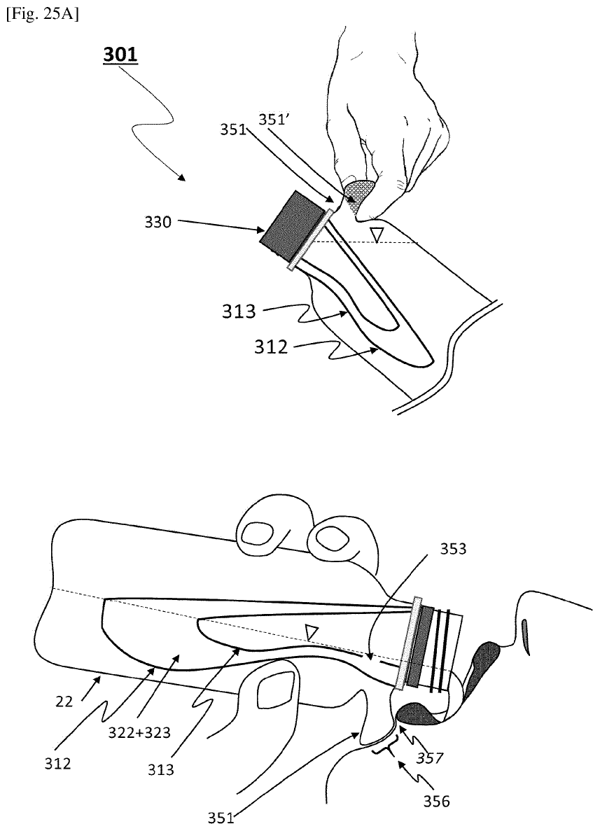

FIG. 24 is an example of a bottle with removable inner sacks.

It relates to a bottle having a removable endothelium and a method of manufacturing the same.

The bottle 301 having removable endotheliums or sacks (33) is configured as follows.

In the bottle 310, which is the container 22, the sacks 33, the first sack 311, the second sack 312, and the third sack 313 are contained in a sack(s)-in-sack method. Other methods mentioned before are possible too. A first fluid 321, a second fluid 322, and a third fluid 323, which are fluids 11, are contained inside each of the fluids. The bottle cap 330 and the elastic body 331 are kept airtight, and have an empty space 340 between them and the fluids 11.

The sacks 311′, 312′, and 313′ extended to the outside of the sacks 33 are shown to extend only to the upper portion, but may extend to the lower portion and close to the outside of the bottle 310 to make it difficult to see with bare eyes.

This allows different fluids 11 to be placed in one space, and later processed [T] to be used in different forms.

The bottle cap 330 may have a means capable of rupturing each of the sacks 311, 312, 313 therein.

The means may be an object with a pointed end in front of an elastic body such as a spring that stores the firing force, etc.

The sacks 311, 312, 313 and the fluids 321, 322, 323 may be placed in a bottle and manufactured by ultrasonic welding or the like.

For details, reference may be made to the document incorporated.

Here, there is no hose 44, and since these are the fluids 11 that have already been processed such as filtering [F], other treatments [T] other than mixing may be omitted. The actuator [P] or controller [C] may also be omitted.

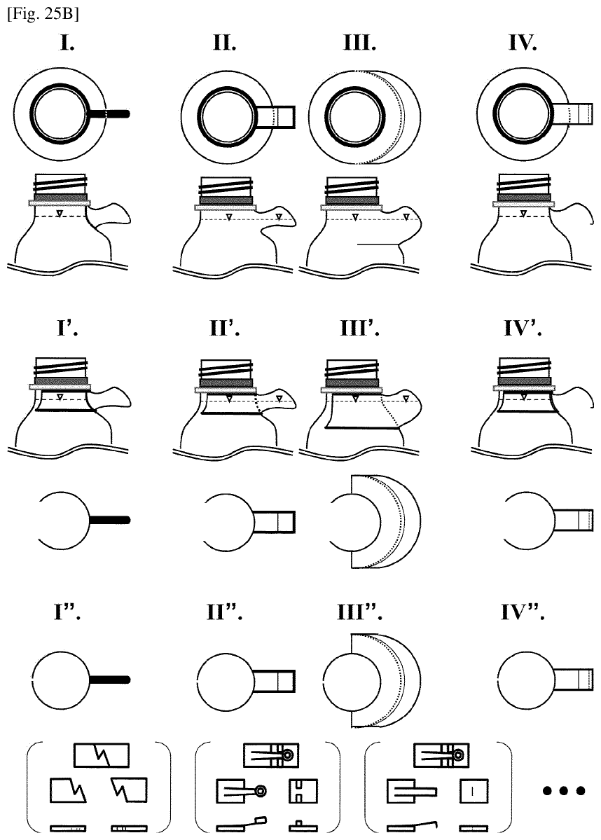

FIG. 25A and FIG. 25B are examples of usage a bottle with a removable sack.

It shows the use of a bottle having a removable endothelium, i.e. sack.

The inner skin, which is the sack 33, can be removed so that the bottle can be recycled.

FIG. 25A shows that the bottle 301 may have a hand holder 351. Various fluids 11 and additives 351′ may be included in the hand holder 351.

The bottle cap 330 and the elastic body 331, as described above, may have a means for opening the sacks 312 and 313; 311 is omitted.

FIG. 25A shows as an example that a portion 353 in which the sack 313 is opened and the second fluid 322 and the third fluid 323 are mixed accordingly to make a fluid different from the original one.

When using the bottle 301, the hand holder 351 may provide a reference point 357 so as not to touch the mouth. The outer portion 356 of the hand holder 351 may have a curve similar to that of the contact portion.

FIG. 25B is a plan view and a side view showing various modified examples of the hand holder 351.

The I. series is integrated with the bottle 301, the I′. series can be fixed with the bottle 301, and the I″ series is a fastening structure that can more strongly fix the I′ series.

In type-I, the hand holder 351 is made of a line or longitudinal section plate.

In Type-II, the hand holder 351 has an accommodation space inside as shown in FIGS. 25-1 and 25-2, so that additives 351′ can be stored.

Type-III is an example in which the width of the hand holder 351 is increased to a diameter in order to enlarge the accommodation space inside the hand holder 351.

Type-IV has the hand holder 351 as a line or latitudinal section plate.

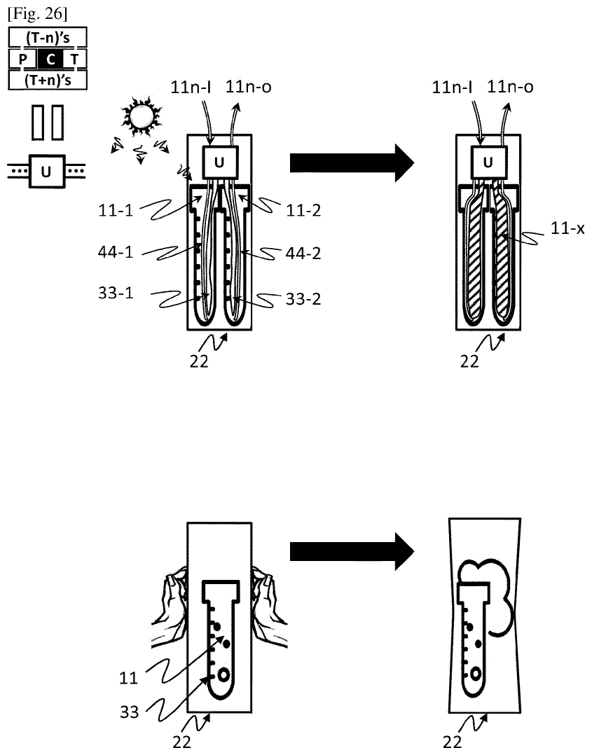

FIG. 26 is an example of remote initiation shown in diagram.

It is a diagram concerning the treat in container and remote initiation.

FIG. 26 is concerning mixing separate fluids in one container.

Concerning the Non-Dilution method, examples are comparatively large scale like oil industry, but it's not inapplicable to relatively small things.

After treating (mixing blending or reacting, etc.) of the 1st fluid (11-1) and the 2nd fluid (11-2) through the 1st hose (44-1) and the 2nd hose (44-2), put them in the 1st sack (33-1) and/or the 2nd sack (33-2). It is useful such as ‘hair dye’ which needs to mix just before use after keeping the 1st fluid (11-1) and the 2nd fluid (11-2) separately.

With this concept, they can mix them as much as they need without extra container (22), and another necessary treat is possible too.

: ‘The nth fluid IN’ (11n-i) means that something added to the system may be different every time.

: ‘Treated nth fluid OUT’ (11n-o) means that because it can treat (in this case mix to react) and save in inner sack (33), various mix ratio is possible, so every treat can have different status (for example, ratio, etc.).

To load back to original container (22), another hose (44) inside the inner sack (33, omitted in drawing) are necessary to suction from the inner sack (33).

This concept includes that the treated matters stay in the system, in the inner bag or in the original container (22), instead of taking them out.

FIG. 26 is concerning remote treat initiation.

Pocket warmer starts to be warm normally by friction using hands. But in some cases like (winter) ambush situation, military operations, or etc. which needs to be silent or no sound is allowed, it is necessary that it starts to react such as to be warm or cool by remote signal.

‘Remote signal’ may be visible or invisible solar rays, ultra violet rays, infrared rays, radioactive ray, pressing power, (ultra) sonic, heat, micro wave, etc. Once started, in case of pocket warmer, the reaction is continued without any additional or external stimulation. But some kinds of (chemical) reactions are controllable by increasing or decreasing the remote signal (more or less rays, more or less power).

This can be applied to make smell signal to friends without making any sound in such as the ambush operation situation, etc.

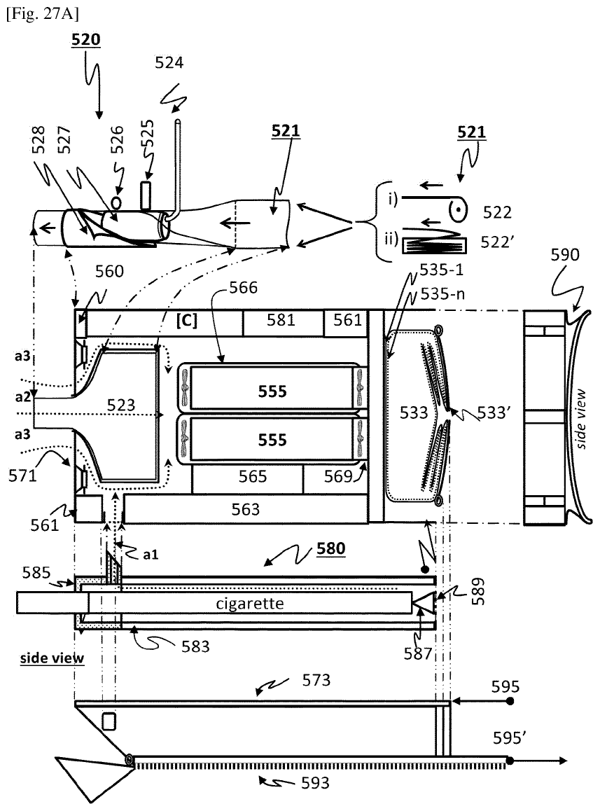

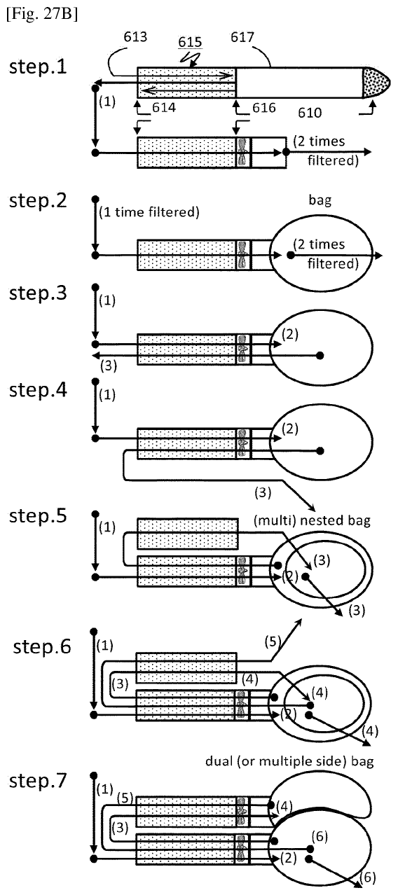

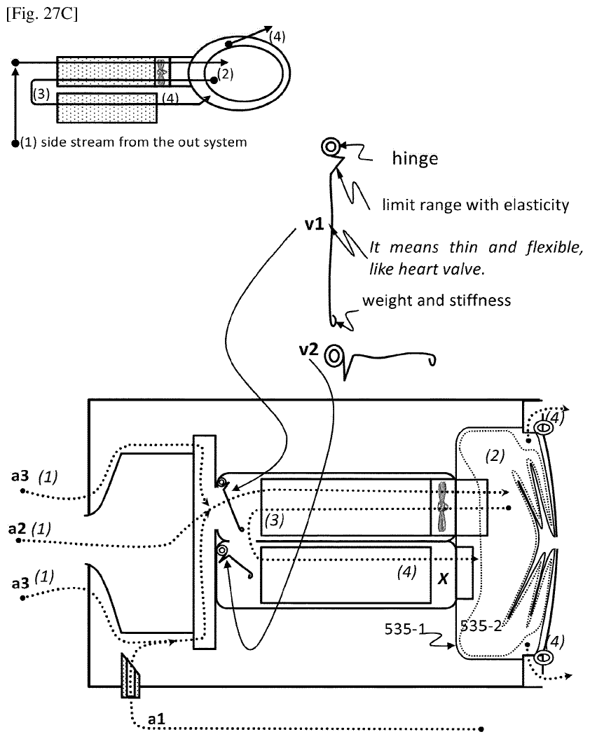

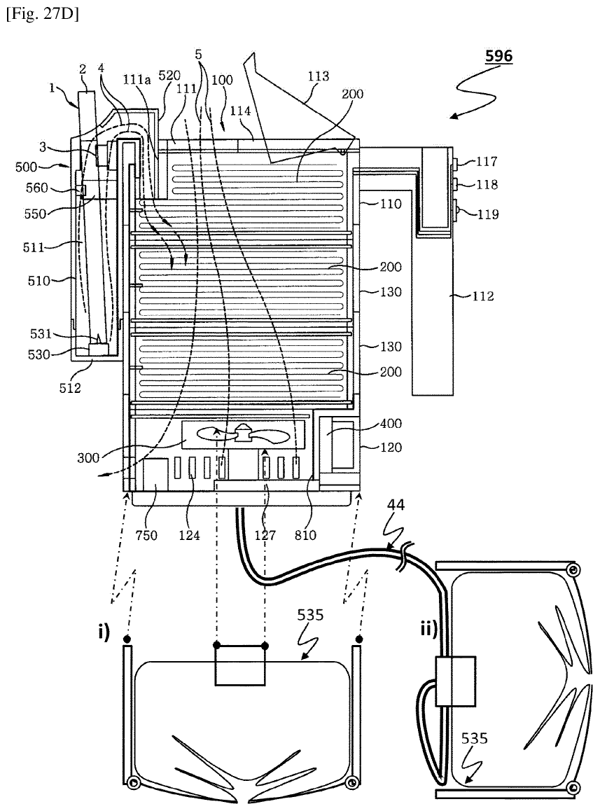

FIG. 27A is an example of treating aerosol.

FIG. 27B shows a kind of schematic diagram of treating of fluid

Fluid (11) aerosol smoke is generated by heat/fire (610). Centered on filter (615), there is mouth side (613), heat side (617), mouth end (614), heat end (616) as depicted in the figure. According to the following steps, contaminated fluid (11) smoked air may be treated:

step.1: Mouth side of the used filter is less contaminated than heat side, because most smoke attached front side of filter fiber i.e. heat side. So the used filter shall not be put reversely, because high density smoke (just filtered once by the cigarette filter) will be came from mouth side first.

step.2: Buffering function only, for easy exhaling.

step.3: Buffering function and filtering once more. Not fully filtered fluid goes to user, which is not good.

step.4: Buffering function and filtering once more. Let not fully filtered fluid go far from the user.

step.5: 3 times filtering with another filter and 1 nested inner bag. Let not fully filtered fluid go far from the user.

step.6: 4 or 5 times filtering with another filter and 1 nested inner bag. Let not fully filtered fluid go far from the user.

step.7: 6 times filtering with another filter, fan and 1 multiple side bag. Let not fully filtered fluid go far from the user.

Combination of multi-nested and multiple side, more filters and multi fans are possible.

FIG. 27C shows an example diagram procedure of FIG. 27A, and FIG. 27B.

It is easy to control flows with as many sensors, many actuators, many ducts as wherever they are necessary respectively. But we will control full flows with just one fan (the other fan was marked ‘X’. The following schematic diagram is another example of previous ones and actual device.

The system may start, if a cigarette lit up then cigarette burning may be sensed by for example simple bimetal (omitted). The sensor gives signal to fan and then turn it on directly. Or the user may turn the system on. Then the fan is turned on slightly at the level of maintaining suction side stream (a1).

The user inhales smoke. The temperature of the burning area goes up to almost 1,000° At this time the side stream dose not come out, because all the smoke is inhaled. In spite of the fact that sensing almost 1,000° keep the fan run slowly to make a kind of ‘air curtain’ for the wall of the system.

The user exhales the smoke to the straw (a2), or the opened gate (a3). A very light lever (omitted) moves or a vision sensor (omitted) detects darkening and give (exhale) signal to the fan. The signal is reduction of Ohm circuitually It may happen even without CPU, but not excluded.

The fan runs faster by reduced Ohm, the v-1 (valve-1) is open, v-2 (valve-2) remains as closed. The smoke passes filter-1. It is the 2nd filtering, because the 1st was by cigarette filter. Then pass the filter, and then goes into the bag-“2 (inside)”.

As the exhale signal ends, the fan runs reversely. The smoke in bag-1 goes back to the filter-1 again (the 3rd), concurrently v-1 is closed and v-2 opened. And the smoke passes through filter-2 (the 4th) and goes into bag-“1 (outside)”.

How to get out the smoke in the bag-1. Just run the fan. Then bag-“2 (inside)” (v-1 open, v-2 close; initial state) will be blown up with (fresh outside) air and the 4th filtered smoke (almost cleaned) in the bag-“1 (outside)” will be pushed out of the system. Then run the fan reversely to empty bag-2 for next puff smoke.

Repeat from step 2) (if burning of cigarette ends, the bimetal will give signal)

At last, the bag-1 remains inflated. \textcircled{1}Move bag-1 air to bag-2; pushing lever button (omitted) by force to switch the fan on but v-2 open, v-1 close. \textcircled{2}v-1 open.

As above we showed that just with light lever, bimetal, etc., the system runs well, so with program aided controller and electronic or mechanical actuators, it will be great but easier. So detailed explanation is not necessary.

(used) Filter of the conventional cigarette or (used) heat not burn itself may be (re)used as a filter.

Just little of nicotine in a cigarette are taken by body. The almost all of them are captured in filter and released into air. But by this system, almost all of the nicotine is captured in the (reused) filter.

The captured “high density” nicotine in the filter can be (re)used for many purpose like pharmaceutical purpose nicotine patches after refining, or natural insecticide. (As known well, the naturally occurring compound nicotine had been used for several centuries to control insect pests. Neonicotinoids are a class of neuro-active insecticides chemically similar to nicotine. The neonicotinoid family includes acetamiprid, clothianidin, imidacloprid, nitenpyram, nithiazine, thiacloprid and thiamethoxam. Imidacloprid is the most widely used insecticide in the world, except most of EU which ban it because of killing bees.)

The mainstream of tobacco smoke contains approximately 500 μg of NO generated per cigarette. Although fresh smoke contains little NO2, the aging of the smoke converts the reactive NO to NO2, which has an estimated the half-life of 10 minutes. (Bornard et al. 1985, Rickert et al. 1987) Some of them will be capture in high density, which may be refined to use another purpose.

One way to change an old filter easily, push the old filter with a new filter like loading a bullet then the old filter will pop out, which needs opening through top and bottom of the case, though.

‘Making straw’ may use pusher-up paper using elastic body like spring, but using just slope is better for slimness.

‘Generator’ of anion, hydrogen, etc. which will be inhaled one by one, mixed each other, with combination of the others before/during/after smoking. The method of generating those is well known.

Cigarette holder (580) may act alone. In other words, originally no relation with main body with addition of fan and motor. The motor can get energy from the heat of the burning cigarette. The cigarette may be ignited by the internal energy source (not drawn) like (rechargeable) battery or external energy source like lighter. Whatever the energy source is, once the cigarette is ignited, the energy from the energy source like dried leaf tobacco may generate electric by a thermoelectric element located around the energy source like dried leaf tobacco above.

This means, once ignited by the internal batteries or external source like lighter, while the energy source like leaf tobacco is burning something necessary like fan (motor) may work (while it is burning).

FIG. 27D shows that some parts of the FIG. 27A may be applied elsewhere.

It is possible to allow more space of another fluid treating system such as, for example, ‘apparatus for both producing anion and removing smoke’ (596) incorporated to this specification. For details, reference may be made to the document incorporated. The buffer (535) may be connected to the apparatus (596); as in option i) directly and/or ii) by the hose (44).

It's just an simple example just for presenting how to combine mug cup type with buffer (535) unit, which is very basic (mono bag), so the filtered air is exhausted to the user. The other features like multiple filtering, etc., with valves, more fans and filters are possible as explained before.

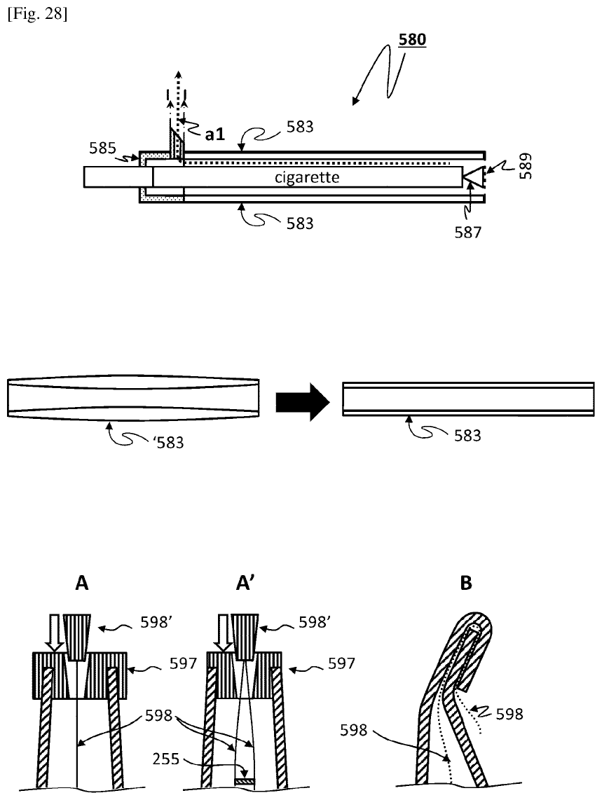

FIG. 28 is an example how to produce thin but flat insulator.

FIG. 28 shows that ‘a1’ is side stream coming into the system. It is suctioned for drawing side stream and heat, while forming air curtain, inside of the cigarette holder (580). It will reduce convective heat and conduction heat except radiant heat.

The proper flow rate is controlled by the controller[C] of FIG. 27A, on the basis of the data collected from the sensors (omitted) like puffing sensor, puffing power or flow speed, temperature of the side stream coming into the system or directly from the cigarette rod burning. Control may be introduced because over-suction makes cigarette burned quickly.

If they use flat plates to make vacuum chamber, they will be concaved after vacuuming, in case of long and thin insulators of the FIG. 28.

As shown in FIG. 28, therefore, preparing the convex plates as in before insulator (′583) may be introduced. After vacuuming, the convex line will be flattened as in after vacuuming insulator (583).

FIG. 28 shows that, in addition, after vacuuming the chamber, insert wedge (598′) like cork, etc., into holder (597) with separator (598). Sealant may be applied. Atmospheric pressure will keep them airtight.

Separators (598) may be one (like A) or more (like A′). In case A′, spacer (255) may be introduced. Then welding them like in B. Separators (598) is dotted to show better.

Separator (598) prevents some molecules' (which were left after not perfect vacuuming) transferring heat from one side to another, which decreases the insulation effect.

As an material of separator (598), Graphene may be good, because it is lighter and even a smallest molecule can not trans pass. Even though it's heat conductivity is high, the other merits are bigger. For thin (ex. 1 mm below) and long tube the separator (598) should be thin (graphene is the world's thinnest and strongest) and can endure very high temperature and pressure, which is important for making and using.

As a reference, computer models predicted the melting point of graphene at 4,500 or 4,900 K.

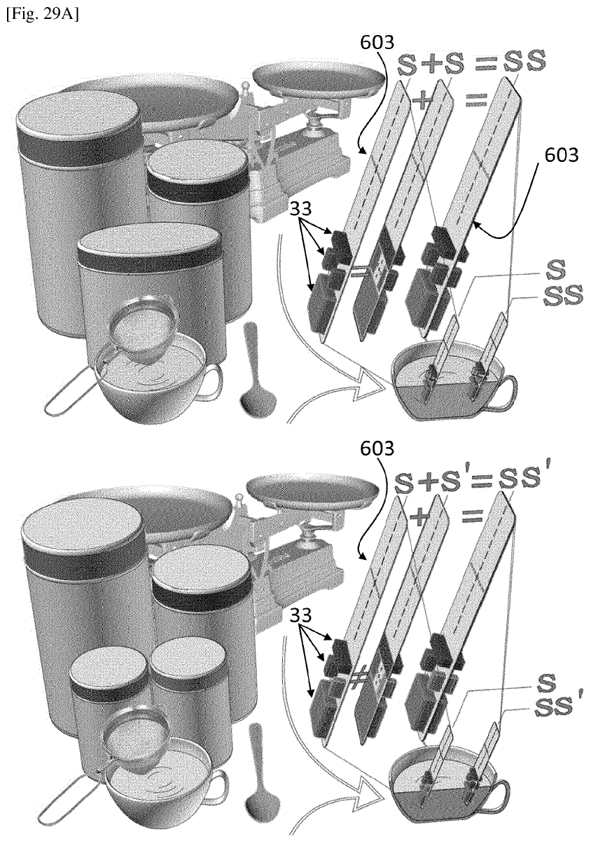

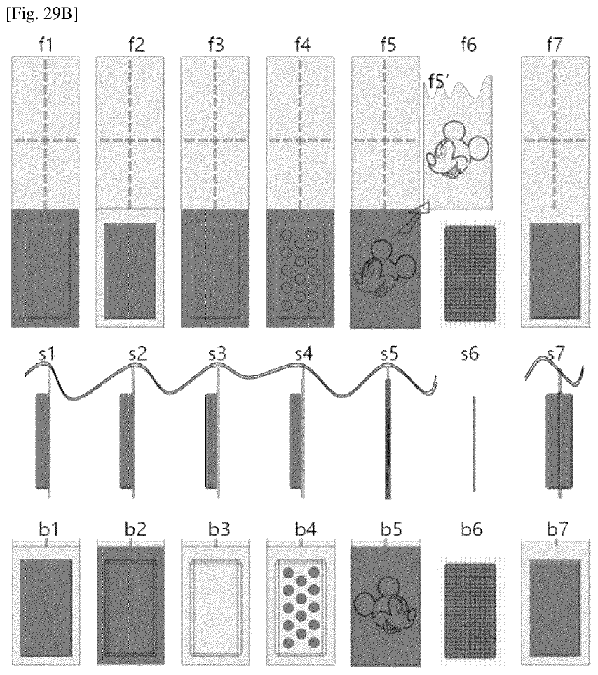

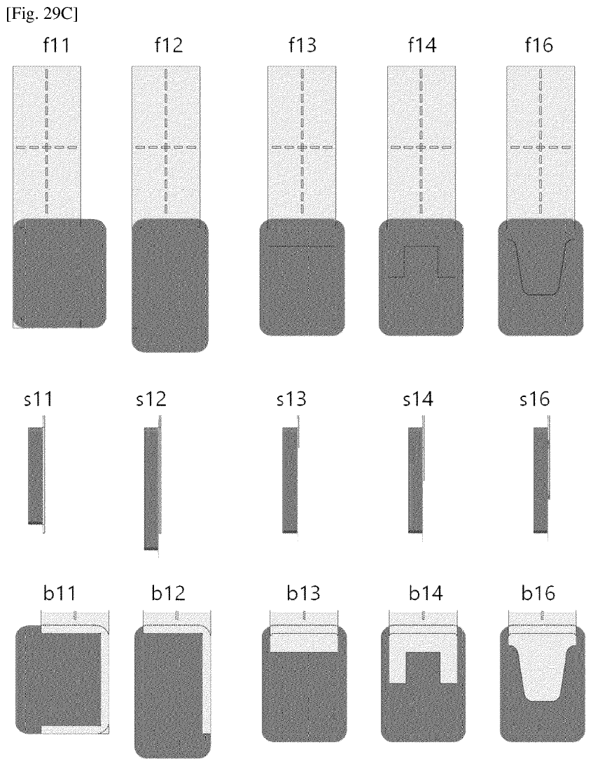

FIG. 29 is an example of treating with perforated sacks and making such.

Some solid fluid (11) like tea, coffee bean, herbal medicine, sugar, etc. may be treated in sacks (33) with perforation and/or mesh, etc.

The sacks (33) side-by-side type with different sizes and positions. They may be attached to stick (603) for convenience.

To enjoy tea for example, there are many accessories, which may be put into a stick (603) with the concept.

FIG. 29A shows that the two sticks (603; S, S) are with same sacks (33).

The sticks (33) S, S are one-sided, i.e. the sacks (33) are protruded from or on the just one side. The same sticks (33) S may be combined back to back, to make SS.

FIG. 29A shows that the two sticks (603; S, S′) are different sacks (33).

The sticks (33) S, S′ are one-sided too, i.e. the sacks (33) are protruded from or on the just one side. The different sticks (33) S, S′ may be combined back to back, to make SS′, for more combinations.

Combining sticks (603) back to back style may be called ‘db’ style. A db-style stick (603) is good for producing.

As shown in FIG. 29B, there are variations of the sticks (603).

fsb1 is a form in which a d-shaped net containing a specific substance (not shown) is attached to the front plate with a large rectangular groove. There is a groove there is an advantage that the liquid can pass through back and forth to quickly elute the leachate.

fsb2 is a form of a d-shaped net containing a specific substance (not shown) inserted into a groove “behind” in one plate with a large rectangular groove. The advantage of fsb1 is that the adhesive surface is not visible from the front, which is neat.

fsb3 is a form in which a d-shaped network containing a specific substance (not shown) is attached to the front plate without a large square groove. There is no groove, so the solution does not pass well, so the elution rate is a little slow, but if you use the integrated stick to stir quickly, it does not cause much inconvenience. Pressing can harden juice, which is impossible with a tea bag tied to a common thread.

fsb4 eliminates the small drawbacks of fsb3 by creating a number of small holes (the number and shape of the holes can be varied, especially in the form of characters like Mickey Mouse). You can also press it strongly against the cup wall. If the specific substance is ground coffee, it can be placed horizontally on the cup to give the impression that the leached coffee solution falls off the various holes into the cup, like real drip coffee.

fsb5 is similar to fsb4, but for example, honey or medicinal extracts (such as honey or medicinal extracts) are applied to the surface of the stick (unlike the previous method of extracting them into a net) by applying a specific substance with a high viscosity, preferably for drying It is dried and used. That means you don't need a separate net (but it's better to extract directly from the source, even if it's cumbersome, like a coffee lover who's going through a cumbersome process of grinding and filtering coffee beans). There is a preferred consumer, so we need other methods before.)

Although not shown, the surface may be scratched or punched as shown in fsb4, and a pattern such as a character such as Mickey Mouse or a desired character may be used to improve adhesion after drying. It can also be drilled by a stencil method that leaves a connection.

If you apply a mucus-like substance (especially opaque) from the front of the perforated area, the character will appear blurry on the front (the perforated part will have more liquid and shrink more and dry out), but it will be visible on the back.

If you apply a mucus-like substance on the back of the perforated area, the opposite is true.

If you apply the entire front and back of the perforated area (fsb5 is shown only in this case), that is to say, dipping and immersing the perforated area in a mucus-specific material solution, the character will only appear blurry from the front and back. After use, the applied specific materials are dissolved and disappeared, so characters such as f5′ are clearly displayed, and various marketing applications are possible.

The method of applying the front side, the back side or the whole side may use various printing techniques, and generally, a brushing method or a spraying method may be used. In case of use or low viscosity of specific material, narrow width of perforation can be used to prevent cracking after drying.

Of course, in the case of the paper stick, even if the surface is water-repellent coating, if not coated to the side (cutting surface) may be wet with water in the process of use may burn the character, etc., the stick material in the present invention as described above It should be recalled that it is not limited to paper but includes synthetic resins and the like.

For reference, in the case of green tea, for example, extracts of dried green tea leaves to make an extract (extract) to reduce the volume to 1/200˜1/300 level can be applied to one stick enough to one stick.

fsb6 is when manufacturing fsb5, there is a problem in that it takes up a lot of places in the process of applying a high concentration of mucus material to a stick immediately after drying. Cutting and fusion to perforated sticks (although the continuous nets can be fused to successive sticks and then the sticks and nets can be cut simultaneously) can save time and work space for faster manufacturing economically.

fsb7 puts a specific substance in two layers of nets and fusions two overlapping parts of two sides, top and bottom, and puts them in the middle of two stick plates. The process is very complicated and therefore the cost is high and not practical.

On the other hand, fsb1˜6 use only one stick plate, so it is not only economical but also simple and low cost, which is very practical.

In particular, one protruding bag is much superior to the process as well as additional means such as attaching a straw than both protruding types can be applied. However, the volume that can be accommodated is reduced, which will be explained below.

FIG. 29C show that it is a means for reinforcing the strength of the stick plate, in particular one stick plate.

As explained above, there are many advantages of using one stick plate, but if the material of the stick plate is plastic, even if one sheet does not matter the strength required for stirring, but if paper is to be used due to consumer's preference (even thick)) In case of absorbent material like paper, reinforcing means is necessary because water may seep into the side (cutting surface) even if the surface coating as described above may weaken strength.

Although shown based on fsb2, it is obvious that other forms are possible. For details, reference may be made to the document incorporated.

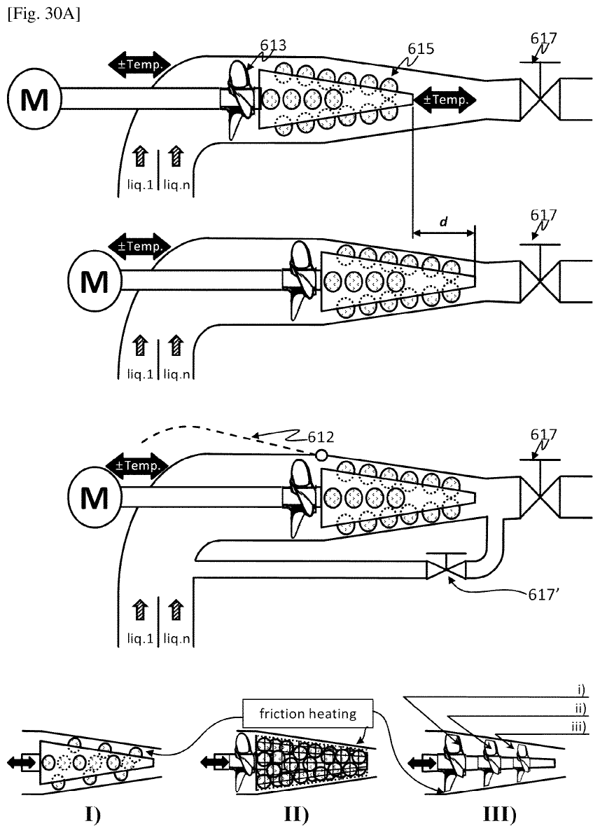

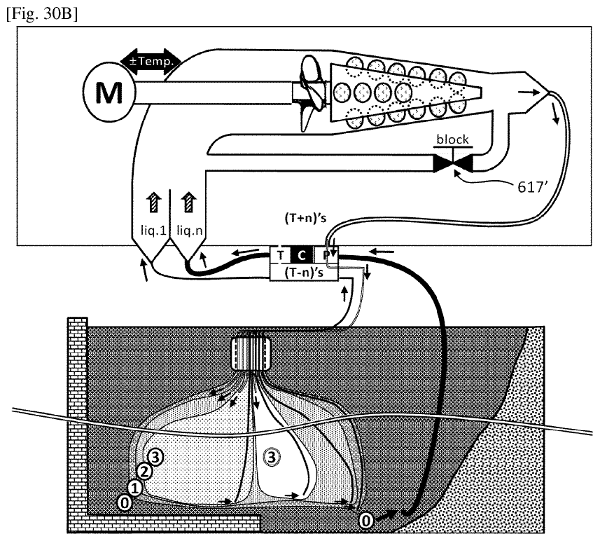

FIG. 30 is an example of how to treat a fluid to increase temperature.

Friction may be introduced to treat fluid (11). Friction of fluid (11) to material (representatively ceramic, etc.) shall change property (good for health, skin care, no scale in pipe) of a fluid (11) including temperature, etc.

A friction maker (615) such as ceramic balls is on the tapered rod, which is actuated by the actuator[M; motor]. There may be a propeller (613), but the friction maker (615) may do the roll. Valve (617) may be introduced not only to control quantity but also shut and make the fluid (11) return back. Repair hole (612) is for easy opening to change the ceramic.

‘liq.1’ and ‘liq.n’ means one more number of fluids may be mixed and treated.

As shown in FIG. 30A, to change the fluid (11) liquid structure mainly, close check valve (615) and the bigger ‘d’, the higher temperature and more structure change.

As shown in FIG. 30A, to heat and change fluid (11) structure quickly.

The less open (valve), the higher temperature, the more change in property of the fluid (11), but with the less output.

As shown in FIG. 30A, returning the treated fluid (11) back by valves (617, 617′) will increase the treating effects.

As shown in FIG. 30A, several types of friction heating may be introduced:

Type I); Helically arranged ceramic (balls) work as propeller too, besides changing fluid (11) structure.

Type II); In order to maximize contact surface, mesh like bag containing ceramic (balls) is possible. Here also if helically arranged, ceramic balls may work as propeller.

Type III); Propeller itself can be made with ceramic. There may be three contact style. i) contact edge only, ii) contact surface only, iii) contact all. The style ii) contact surface only is cost effective and mechanically strong.

As shown in FIG. 30B, the above examples are one of the Treats (T±n), which may have variations. It is one example of what may be done in this system's unit, in this case, changing the properties of the fluid including the property of the fluid (11) as well as the temperature.

Returning the treated liquid back by valves (617, 617′) will increase the treating effect.

But it has same problem of the Dilution method, especially in this system uneven result is problem. Using the concept Non-Dilution system, no extra space, uniform result, heat exchange (some ceramic water factories have difficulties to cool it before packing) and etc. is possible.

FIG. 31 is an example of combining various treatings in case of big pool.

As explained at the Option iii) in FIG. 4B, septum (155) in FIG. 11 may be introduced here.

This pool, as a container (22) without lid (23), is filled with the water heated, changed to better property by the ceramic treating, and/or cleaned by another type of Non Dilution method, which will show many variations including septum (155) shown in FIG. 11.

Ceramic treating is explained just before. Here we would like to show variations of Non Dilution method more, incase of big pool.

This figure is also an example showing that the unit [U] and another unit [U] may be connected. The ceramic friction machine of FIG. 30B sends warm and improved water. Several treatments may be introduced, such as the introduction of chlorine during use, but only the filtering of water, which is the frequent and so far inefficient, is considered.

Type I: Since the pool is assumed to be big, a method of dividing the pool with a confiner (623) can be introduced. Of course, it is simple to introduce the large bag 33, but this is also given as an example that this concept is possible. In addition, not only filtering, but also various treatments are possible in combination with the bag(s)-in-bag method. When the treated water in the bag returns to the pool and the bag becomes empty, it is moved to the next area and treated in the same way. While treating a confined area, the other area may be used, which is advantage of this type.

It may also be an advantage to be able to create the appearance of walking on the water surface of the pool with a help of the confiner 623, which is just below the surface. Therefore, transparent acrylic may be introduced as a material of the confiner 623.

Type II: Another type of confiner (623′), which is made only of a plate, and a wheel 625 may be introduced to move while maintaining an upright position. It can even serve as the rail 119 of FIG. 4B.

Here, the break line in the hose 44 diagram means that the unit [U] with filtering capability is located outside the swimming pool and can be connected farther away through the hose 44.

Another thing is that, as drawn, the end of two hoses 44 only needs to be below the surface of the water, not touching the bottom. In the previous examples, the discharge hose 44 is shown to be inserted only in the bag because the fluid 44 flows downward. The suction hose 44′ is drawn to reach to the bottom because suction may not be possible when the water level is lowered by suction. Of course, it was also explained that the roles change with each other while the treatment is repeated.

However, in this case, the water level does not decrease even if the treatment proceeds within the divided compartment. When either side of the water level rises, the water level does not change because the confiner 623′ automatically moves due to the water level difference, that is, the water pressure difference. This is the advantage of the horizontal bulkheads 155 and 623′.

Of course, when the partition wall 623′ moves, the hose 44 must also move, so the hoses 44 have a length not less than equal to the horizontal movement distance, or move the unit[U]. Therefore, it may not have a great advantage, but it was described for conceptual purpose.

Type III: A unit [U] with a built-in pump [P] and filter [F] was introduced into the inside of the confiner 623. The hose 44 may be replaced a holes in the side walls of the confiner 623 (not shown).

The flow of the fluid 11 may help to move the confiner 623 like a jet propellant, flowing from top to bottom, i.e., backward, as shown by three arrows. It becomes stable by pushing the lower part. If it is an outdoor swimming pool, a skimmer 118 and a skimmer bin 118′ for cleaning flooded leaves, etc. can be introduced as shown in the drawing.

Type III′: It is about what to do with the type III confiner 623 after or not in use.

Up and down arrow (139), as mentioned in FIG. 6, if the unit[U] introduces empty inside, it may float up by air-in or fluid-out and submerge down by air-out or fluid-in.

In this case, they may float it up for swimmers' something like toy, and If they set it down, it will be put out of sight.

Type IV: If the fluid to be treated is in a narrow and long vertical container 44, a different approach is used than before using the horizontal type septum 155 of FIG. 11. Referring to FIG. 13, which explains the vertical type diaphragm, it is as follows:

The airtight film 625 with the side wall can be introduced into the unit [U]. Instead of the hose 44, an outlet (not shown) is placed above, the inlet (not shown) below. Unit [U] has a filter inside. If the unit's own weight is heavy, the pump [P] can be omitted. This is because the fluid 11 will gradually descend itself as the fluid 11 escapes between the spaces of the filter [F]. They can increase the speed by introducing a pump [P]. It doesn't rule out what starts from below.

After completing the work, the return string 627 is pulled.

In this drawing, other parts that are not described are intended to help explain this situation and are not related to the concept.

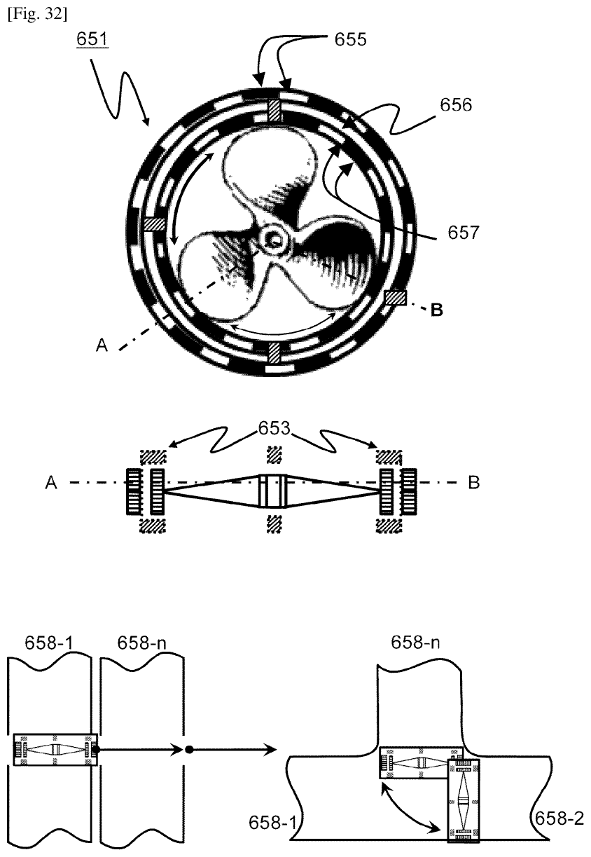

FIG. 32 is an example of no axis motor (fan).

No axis motor (fan) may be introduced to control fluid (11) flow in such as aerosol treater in FIG. 27A etc.

FIG. 32 shows that fan unit (651) comprises:

Outer electronic magnets (655); changing N/S by the controller to make inner magnet-set turned (reversely also).

Space (656); Nothing may be between the inner and outer, i.e. it's floating in the air by the controller. (Not turning/working situation is ‘never mind’), in order to reduce friction (not by lubricants).

Inner magnets (657); (N/S poles) Fan and inner magnet-set are attached.

guides (653); it guides the above.

The bottom of the figure cross sectional diagram of A-B, which is bent 60 degrees at the center.

It may be used as a fan for (Handheld) treater of fluid (gas, liquid, granule, incl. Aerosol, etc.)

As shown in FIG. 32, fan unit (651) comprises:

duct-1 (658-1), duct-2 (658-2) and duct-n (658-n) are hose (44) or ducts related.

Moving/rotating is easy because it does not have axis and is not fixed by bolt. In case of aerosol devices, fan unit may move/rotate (horizontally or vertically) from a duct to another by actuator (omitted), because leakage is not that big problem.

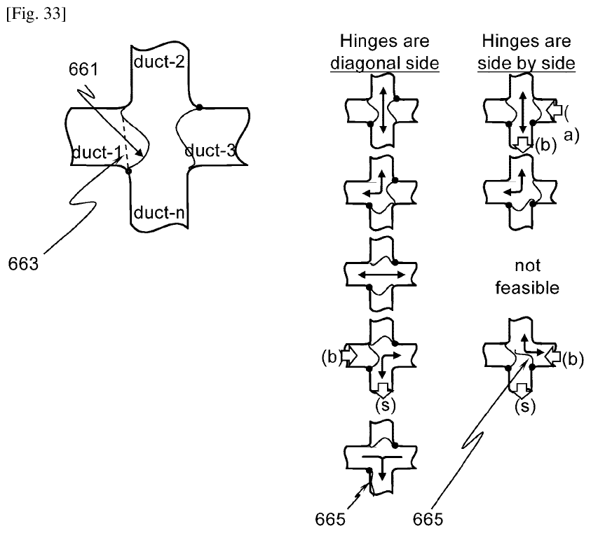

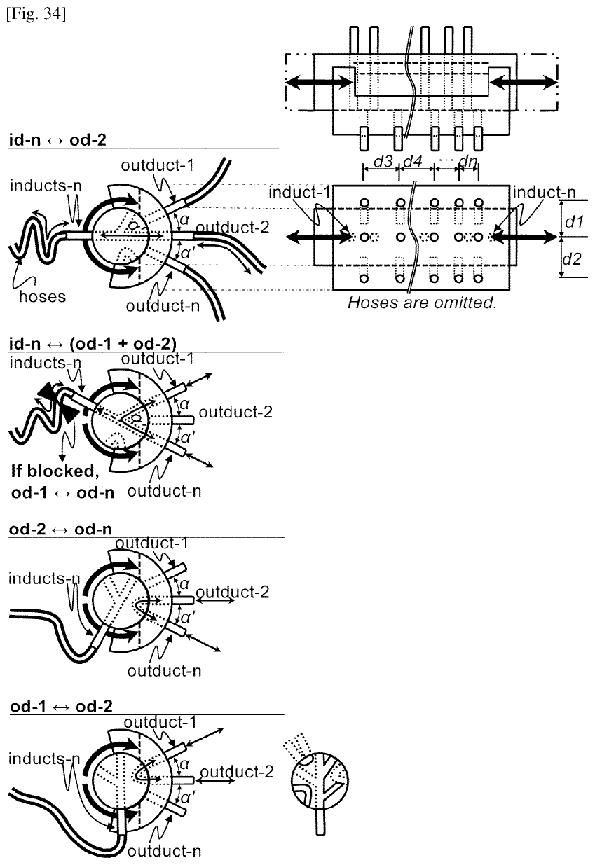

FIG. 33 is an example of valve application (for combination)

One motor per hose system is expensively simple. So here we control with just one motor. Controlling the valves mainly for hand-held devices is here.

Opening and/or closing the valve;

i) by the mouth wind

ii) by fan wind

iii) by string or lever connected to bag (budging or shrinking)

iv) by mechanical lever, crank, cam, etc., with hand or various actuators

v) by hydraulic, servo motor, solenoid, (electro)magnetic power, etc.

FIG. 33 shows that it is easy to control flow direction or closing rate by the above (explanation and Fig.'s are redundant, so omitted), but among them the inventors would like to give a stress on the ‘strength’ of the wind from the ‘basic’ mouth and ‘essential so built-in’ fan(s) which means no additional parts are necessary, especially in the case of hand held devices for less weight and volume (and cost too).

Shaped film (661) (ex. Soft, thin, elastic silicon) is introduced.

If contamination (which may be accumulated easily on curvature surface) is not big problem, without flat lid (663; dotted line, others are omitted) is better which will be operated with less (mouth) power.

FIG. 33 shows that controls are depends on hinges' position; diagonal side, and side by side.

Concerning state (665), if blow from (b) and then suction toward(s) the valve will be bent or almost flattened, because it is soft. Using this basic the other variations are possible.

FIG. 34 is an example of Multiple Valves I—complex (of linear and rotary) type.

FIG. 34 is side view, and FIG. 34 is front view. For easy understanding, name of parts are denoted in the diagram. Rotating the induct-n the flows are changed as drawn. ‘id’ is for in-duct, ‘od’ is for out-duct.

Outduct was named because it's position is outside, induct inside of the system, even though the flow is ‘bi’-directional.

Different degrees (α#α′) and distances (between inducts-n, d1≠d2, d3≠d4≠dn) give many options for flow direction.

If there are n outducts, the spacing between outducts must be widened by n multiples of the minimum angle. In the same way, the distance between the ducts must also extend by n multiples of the minimum distance. The minimum distance is determined by the diameter or width of the duct.

More flow directions and variations are possible making some more ducts as follows (shown as solid line), which is not actual but just to show what may be possible.

If inducts-n have different internal duct pass respectively, with outducts-n of different interval ducts, thousands of flow may be possible with just one valve.

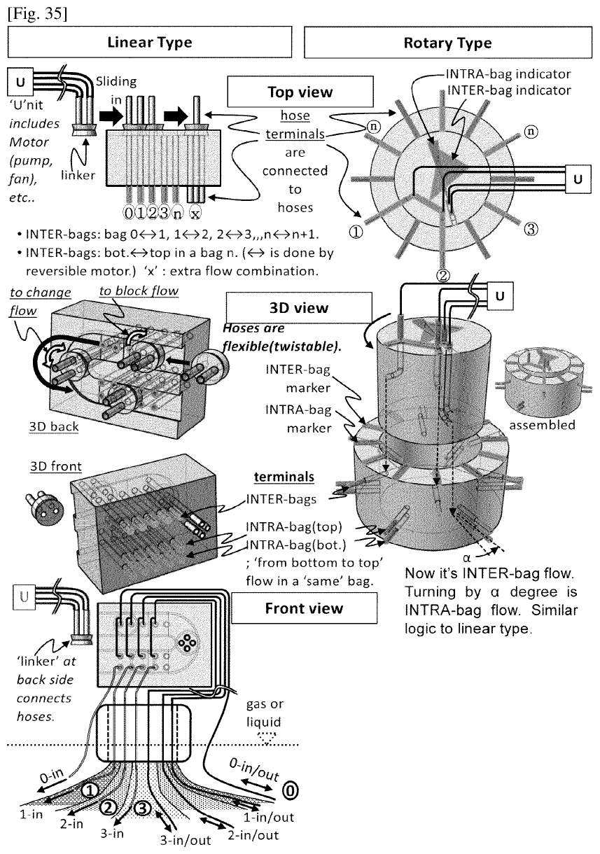

FIG. 35 is an example of Multiple Valves II—complex (of linear and rotary) type.

Linear Type and rotary type is compared. It is so complicated, so name of parts are denoted in the diagram.

For INTRA-bag flow, the INTER-bag flow terminal shall be blocked by turning the ‘linker’

Long hoses reaching bottom may work as both IN and OUT, where as short hoses just as only IN. So normally 1 long hose per bag is enough, if high speed is not essential.

Reversing flow direction is by rotating linker 180 degree or reversible motor.

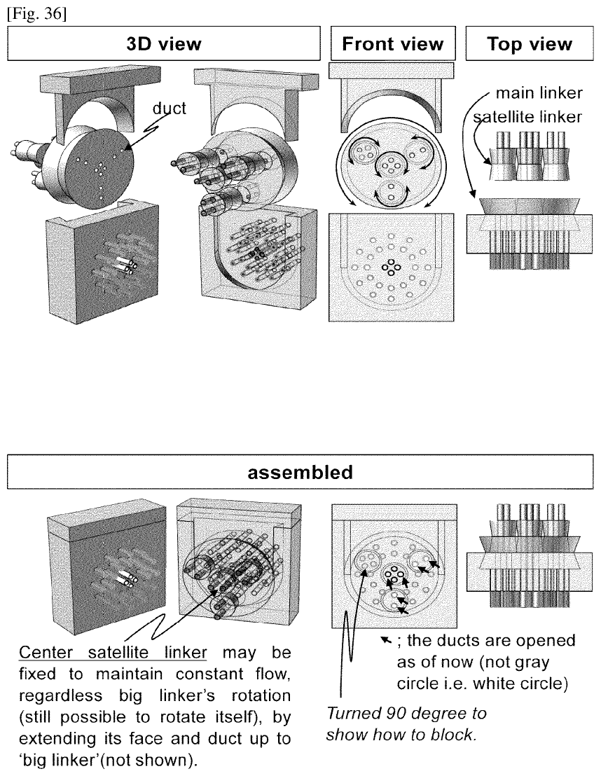

FIG. 36 is an example of Multiple Valves III—Double Rotary type.

Hose connections and how to operate are same as before. But this type, as shown in following example, has more combinations with relatively simple structure.

FIG. 36 shows 3D-, Front- and Top-view of the valve.

It shows how does each parts work.

FIG. 36 shows that each of the three parts are assembled as drawn.

Of course it is achieved by combination of Check Valve, Spool Valves (3/2, 5/2, etc.), Bleed Valves, Logic ‘OR’ Shuttle Valves, Logic ‘AND’ Shuttle Valves, Quick Exhaust Valves, Diaphragm Valve, Pinch Valve, Servo Control Valves or other lots of valves. But the examples shown in this invention are more simple and can control more ports easily, actuators like solenoids, servomotors, electro magnetic, etc. were omitted though.

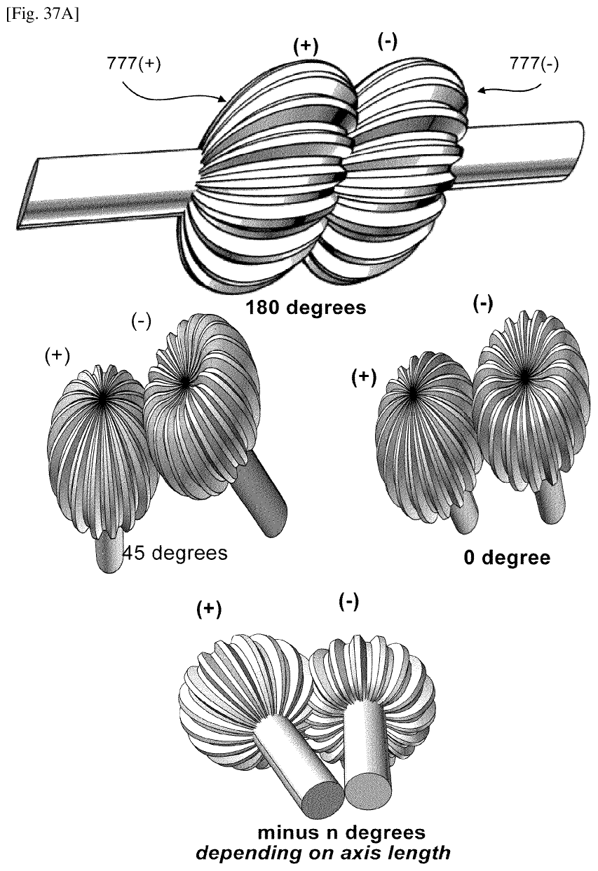

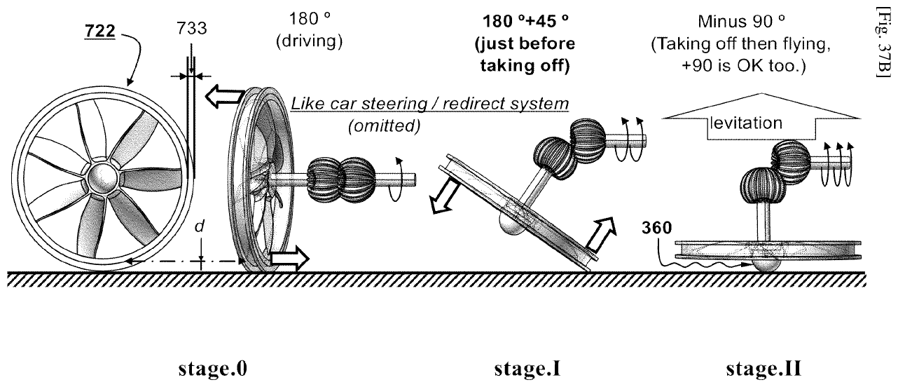

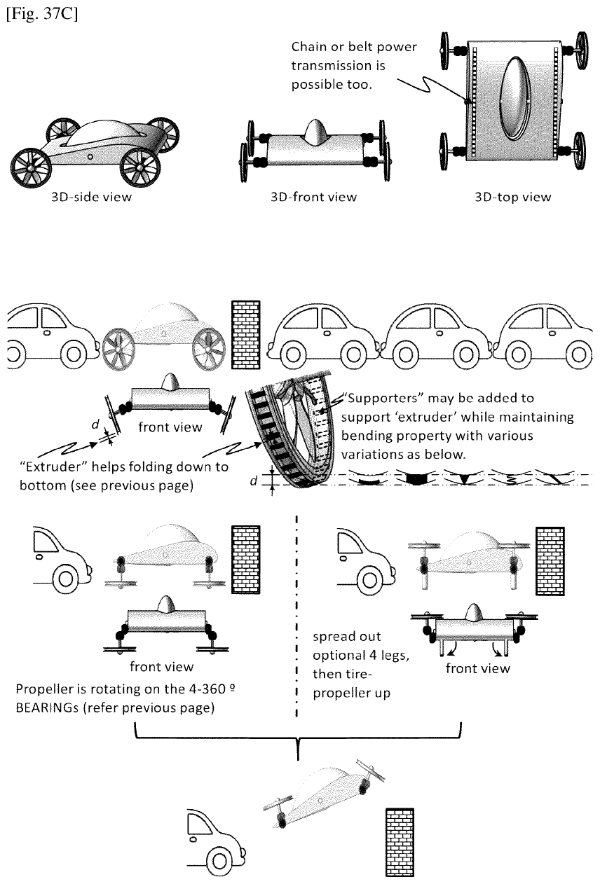

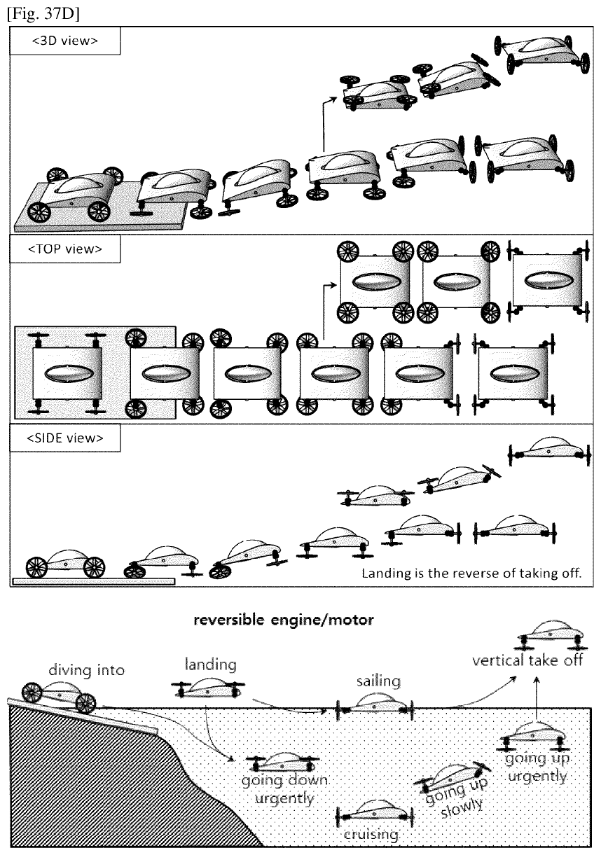

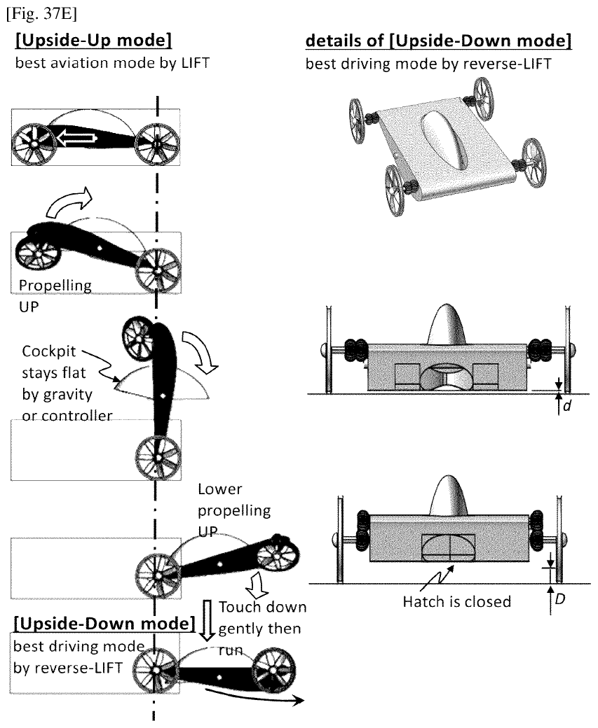

FIG. 37A is an example of 360 degree energy transfer in 3D view.

It is an example of 3D of 360 degree energy transfer to control hose or duct.

Equator teeth are thickest (max), polar thinnest (min). So ‘continuous’ gear shifting is possible by adjusting the contacting point of each other. Max vs. Max is like normal gear, all the other combinations are Max vs. less-Max or less-max vs. less-Max., which may cause noise to be reduced by Helical teeth.

At a glance, both a flower gear plus (777+) and a flower gear minus (777−) looks similar though, the black part in the top side is (+) gear is convex, (−) gear is concave with close observation

With this ‘flower (chrysanthemum, mum)’ gear, concise controlling the ducts of FIG. 34˜FIG. 36 become possible.

FIG. 37B is concerning usage of flower gear except controlling ducts.

With the concept of the flower gear, Car+Aviation (Gliding and/or VTOL (vertical takeoff and landing))+Submarine in a body is possible.

A tire-propeller (722) acts as both tire and propeller. It runs on the road.[stage.0]

An extruder (733; ‘d’ is length of it, elastic, folding) of tire-propeller is a kind of cushion while driving, and helps folding down to bottom for taking off when traffic is STOPped.

[stage.I] Folding down the tire-propeller (722) inward i.e. under the body. the propeller of the tire-propeller (722) start to uplift the body. It will be folded owing to the elasticity of the extruder (733).

If uplift is failed or still lift is not sufficient yet, a 360 degree bearing (360) will support the body while still in middle of driving and flying.

How it works;

Propelling to Fly: Taking Off and Flying—from the bottom (top is possible too)

Propelling On or Under water—front and/or back.

‘Spheric Bevel Gear’ flower gear (777) above transfer power at any angle (3-dimensionally 360° Each tire-propellers (722) may have their own engine (for ease, such as electronic motors) separately. The body of the car has shape of cross section airplane wing (when flying), and tunable (when driving), which will be explained latter.

Driving at high speed: Very easy to take off like on the airstrip. Fold the tire-propeller down slowly, feeling the front propellers being levitated, while speeding up more back tire-propellers still contacted to ground (still push the car) and also propelling up power is increased gradually by folding more

Even in case of traffic jam: While moving the car slowly, let the propeller(s) folded down to the bottom of the car slowly (as of now can not speed up to propel) then finally the car is on the 4 ‘bearings’(support the car vertically while the car is go forward). You know what to do. Speed up till the car levitated vertically, then change direction of the back tire-propellers up to rear side with maintaining the front tire-propellers propelling up. When reached at the enough speed, changed the direction

Under the sea: It's very easy referring the above.

FIG. 37C is overview of the car; 3D-side, front and top view.

FIG. 37C is how to escape out of the blocked situation while driving and side driving possible too, by making (steering) 4 wheels directing sides (90 degrees).

FIG. 37D shows various propelling modes; 3D, top, and side view

FIG. 37D shows how to use aqueous situation.

FIG. 37E procedure to Flip Over to reverse-lift mode (from Upside-Up to Upside-Down mode)

Upside-Up mode is good for aviation mode because of Lift.

Upside-Down mode is best driving mode because of reverse-Lift.

“short flying (car floats)” while driving: at the upside-up (aviation) mode

“high speed driving grip”: at the upside-down mode

For reference, from the top view unlikely side view, width of both wing side is wider than that of cockpit, which makes enough lift.

At the state of Upside-Down mode (180 degree gear contact, middle figure) distance (d) between bottom of the car and road is short. If the load is bumpy, change the 180 degree gear contact to bottom-top contact to raise body (D) (bottom figure), which will be useful in the narrow road or lane also.

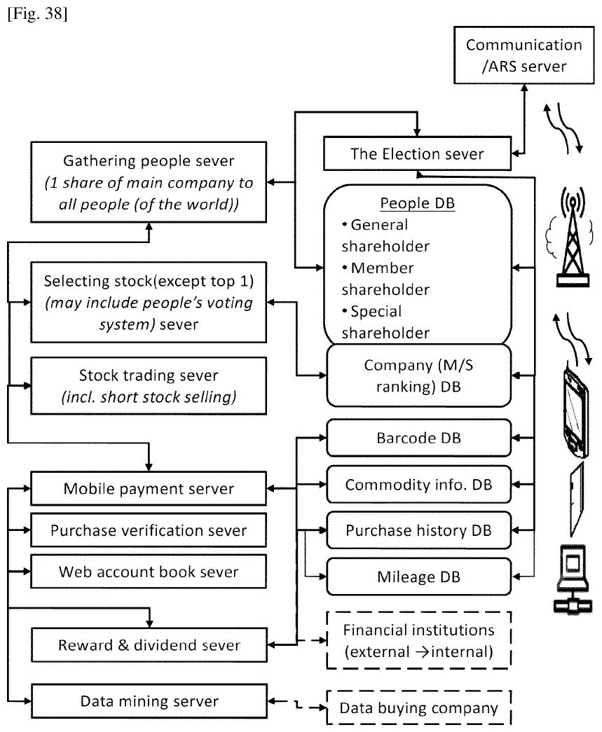

FIG. 38 is example of method and apparatus for gathering investors.

MASSItAlism is on the basis of;

Less people, More money, Less total consumption.—LML

More people, Less money, More total consumption—MLM

Through Internet, (personal) terminals, and the system with various servers and DB's above, gathering people (incl. Corporation) to invest companies (1 by category) selected from or voted on top 2nd˜nth in Market Share.

General shareholders: those who receive at least 1 share of the main company (operating this system) without paying anything. It may be all the people of the world including to be born. They have just 1 share and will not get rewards or dividend, with 0 (zero) vote in selecting company to invest.

Member shareholders: those who purchase commodities designated by the system and input/transmit purchase evidence like receipt picture (or credit card (of the main company) purchase data having purchase details) which will be translated to text data by character recognition to be transferred to, verified by, stored on the system. The data gathered will produce account book of the member automatically and will be used to count rewards or activities. They can get rewards and dividend, with 1+α (by their contribution & activity) vote. Verification server compares already verified data with

Special shareholders: those who buy the stock of the main company. If they do the same activities as member shareholders, they can get reward and higher dividend, with 100+α (by their contribution & activity) vote.

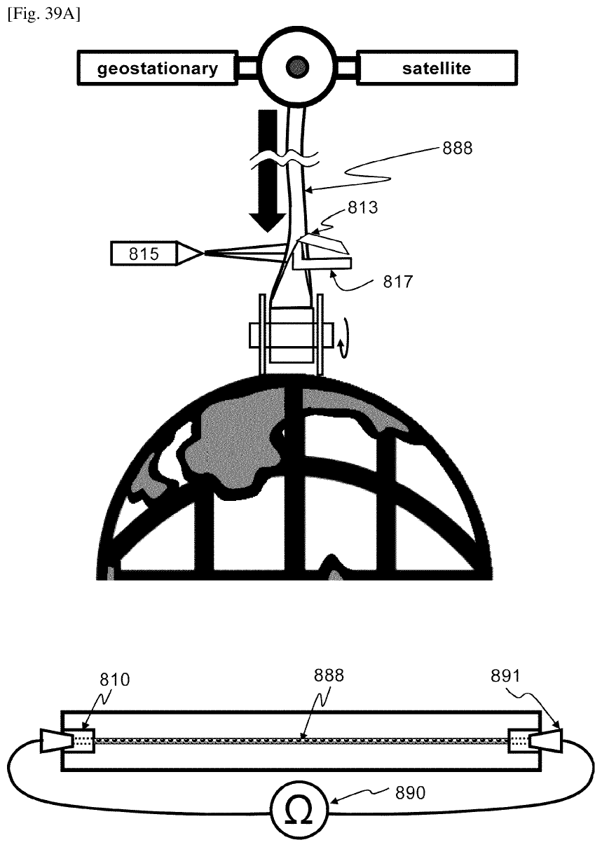

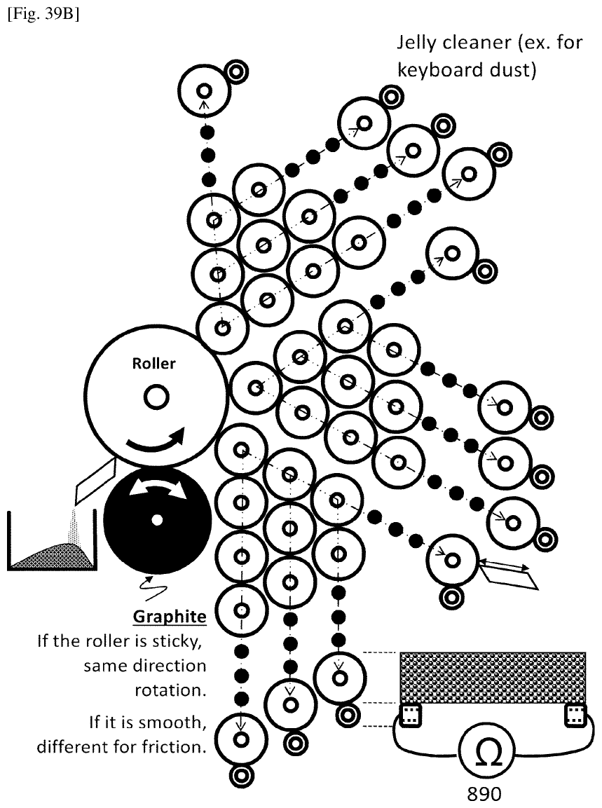

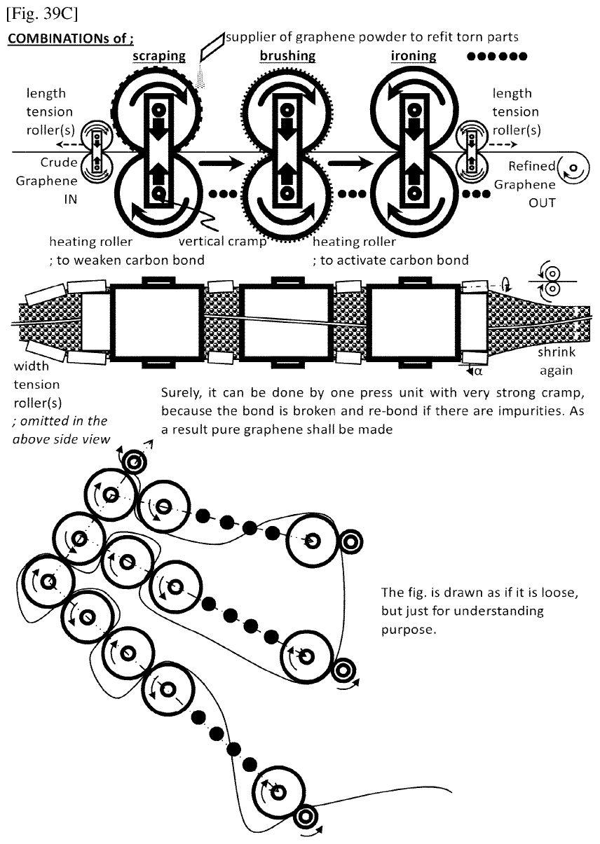

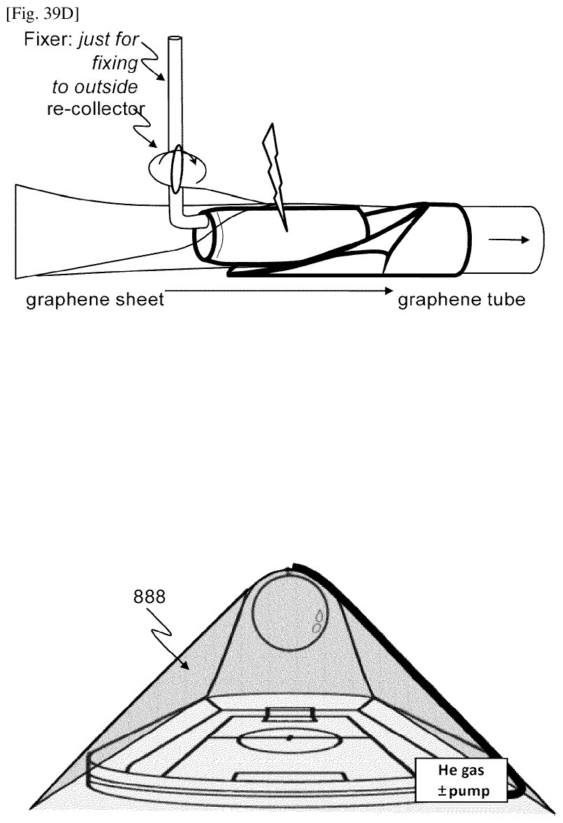

FIG. 39 is an example of how to produce better property sacks.

As explained in ‘inner-container’ of definition section, and in explanation of FIG. 8 septic tank, Mass production method of the graphene is required, which has best property for the sack (33) like thin, elastic, strong, etc., so far.

FIG. 39A shows schematic diagram. In order to make it in none gravity or vaccume, geostationary or geosynchronous satellite may be introduced.

Graphene (888) is so light and tight. If, therefore, we make tube type graphene (888), we can send raw materials like methane up to satellite through the tube. On the ground, cut by cutter (813) longitudinally just before the raw material supply pipe (817). Or just connect by the independent tube to send raw materials up to the satellite. This procedure will be continued.

Cleaning/Repairing (815); Removing impurities or repairing impure parts can be done on the earth. Air (incl. Vapor), Liquid (ex. Solvent), Brushing, ironing, and/or Combination of the above

Supplying pipe (817); supplying raw materials (gaseous, powder or grain form)

If let all the satellites have graphene ‘tail’ like this, cleaning satellite waste is easy. Without the tail, graphene net will catch the waste satellite.

FIG. 39A shows a kind of graghene finder by measuring resistance, composing;

graphene (888), holder (810) with clip (891) of resistance meter (890)

In order to explain this concept to make graphene, the simplest method is presented first, on FIG. 1A.

Draw a line (1111) with a graphite (pure graphite pencil) on the flat (or cylindrical or curved) surface (1100, like glass) from one end to the other end. If, like coarse or thick pencil lead, the contact line of graphite with flat surface is long, the line (the trace or trail of graphite) will be a rectangle in other words a surface.

Attach conductive material (1120, ex. Thin copper plate) to the both end of the above line.

Clip the both conductive material and the flat glass together respectively. The two clips (891) are connected to resistance meter (1140). The line (1111) drawn under the conductive materials and clips are shown as dotted line.

Cover or attach the line (i.e. the trace, trail, rectangle or surface) fully with cellophane tape which is wider than the width of line.

Detach the tape from the plate. (Let's call the tapes detached through this process as “ ” and the lines which are attached to tapes-1st as””

Repeat 4) and 5) until the value of the resistance meter (1140) is same with graphene's resistance, considering resistance of dot-lines of the both end of the line. For more exact result, we can remove the portion of dot-line by cutting and scratching them out with knife, then reconnect electrode to the shorted line during the repeating process of 4) and 5), and we can use the technology of reducing contact resistance of between graphene and conductive electrode (for example, palladium ˜86 Ω-μm can be reduced to ˜23 Ω-μcm by n-type doping technology and design modification of graphene edge i.e. by designing the length of the graphene corners longer).

If the value of resistance of the line on the plate became infinite, we can guess the last line attached to cellophane tape is (maybe 1 layer) graphene.

Repeatedly new cellophane tapes can be attached to and then detached from the tapes-1st which will make tapes-2nd, tapes-3rd and so on, which will make thin graphite layer and eventually 1 layer graphene (like above, if there is no graphite or graphene attached to the tape, the resistance will be infinite) according to the stickiness of the tape which can be adjusted. The tapes-nth can be used to get thinner graphite layer or 1 layer graphene.

In addition to glasses, to get thin layer graphite or graphene, other solids with very smooth surface such as papers, ceramics (or porcelains), (stainless) steel, dry- (including water-) ice, graphite itself and other solid can be used as a plate, according to the various purposes.

In case of ceramics (or porcelains) with the property of high-temperature resistance, in order to re-structure the carbons, heating the line is possible.

In case of paper, eliminating the plate in other words leaving the lines only is easy by dissolving the paper in water.

When using (stainless) steel, it is difficult to measure the value of line because steel itself is conductive, heating the line is possible though.

Especially in case of dry- (including water-) ice, it's very easy to separate thin layer graphite or graphene from the plate by sublimating or melting of the plate. But the graphite to be used needs to be chilled to the ice point (temperature) for maintaining proper friction between them.

According to the Wikipedia, one of the graphene's characteristics is “In magnetic fields above 10 tesla or so additional plateaus of the Hall conductivity at oxy=ve2/h with i=0, ±1, ±4 are observed. A plateau at i=3 and the fractional quantum Hall effect at were also reported. These observations with i=0, ±1, ±3, ±4 indicate that the four-fold degeneracy (two valley and two spin degrees of freedom) of the Landau energy levels is partially or completely lifted” (https://en.wikipedia.org/wiki/Graphene)

FIG. 39C Refining crude graphene (by combinations of Ironing, Scraping and etc.)

FIG. 39D Making graphene-tube

If we make a large diameter graphene-tube, we can use tube type itself (such as hose between satellite and earth to send methane gas for raw material or cut- (in the longitudinal direction)-and-use with supplying hydrogen.

By (revolving, heated diamond) knife, electric shock, laser, ultrasonic, (electronic, gas) torch, electric iron, chemical agents, (etc. or combination of them, seal contact point of the both ends or remove or re-collect 2 cut narrow long sheet immediately after cutting overlapped area and then let them make carbon bond naturally (for reference, it's vacuum state).

Whatever the heated graphene melt or sublimate, cutting is possible and if graphene is cut, not melt or sublimate parts will re-bond naturally.

As a reference, no graphene melting experiments have been conducted. Previously, computer models predicted the melting point of graphene at 4,500 or 4,900 K. “Graphene ‘melting’ is, in fact, sublimation.” (Jan. 6, 2020)

https://phys.org/news/2020-01-sublimation-graphene.html

FIG. 39D is for another container (22)

1. Method and device for treating various type of fluids.
